(19) United States
(12) Patent Application Publication
(10) Pub. No.: US 2025/0086562 A1
(43) Pub. Date: Mar. 13, 2025

(54) SYSTEM AND METHOD FOR DELIVERY METRIC ANALYSIS AND NOTIFICATION

(71) Applicant: Hera Solutions Inc., Los Angeles, CA (US)

(72) Inventor: Matthew Goldman, Los Angeles, CA (US)

(21) Appl. No.: 18/962,536

(22) Filed: Nov. 27, 2024

Related U.S. Application Data
(63) Continuation-in-part of application No. 17/743,713, filed on May 13, 2022.
(60) Provisional application No. 63/188,346, filed on May 13, 2021.

(51) Int. Cl. G06Q 10/0639

(52) U.S. Cl. CPC G06Q 10/06398; G06Q 10/06393

(57) ABSTRACT

A system for delivery associate metric analysis and notification comprising: a delivery metric receiving device that may be adapted to receive one or more delivery metrics associated with one or more users; a delivery metric analysis device that may be adapted to determine performance data and generate coaching messages based on the one or more delivery metrics, and a delivery coaching message transmission device that may be adapted to send the generated coaching messages to the one or more users, wherein each of the generated coaching messages may be generated based on a particular user of the one or more users.

### CROSS-REFERENCE TO RELATED APPLICATIONS

This U.S. Non-Provisional Utility Patent Application is a Continuation-in-Part Patent Application of U.S. Non-Provisional patent application Ser. No. 17/743,713, filed on May 13, 2022, by inventor Matthew Goldman, the contents of which are expressly incorporated herein by this reference, and to which benefit of and priority to are claimed. U.S. Non-Provisional patent application Ser. No. 17/743,713 claims the benefit of and priority to U.S. Provisional Patent Application No. 63/188,346, filed on May 13, 2021, by inventor Matthew Goldman, the contents of which are expressly incorporated herein by this reference.

### FIELD OF USE

The present disclosure relates generally to the field of delivery informatics, and more specifically, to systems and methods for analyzing delivery metrics, generating scorecards, and sending coaching messages.

### BACKGROUND

Delivery informatics services are regularly used by many companies, to provide information relating to their delivery associates. In particular, the service of providing information relating to delivery associates has become increasingly popular.

However, delivery informatics services prior to the systems and methods of the present disclosure only allow for extremely limited customization and notification. Such existing delivery informatics services do not provide delivery information in a concise, intelligible, and easily digestible format and do not allow for coaching messages to be automatically sent to users. Thus, there is a need for a delivery metric analysis and notification system which can provide delivery information in a concise, intelligible, and easily digestible format and allow for coaching messages to be sent to users.

### SUMMARY

To minimize the limitations in the cited references, and to minimize other limitations that will become apparent upon reading and understanding the present specification, the system and method for delivery metric analysis and notification disclosed herein relates to a system and method for receiving delivery metrics relating to one or more users, determining performance data based on the one or more delivery metrics, generating coaching messages based on the one or more delivery metrics, and sending the generated coaching messages to the one or more users. In general, the delivery metrics relate to users who are delivery drivers.

One embodiment may be a system for delivery metric analysis and notification. The system may include a delivery metric receiving device; a delivery metric analysis device; and a delivery coaching message transmission device; where the delivery metric receiving device may be configured to receive one or more delivery metrics associated with one or more users; where the delivery metric analysis device may be configured to generate a performance data based on the one or more delivery metrics; where the delivery metric analysis device may be configured to generate one or more coaching messages based on the performance data; and where the delivery coaching message transmission device may be configured to send the generated coaching messages to the one or more users, where each of the generated coaching messages may be generated based on a particular user of the one or more users. Other embodiments of this aspect include corresponding computer systems, apparatus, and computer programs recorded on one or more computer storage devices, each configured to perform the actions of the methods.

The one or more delivery metrics may be used to generate one or more scorecards. The generated performance data may include: a picture upon a delivery report, a delivery service partner delivery excellence performance report, a customer feedback report, and a driver performance report (which may be in whole or in part be provided by a third-party such as Amazon®, Netradyne®, and/or Mentor®). The delivery coaching message transmission device may be configured to send a broadcast message to one or more users. The injury information input device may be configured to receive an injury information associated with an injury and generate an injury form based on the injury information. The one or more delivery metrics may include one or more of: acceleration metrics, braking metrics, cornering metrics, speeding metrics, distraction metrics, seatbelt metrics, back up metrics, mile-per-gallon metrics, idling metrics, odometer reading metrics, and engine off metrics. The delivery coaching message transmission device may be configured to send the generated coaching messaging through a cellular communication protocol. The delivery coaching message transmission device may be configured to send the generated coaching messaging through the internet. The delivery associate input device may be configured to allow a user to input delivery associate data; where the delivery associate data may be configured to be displayed in an associate dashboard view, daily roster view, and detailed associate summary view. The inventory management input device may be configured to receive inventory data; where the inventory data may include information about product inventory. The daily roster input device may be configured to allow users to track, change, and update routes, or vehicle reassignments.

Another embodiment may be a method for delivery metric analysis and notification that may comprise receiving one or more delivery metrics associated with one or more users; generating performance data based on the one or more delivery metrics, generating one or more coaching messages based on the one or more delivery metrics, and sending the generated coaching messages to one or more users.

The one or more delivery metrics may be used to generate one or more scorecards. The generated performance data may include: a picture upon a delivery report, a delivery service partner delivery excellence performance report, a customer feedback report, and a driver performance report (which may be in whole or in part be provided by a third-party such as Amazon®, Netradyne®, and/or Mentor®). The method may include the step of sending a broadcast message to one or more users. The method may include the step of receiving an injury information associated with an injury and generating an injury form based on the injury information. The one or more delivery metrics may include one or more of: acceleration metrics, braking metrics, cornering metrics, speeding metrics, distraction metrics, seatbelt metrics, back up metrics, mile-per-gallon metrics, idling metrics, and engine off metrics. The method may include the step of receiving a delivery associate input, and generating a dashboard view of associates, a daily roster, and a detailed delivery associate summary.

It is understood that in one embodiment, the system and method for delivery metric analysis and notification may be used in order to analyze delivery driver performance and provide feedback to the delivery driver. The feedback may be presented to the delivery driver in order to explain to the delivery driver their strengths, weaknesses, and areas for improvement. In some embodiments, the feedback may be presented to the delivery driver to show the delivery driver how they compare to other delivery drivers. In other embodiments, the feedback may be provided to delivery driver supervisors in order to allow the delivery driver supervisors to understand how their delivery drivers are performing and how their drivers are performing to one another or established metrics.

One embodiment of the system for data aggregation, data processing, and messaging may comprise a delivery metric gathering device; a delivery metric analysis device; a message transmission device; a driver device; and a manager device; wherein the delivery metric gathering device may be configured to receive one or more delivery metrics associated with one or more drivers; wherein the delivery metric gathering device may be configured to send the one or more delivery metrics to the delivery metric analysis device; wherein a driver may be prompted to enter into the driver device one or more driver ranges of acceptable values of the one or more delivery metrics; wherein a manager may be prompted to enter into the manager device one or more manager ranges of acceptable values of the one or more delivery metrics; wherein the delivery metric analysis device determines when the one or more delivery metrics may be a value outside of the one or more driver ranges of acceptable values; wherein when the one or more delivery metrics may be a value outside of the one or more driver ranges of acceptable values, the message transmission device may be configured to send a driver message to the driver device; wherein the delivery metric analysis device determines when the one or more delivery metrics may be a value outside of the one or more manager ranges of acceptable values; and wherein when the one or more delivery metrics may be a value outside of the one or more manager ranges of acceptable values, the message transmission device may be configured to send a manager message to the manager device. The delivery metric analysis device may be configured to generate performance data based on the one or more delivery metrics. The performance data may comprise one or more of: a picture upon delivery report, a delivery service partner delivery excellence performance report, a customer feedback report, and a driver performance report (which may be in whole or in part be provided by a third-party such as Amazon®, Netradyne®, and/or Mentor®). The one or more delivery metrics may be used to generate one or more scorecards. The metrics may comprise an injury information input. The injury information input relates to injuries caused to the one or more drivers while performing delivery related activities; and generating an injury form based on the injury information input. The one or more delivery metrics may comprise one or more of: acceleration metrics, braking metrics, cornering metrics, speeding metrics, distraction metrics, seatbelt metrics, back up metrics, mile-per-gallon metrics, idling metrics, odometer reading metrics, and engine off metrics. The driver message and manager message may be transmitted via wireless communications. The delivery metrics comprise inventory management data; and wherein the inventory management data may comprise information about product inventory.

In one embodiment, the systems, methods, and devices of the present disclosure are designed to integrate performance metrics from various external sources seamlessly. These data sources may include third party delivery metric vendors, such as Amazon®, Mentor®, Netradyne®, and others, which provide key performance indicators (KPIs) related to delivery associates' actions. The data intake system of the present disclosure accommodates numerical metrics and text-based data, such as customer feedback, safety compliance reports, delivery status updates, and on-road performance metrics. The system of the present disclosure may process hundreds of different data points from spreadsheet-like files obtained from third party delivery metric vendors. These data points may include legible metrics that the delivery drivers themselves would not typically be able to understand or access via their mobile devices. The methods, systems, and devices of the present disclosure may extract, organize, and prepare the third party vendor data for transformation into feedback, which preferably takes the form of actionable insights, enabling delivery companies, which are frequently independent contractors, to maintain a clear and detailed understanding of the performance of their delivery associates. This ability to process data from disparate sources, regardless of format, is an important feature of the systems of the present disclosure. The systems, methods, and devices of the present disclosure may include unique ranking and prioritization technology. The ranking and prioritization features offers a comprehensive and customizable way to “score” delivery associate performance. The system of the present disclosure does not rely solely on third-party vendor-provided scorecards. The systems of the present disclosure preferably integrate many factors, providing users/companies with a holistic view of each delivery associate's performance. This may include performance metrics such as, but not limited to, on-time deliveries, safety compliance (including factors such as speeding, seatbelt usage, and hard braking), and operational concerns such as attendance issues, vehicle damage, rescues, and insubordination. The ranking and prioritization features of the present disclosure may use an advanced weighting system, which allows customers to assign different levels of importance to various metrics using customizable importance sliders. Companies may prioritize key performance areas that align with their specific operational goals. For example, a company might, with a flick of a finger or movement of a mouse, give higher importance to safety compliance while lowering the emphasis on customer feedback. These graphical user interface sliders ensure each associate's ranking is tailored to the user's/company's unique preferences. Once the importance of each metric is established, The system of the present disclosure may process thousands of data points across multiple dimensions, transforming them into a unique ranking profile for each delivery associate. The system preferably may continuously analyzes the substantial array of data points to ensure the rankings and ranking profiles provided accurately reflects real-time performance. This system of the present disclosure allows each user/customer to have a unique and tailored platform that is able to recalculate based on the specific settings and preferences of the company, allowing for a truly tailored performance management tool. The ranking features may be very flexible in terms of time periods. Users/companies may choose to calculate rankings over various time frames, from as short as one week or up to years, or anything in between, such as, for example, 180 days. This flexibility allows users/companies to view both short-term performance fluctuations and long-term trends. When a new time frame is selected, the system of the present disclosure, as calibrated with the user's preferences, recalculates the rankings by processing all the previously imported performance metrics for that desired and specified time period. This recalculation feature ensures that rankings are always based on the most accurate and relevant data available, whether the focus is on immediate recent performance or long-term evaluation. Combining real-time recalculation capabilities with a flexible and customizable metric weighting system, the system of the present disclosure provides users/businesses with an unmatched level of insight and control over their knowledge of each delivery associate's performance.

One embodiment of the system of the present disclosure, features data transformation algorithms, which may process complex data sets and turn them into automated coaching messages and positive reinforcement, which may be referred to as “Associate Issues” and “Kudos”. The system may collect the raw data, analyze it, flag performance concerns, and trigger feedback to the delivery associates. The transformation process may include:
(1) “Automated Associate Issues” may be generated for poor performance metrics, such as low scores on the Amazon® Delivery Scorecard, Mentor® safety violations, or Netradyne® driving safety alerts. These issues may be automatically flagged without manual intervention, reducing managers' time reviewing associate performance.
(2) “Automated Associate Kudos” may be created when delivery associates excel and receive high scores or positive feedback. These Kudos may be tracked and used to calculate an Associate Ranking.
(3) “Positive Reinforcement and Coaching” messages may be automated. Based on user/company set thresholds, the system may send text messages and/or emails to delivery associates, providing actionable coaching based on the analyzed metrics. Raw data and the third-party scores are not parroted, they are transformed. The system may identify coaching opportunities as soon as performance data is processed.

Other features and advantages inherent in the disclosed system and method for delivery metric analysis and notification, besides those which are claimed and disclosed, will become apparent to those skilled in the art from the following detailed description and its accompanying drawings.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps, which are illustrated. When the same numeral appears in different drawings, it refers to the same or like components or steps.

FIG. 1 is an illustration of one embodiment of a main performance screen of a system for delivery metric analysis and notification.

FIG. 2 is an illustration of one embodiment of a performance import pop-up of a system for delivery metric analysis and notification.

FIG. 3 is an illustration of one embodiment of a task management screen of a system for delivery metric analysis and notification.

FIG. 4 is an illustration of one embodiment of a task addition pop-up of a system for delivery metric analysis and notification.

FIG. 5 is an illustration of one embodiment of a messaging interface of a system for delivery metric analysis and notification.

FIG. 6 is an illustration of one embodiment of a coaching preferences screen of a system for delivery metric analysis and notification.

FIG. 7 is another illustration of one embodiment of a coaching preferences screen of a system for delivery metric analysis and notification.

FIG. 8 is an illustration of one embodiment of a messaging device manager of a system for delivery metric analysis and notification.

FIG. 9 is an illustration of one embodiment of a user management screen of a system for delivery metric analysis and notification.

FIG. 10 is an illustration of one embodiment of a company details screen of a system for delivery metric analysis and notification.

FIG. 11 is an illustration of one embodiment of a monthly invoices screen of a system for delivery metric analysis and notification.

FIG. 12 is an illustration of one embodiment of an account details screen of a system for delivery metric analysis and notification.

FIG. 13 is an illustration of one embodiment of a drop-down list customization screen of a system for delivery metric analysis and notification.

FIG. 14 is another illustration of one embodiment of a drop-down list customization screen of a system for delivery metric analysis and notification.

FIG. 15 is an illustration of one embodiment of a vehicle detail screen of a system for delivery metric analysis and notification.

FIG. 16 is an illustration of one embodiment of an overall vehicle view screen of a system for delivery metric analysis and notification.

FIG. 17 is an illustration of one embodiment of an injury form input screen of a system for delivery metric analysis and notification.

FIG. 18 is another illustration of one embodiment of an injury form input screen of a system for delivery metric analysis and notification.

FIG. 19 is an illustration of one embodiment of a delivery associate details page of a system for delivery metric analysis and notification, consistent with some embodiments of the present disclosure.

FIG. 20 is an illustration of one embodiment of a customization screen for the delivery association list of a system for delivery metric analysis and notification, consistent with some embodiments of the present disclosure.

FIG. 21 is an illustration of one embodiment of a delivery associate issue input screen of a system for delivery metric analysis and notification.

FIG. 22 is another illustration of one embodiment of a delivery associate issue input screen of a system for delivery metric analysis and notification.

FIG. 23 is yet another illustration of one embodiment of a delivery associate issue input screen of a system for delivery metric analysis and notification.

FIG. 24 is an illustration of one embodiment of a counseling input screen of a system for delivery metric analysis and notification.

FIG. 25 is another illustration of one embodiment of a counseling input screen of a system for delivery metric analysis and notification.

FIG. 26 is an illustration of one embodiment of a main coaching screen of a system for delivery metric analysis and notification.

FIG. 27 is an illustration of one embodiment of a coaching messages screen of a system for delivery metric analysis and notification.

FIG. 28 is an illustration of one embodiment of a detailed delivery associate screen of a system for delivery metric analysis and notification.

FIG. 29 is another illustration of one embodiment of a detailed delivery associate screen of a system for delivery metric analysis and notification.

FIG. 30 is another illustration of one embodiment of a detailed delivery associate screen of a system for delivery metric analysis and notification.

FIG. 31 is another illustration of one embodiment of a detailed delivery associate screen of a system for delivery metric analysis and notification.

FIG. 32 is another illustration of one embodiment of a detailed delivery associate screen of a system for delivery metric analysis and notification.

FIG. 33 is another illustration of one embodiment of a detailed delivery associate screen of a system for delivery metric analysis and notification.

FIG. 34 is another illustration of one embodiment of a detailed delivery associate screen of a system for delivery metric analysis and notification.

FIG. 35 is another illustration of one embodiment of a detailed delivery associate screen of a system for delivery metric analysis and notification.

FIG. 36 is another illustration of one embodiment of a detailed delivery associate screen of a system for delivery metric analysis and notification.

FIG. 37 is an illustration of one embodiment of a dashboard view of delivery associates screen of a system for delivery metric analysis and notification.

FIG. 38 is an illustration of one embodiment of a view of all delivery associates screen of a system for delivery metric analysis and notification.

FIG. 39 is an illustration of one embodiment of a delivery associate addition screen of a system for delivery metric analysis and notification.

FIG. 40 is an illustration of one embodiment of a broadcast messaging screen of a system for delivery metric analysis and notification.

FIG. 41 is an illustration of one embodiment of a daily roster screen of a system for delivery metric analysis and notification.

FIG. 42 is another illustration of one embodiment of a daily roster screen of a system for delivery metric analysis and notification.

FIG. 43 is another illustration of one embodiment of a daily roster screen of a system for delivery metric analysis and notification.

FIG. 44 is an illustration of one embodiment of a daily roster assignment addition screen of a system for delivery metric analysis and notification.

FIG. 45 is an illustration of one embodiment of a daily roster odometer reading input screen of a system for delivery metric analysis and notification.

FIG. 46 is another illustration of one embodiment of a daily roster odometer reading input screen of a system for delivery metric analysis and notification.

FIG. 47 is another illustration of one embodiment of a daily roster odometer reading input screen of a system for delivery metric analysis and notification.

FIG. 48 is an illustration of one embodiment of a daily roster helper screen of a system for delivery metric analysis and notification.

FIG. 49 is an illustration of one embodiment of a daily roster rescuer screen of a system for delivery metric analysis and notification.

FIG. 50 is an illustration of one embodiment of a daily roster split-route screen of a system for delivery metric analysis and notification.

FIG. 51 is an illustration of one embodiment of a daily roster single delivery associate roster-assignment screen with the ability to add issues/counseling.

FIG. 52 is an illustration of one embodiment of a daily roster screen for delivery associates for delivery metric analysis and notification.

FIG. 53 is an illustration of one embodiment of a daily roster assignment status screen.

FIG. 54 is an illustration of one embodiment of a delivery associate screen for delivery metric analysis and notification.

FIG. 55 is an illustration of one embodiment of a daily roster screen to add a single roster assignment.

FIG. 56 is an illustration of one embodiment of a daily roster messenger screen which allows users to send a text message to a select group of employees.

FIG. 57 is an illustration of one embodiment of a daily roster function which allows the user to send details of roster assignments to an employee's personal or work phones.

FIG. 58 is an illustration of one embodiment of a daily roster messenger screen which allows users to send a text message to all employees working on a particular day, either on their personal or work phones.

FIG. 59 is another illustration of one embodiment of a daily roster screen which allows users to send roster assignments to a select group of employees.

FIG. 60 is another illustration of one embodiment of a daily roster screen which allows users to customize which data displays in the columns and in which order.

FIG. 61 is an illustration of one embodiment of the delivery associate screen with the ability to assign inventory.

FIG. 62 is an illustration of one embodiment of the delivery associate screen with the ability to apply filters for data sorting.

FIG. 63 is an illustration of one embodiment of the inventory management screen with the ability to add a new uniform item.

FIG. 64 is an illustration of one embodiment of the inventory management screen with the ability to add a new device.

FIG. 65 is an illustration of one embodiment of the inventory management screen.

FIG. 66 is an illustration of one embodiment of the inventory management screen showing the history of an item.

FIG. 67 is an illustration of one embodiment of the inventory management screen showing the ability to add an order.

FIG. 68 is an illustration of one embodiment of the inventory management screen with replacement order status displayed.

FIG. 69 is an illustration of one embodiment of the inventory management screen, showing the ability to change specific settings and types for inventory items.

FIG. 70 is an illustration of one embodiment of the inventory management screen, showing the ability to change specific settings and types for inventory items.

FIG. 71 is an illustration of one embodiment of the inventory management screen, item type details screen shown in non-editable view for non-premium paying customers.

FIG. 72 is an illustration of one embodiment of the inventory management screen, item type details screen shown in editable view for premium paying customers.

FIG. 73 is an illustration of one embodiment of the inventory management screen, item type details screen shown in non-edit view.

FIG. 74 is an illustration of one embodiment of the inventory management screen in dashboard view.

FIG. 75 is a block diagram of one embodiment of a system for delivery metric analysis and notification.

FIG. 76 is a flow diagram illustrating an embodiment of a method for delivery metric analysis and notification.

FIG. 77 is an illustration of one embodiment of a ranking of delivery associates for a particular user/company.

FIG. 78 is an illustration of one embodiment of a scorecard customization screen.

FIG. 79 is an illustration of one embodiment of a photo log review screen.

FIG. 80 is an illustration of one embodiment of a messenger interface showing a one-on-one conversation.

FIG. 81 is an illustration of one embodiment of a messenger interface showing a group conversation between two or more delivery associates working on a particular day.

FIG. 82 is an illustration of one embodiment of a messenger interface showing a group conversation between one or more delivery associates that have been assigned a custom label.

FIG. 83 is an illustration of one embodiment of a messenger interface showing the platform may include the ability to see all forms of communication (SMS/Email/Phone/Notifications) for one specific delivery associate on one screen.

FIG. 84 is an illustration of one embodiment of a messenger interface showing the first part of company settings for managing voice recordings.

FIG. 85 is an illustration showing the second part of what is shown in FIG. 84.

FIG. 86 is an illustration of one embodiment of a daily roster and scheduler showing an overview of the weekly schedule for associates, including showing shifts, routes, and rostered vehicles across different days.

FIG. 87 is an illustration of one embodiment of a roster and scheduler showing shift utilization for individual associates, which includes showing their scheduled shifts and actual schedules.

FIG. 88 is an illustration of one embodiment of a roster and scheduler showing the current day's standup announcements, general notes, and fleet notes, which allows supervisors to send critical messages to associates.

FIG. 89 is an illustration of one embodiment of a roster and scheduler showing associates' shift types, time blocks for each shift type, and shift duration.

FIG. 90 is an illustration of one embodiment of a roster and scheduler showing detailed information about a specific shift, including the scheduled start and end times.

### DETAILED DESCRIPTION OF THE DRAWINGS

In the following detailed description, numerous specific details are set forth in order to provide a thorough understanding of various aspects of one or more embodiments. However, these embodiments may be practiced without some or all of these specific details. In other instances, well-known methods, procedures, and/or components have not been described in detail so as not to unnecessarily obscure aspects of embodiments.

While multiple embodiments are disclosed, still other embodiments will become apparent to those skilled in the art from the following detailed description. As will be realized, these embodiments are capable of modifications in various obvious aspects, all without departing from the spirit and scope of protection. Accordingly, figures and the detailed descriptions thereof are to be regarded as illustrative in nature and not restrictive. Also, the reference or non-reference to a particular embodiment shall not be interpreted to limit the scope of protection.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about,” may refer to a deviance of between 0.0001-10% from the indicated number or range of numbers.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

As will be appreciated by one skilled in the art, the systems and methods may take the form of an entirely hardware embodiment, an entirely software embodiment, or an embodiment combining software and hardware embodiments. Furthermore, the systems and methods may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, compact discs, read-only-memory (CD-ROMs), optical storage devices, or magnetic storage devices.

Embodiments of the systems and methods are described below with reference to schematic diagrams, block diagrams, and flowchart illustrations of methods, systems, apparatuses and computer program products. It will be understood that each block of the block diagrams, schematic diagrams, and flowchart illustrations, and combinations of blocks in the block diagrams, schematic diagrams, and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

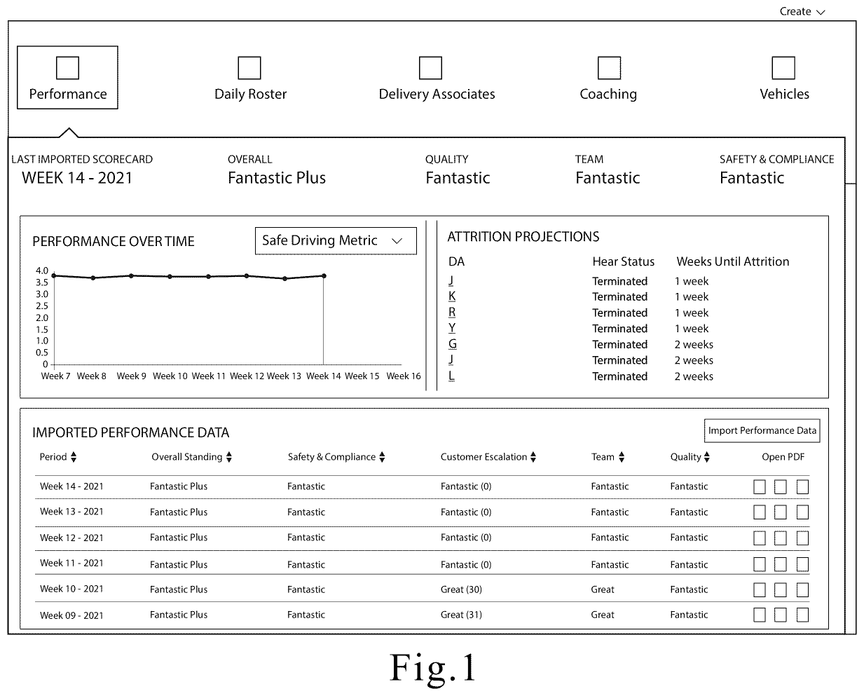

FIG. 1 is an illustration of one embodiment of a main performance screen of a system for delivery metric analysis and notification. As shown in FIG. 1, the main performance screen may include a graph or other illustration indicating delivery performance over time. Delivery performance over time may include metrics such as safe driving metric, overall standing, key focus areas, top drivers, safety and compliance, comprehensive audit, on-road safety score, compliance score, seatbelt-off rate, working hours compliance, on-time preventative maintenance compliance, sign/signal violations rate, distractions rate, following distance rate, daily vehicle condition report compliance, daily vehicle inspection checklist, reliability, quality, team, capacity reliability, high performers share, low performers share, attrition rate, customer delivery experience, customer escalation defects per million opportunities, customer delivery feedback, delivery completion rate, delivered and received, standard work compliance, photo-on-delivery, contact compliance, attended delivery accuracy, delivery not received, picture upon delivery opportunities, contact compliance opportunities, and average time. It will be appreciated that there may be other metrics tracked related to delivery performance and other associated information. It will also be appreciated that any combination of one or more of these metrics may be used.

In some embodiments, other metrics may also be tracked including taking a picture upon delivery report summary types including: opportunities, success, bypass, rejects, blurry photo, human in the picture, no package detected, package in car, package in hand, package not clearly visible—locker/other concealment, package too close, photo too dark, and others. It will be appreciated that any combination of one or more of these metrics may be used.

In some embodiments, the system for delivery metric analysis and notification may also receive or determine a driver performance report (which may be in whole or in part be provided by a third-party such as Amazon®, Netradyne®, and/or Mentor®) including: trips, miles, time, FICO® safe driving score, acceleration, braking, cornering, speeding, distraction, seatbelt, back up, scorecard, speeding event, miles-per-gallon, idling, engine off, pre daily vehicle condition report compliance, post daily vehicle condition report compliance, training assigned, and training completed. In this context, FICO® may be the score a driver receives from the company reachable at https://edriving.com/mentor/. It will be appreciated that any combination of one or more of these metrics may be used.

In some embodiments, the system for delivery metric analysis and notification may also receive or determine active car monitoring alerts including: following distances, hard braking, hard acceleration, high g (acceleration), traffic light violation, hard turn, sign violations, speeding violations, seatbelt compliance, driver initiated, weaving, U-turns, driver drowsiness, driver distraction, camera obstruction, face mask compliance, requested video, low impact, and driverstar. It will be appreciated that any combination of one or more of these metrics may be used.

In some embodiments, as shown in FIG. 1, a main performance screen may also include attrition projections or attrition history. Attrition projections may include a determination of time until attrition and/or a status corresponding to one or more delivery associates.

In some embodiments, as shown in FIG. 1, a main performance screen may include a performance rating relating to at least one of an overall performance, a quality of performance, a team quality of performance, and a safety and compliance performance. The performance rating may be based on one or more metrics determined from delivery metrics.

In some embodiments, as shown in FIG. 1, a main performance screen may include imported performance data wherein the imported performance data comprises one or more delivery metrics.

In some embodiments, as shown in FIG. 1, a main performance screen may correspond with one or more instances of imported performance data. In other embodiments, the main performance screen may correspond with a given time period.

In some embodiments, delivery metrics may be gathered or generated by a delivery metric gathering device, which may be operated by an entity separate from the driver. In some embodiments, the delivery metrics gathered by the delivery metric gathering device may be processed or analyzed by a delivery metric analysis device, which may be operated by an entity separate from the driver and the entity responsible for operating the delivery metric gathering device. In some embodiments a driver device may be operated by a driver, and a manager device may be operated by a manager. The driver device may be configured to send and receive communications with the system. The manager device may be configured to send and receive communications with the system. In some embodiments, the manager may be a person designated to supervise, train, or otherwise communicate with driver with the goal of improving the driver with respect to the driver's metrics.

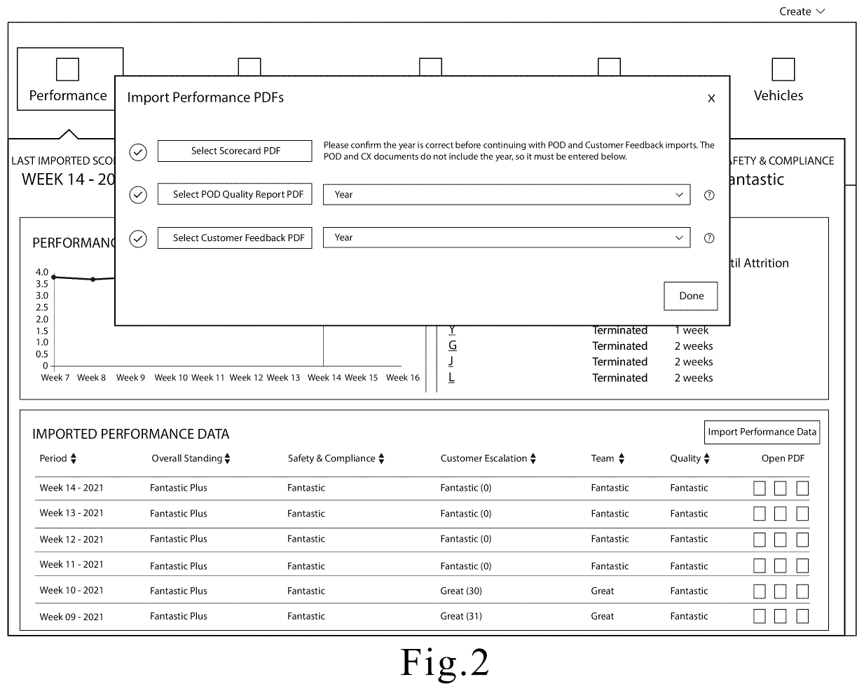

FIG. 2 is an illustration of one embodiment of a performance import pop-up of a system for delivery metric analysis and notification. In some embodiments, the performance import pop-up screen may allow a user to import performance data associated with one or more delivery metrics. In some embodiments, the performance import pop-up screen may allow a user to select different types of performance data to import, such as proof of delivery quality report and/or customer feedback.

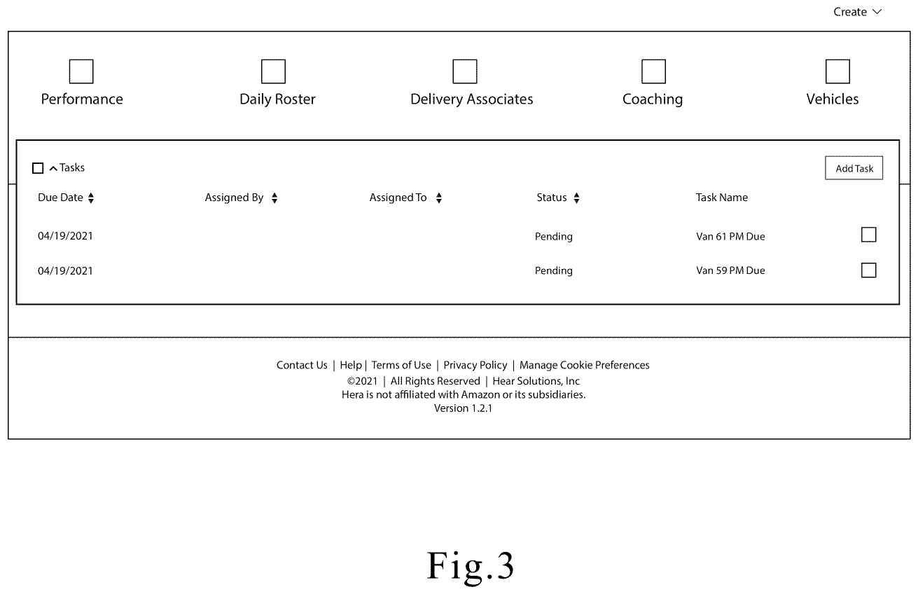

FIG. 3 is an illustration of one embodiment of a task management screen of a system for delivery metric analysis and notification. In some embodiments, the task management screen may comprise one or more tasks, each task assigned by a first user and assigned to a second user, wherein the first user and the second user may or may not correspond to the same person.

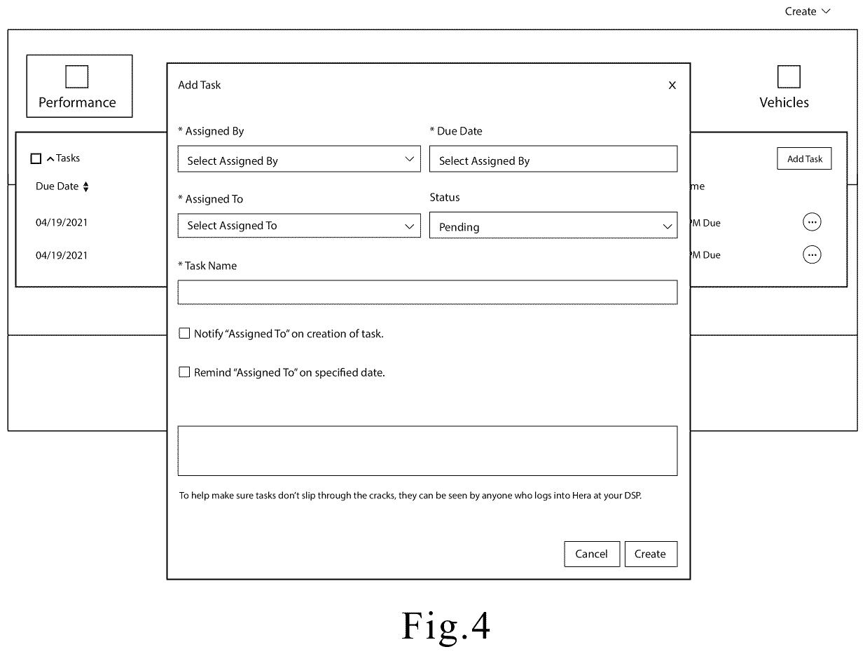

FIG. 4 is an illustration of one embodiment of a task addition pop-up of a system for delivery metric analysis and notification.

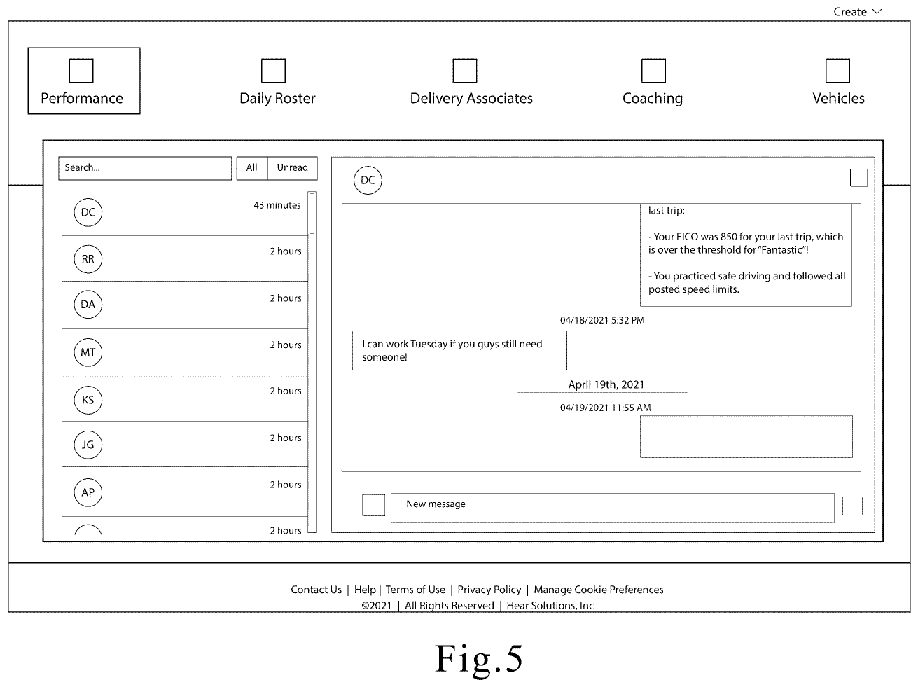

FIG. 5 is an illustration of one embodiment of a messaging interface of a system for delivery metric analysis and notification. In some embodiments, the messaging interface may be adapted to connect to a short message service (SMS) or other service adapted to send messages wirelessly such as email.

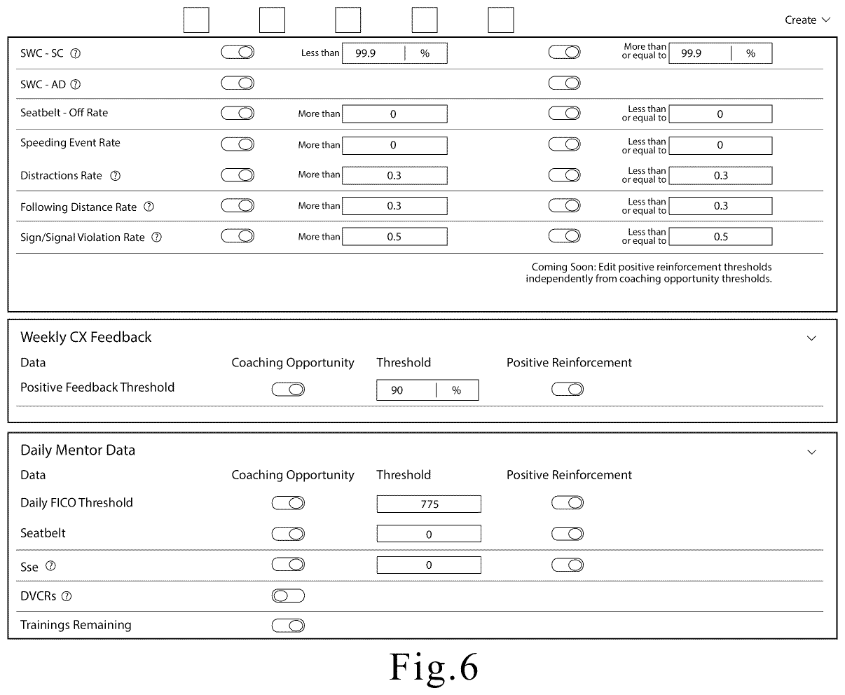

FIG. 6 is an illustration of one embodiment of a coaching preferences screen of a system for delivery metric analysis and notification. In some embodiments, coaching preferences screen may allow a first user to assign value ranges to one or more delivery metrics associated with one or more second users. The system for delivery metric analysis and notification may be adapted to determine, based on an input to the coaching preferences screen and based on delivery metrics associated with one or more second users, a message to send to the one or more second users. For example, upon a determination that the delivery metrics associated with a second user are above a value range set by a first user, system for delivery metric analysis and notification may send a positive reinforcement message to the second user. Alternatively, upon a determination that the delivery metrics associated with a second user are below a value range set by a first user, system for delivery metric analysis and notification may send a coaching message to the second user, informing the second user of how to improve their delivery metrics. In some embodiments, the first user may also receive notifications relating to the coaching preferences and messages, such as when delivery metrics associated with the first user deviate from the assigned value ranges.

In some embodiments, the second user may have the ability to assign value ranges to one or more delivery metrics associated with the second user. In this way, the second user may be sent messages when the value ranges assigned by either the first or second user. In some embodiments, the first user may also be sent messages based on deviations from the value ranges determined by the second user. In some embodiments, the first and second users may receive different messages based on the same delivery metrics, depending on what specific metrics deviate from which assigned value ranges. In some embodiments, the first and second users may be sent only messages based on their own assigned value ranges. In other embodiments, the first and second users may be sent messages based on any assigned value ranges. In yet other embodiments, a third user may assign value ranges and/or be sent messages. In other embodiments, any number of users may assign value ranges and/or be sent messages.

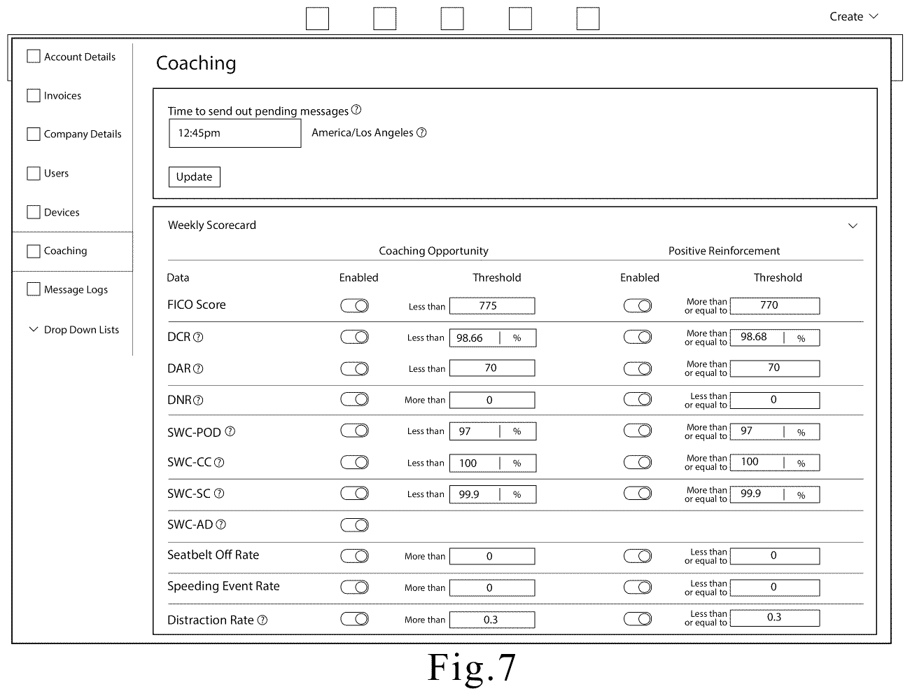

FIG. 7 is another illustration of one embodiment of a coaching preferences screen of a system for delivery metric analysis and notification. As shown in FIG. 7 the screen allows the users to enable or disable specific metrics for coaching opportunities and positive reinforcement opportunities. Examples of specific metrics that a user can enable or disable include, but are not limited to the following: Delivery Completion Rate (“DCR”); Delivered and Received (“DAR”); Did Not Receive (“DNR”); Standard Work Compliance (“SWC”); Picture on Delivery (“POD”); Contact Compliance (“CC”); Scan Compliance (“SC”); and Attended Delivery (“AD”).

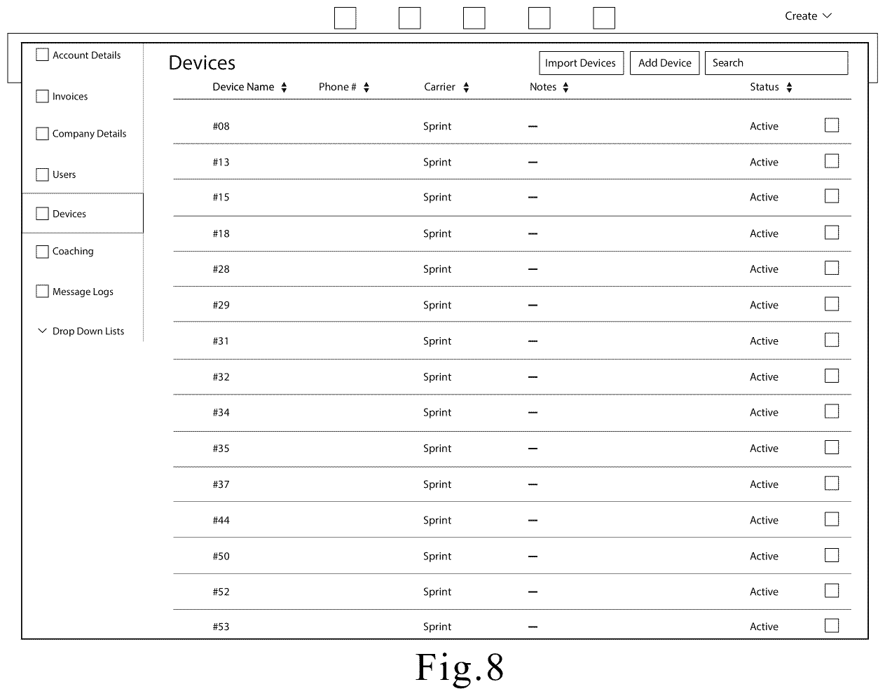

FIG. 8 is an illustration of one embodiment of a messaging device manager of a system for delivery metric analysis and notification. In some embodiments, messaging device manager may comprise one or more devices each associated with one or more users. The one or more devices may be adapted to receive messages from the system for delivery metric analysis and notification. The one or more devices may be smart or cellular phones. Devices may be imported or added from this screen.

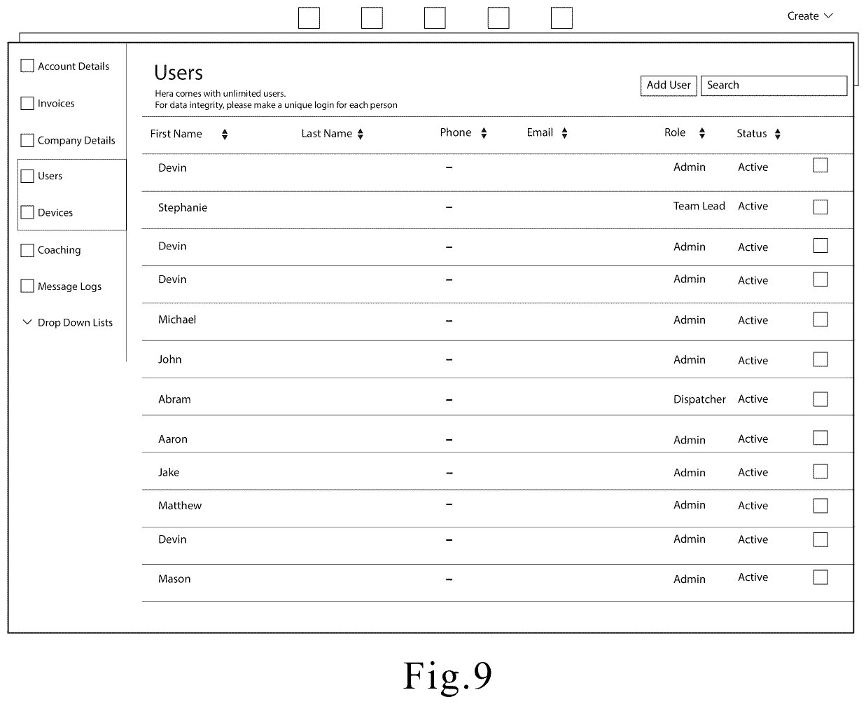

FIG. 9 is an illustration of one embodiment of a user management screen of a system for delivery metric analysis and notification. As shown, the system may track the users role, such as Admin, Team Lead, Dispatcher, and the like. The user's status may be displayed and updated.

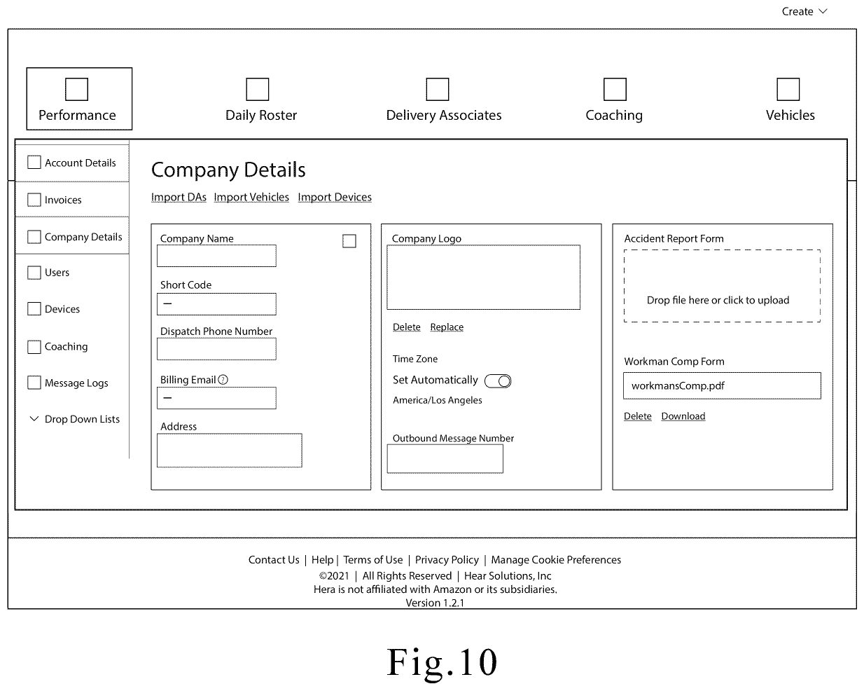

FIG. 10 is an illustration of one embodiment of a company details screen of a system for delivery metric analysis and notification. In addition to the basic name, address and contact information, the company details screen may allow the inclusion of a logo and forms that are specific to that company, such as accident report and workman's compensation.

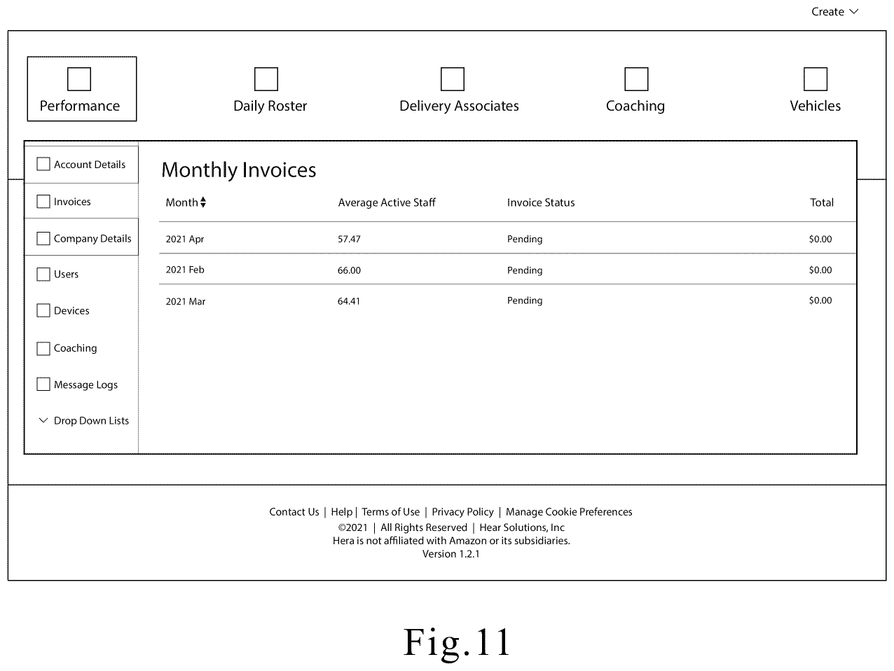

FIG. 11 is an illustration of one embodiment of a monthly invoices screen of a system for delivery metric analysis and notification.

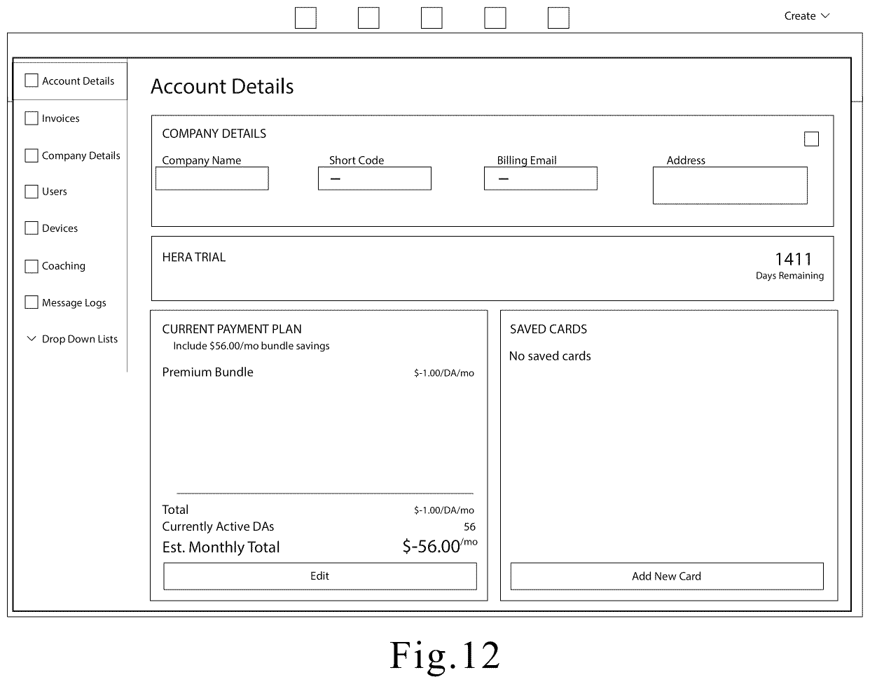

FIG. 12 is an illustration of one embodiment of an account details screen of a system for delivery metric analysis and notification.

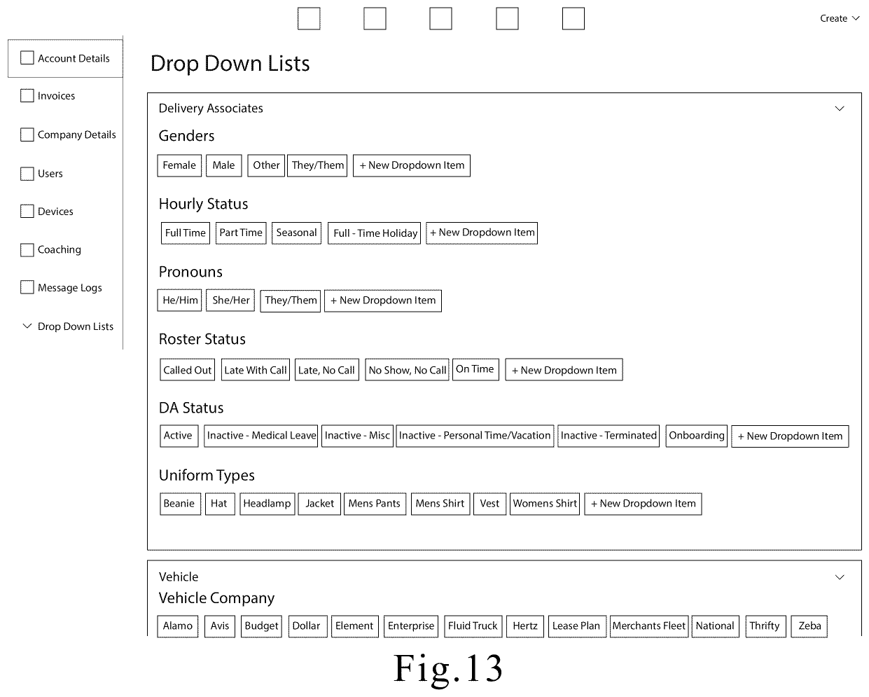

FIG. 13 is an illustration of one embodiment of a drop-down list customization screen of a system for delivery metric analysis and notification. This allows for the customization of what options may be selected when setting parameters, such as gender, hourly status, roster status, delivery associate status, and uniform type. In addition to already created or provided selections, the system allows the creation of new selections in each parameter.

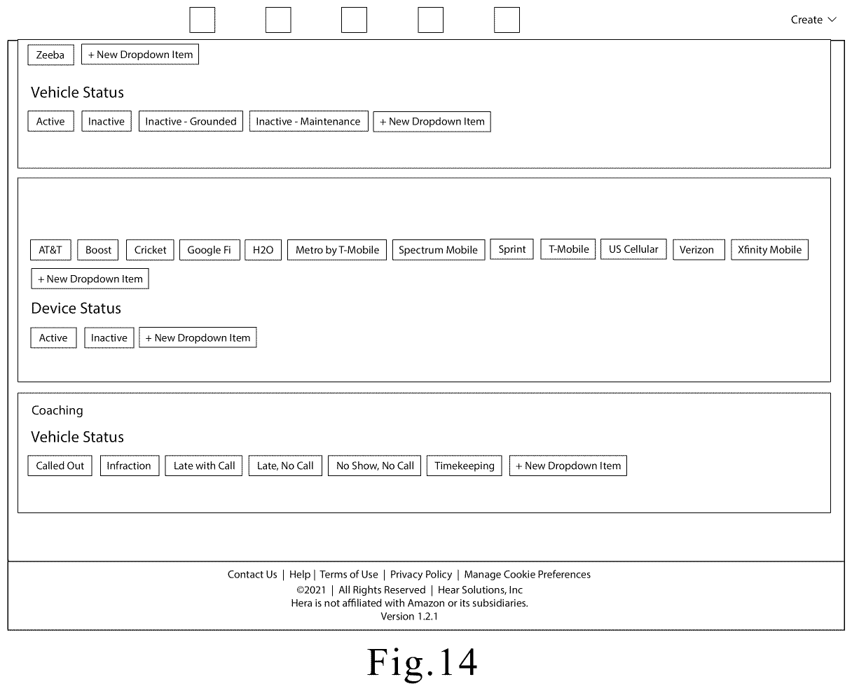

FIG. 14 is another illustration of one embodiment of a drop-down list customization screen of a system for delivery metric analysis and notification. FIG. 14 shows that the customization may further comprise vehicle status, device carrier, device status, and delivery associate issue types.

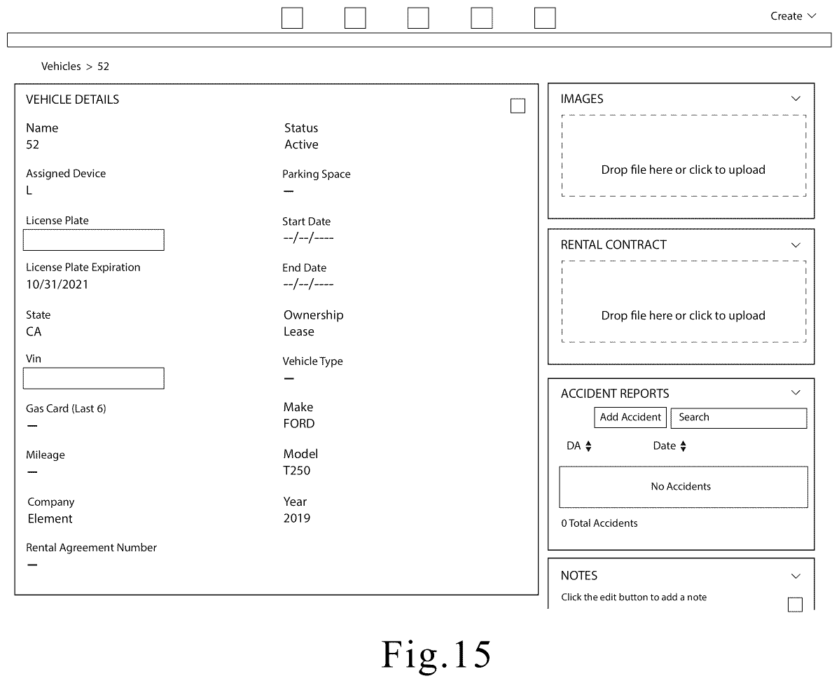

FIG. 15 is an illustration of one embodiment of a vehicle detail screen of a system for delivery metric analysis and notification. As shown in FIG. 15, images of the vehicle may be uploaded. Additionally, the rental contracts involving this vehicle may also be uploaded. Further, accident reports may be made and accessed from this screen.

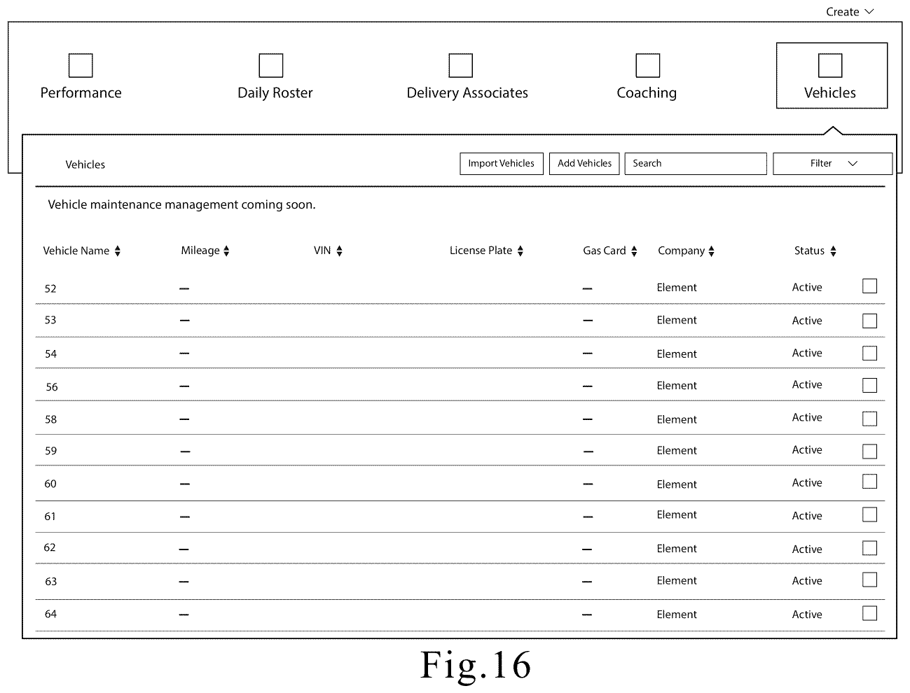

FIG. 16 is an illustration of one embodiment of an overall vehicle view screen of a system for delivery metric analysis and notification. In some embodiments, overall vehicle view screen may display one or more vehicles each associated with one or more users. The system may allow vehicles to be added or imported. Various factors related to each vehicle may be presented including name, mileage, identification number, license plate, associated gas card number, the company using the vehicle, and the status of the vehicle.

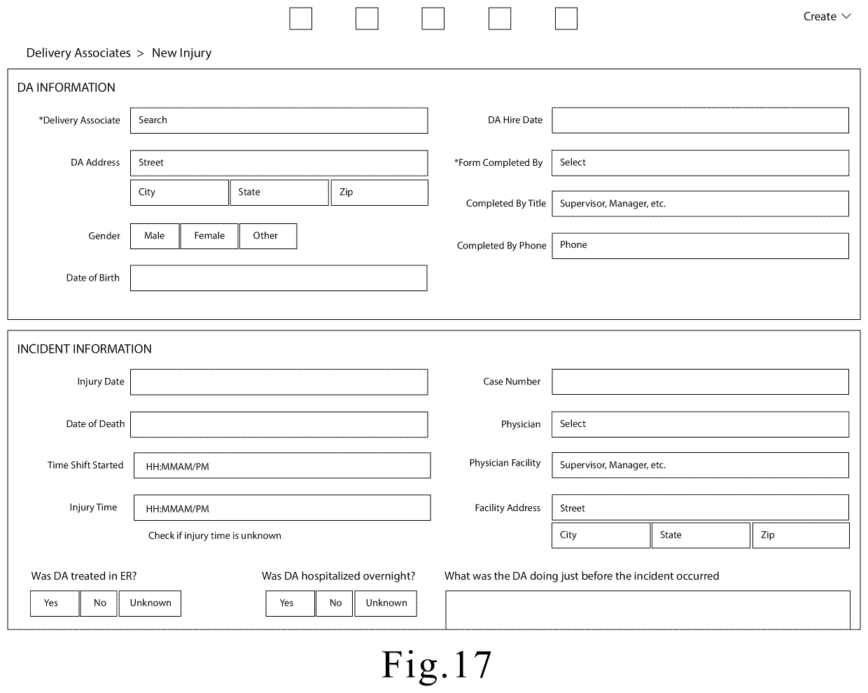

FIG. 17 is an illustration of one embodiment of an injury form input screen of a system for delivery metric analysis and notification.

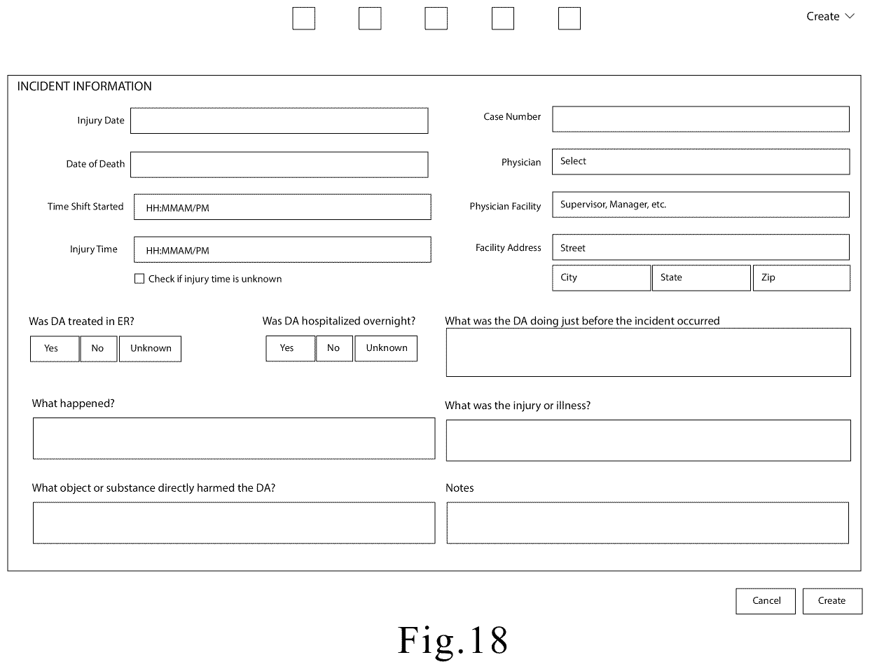

FIG. 18 is another illustration of one embodiment of an injury form input screen of a system for delivery metric analysis and notification.

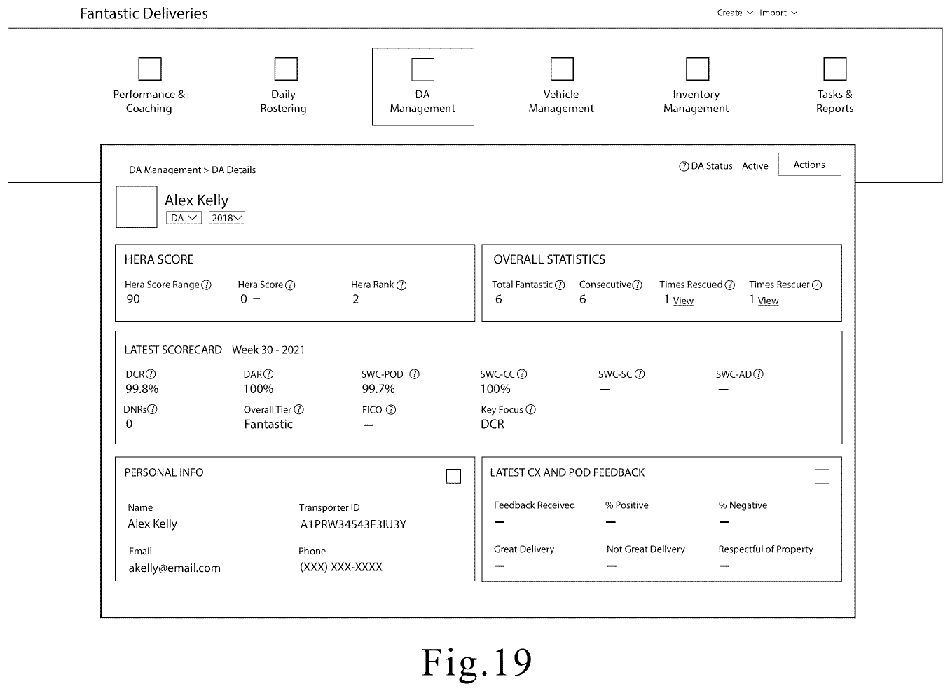

FIG. 19 is an illustration of one embodiment of a delivery associate details page of a system for delivery metric analysis and notification, consistent with some embodiments of the present disclosure. As shown in FIG. 19, the delivery associate detail may provide a picture, contact information, a summary of how well the driver is performing, and various performance metrics/statistics.

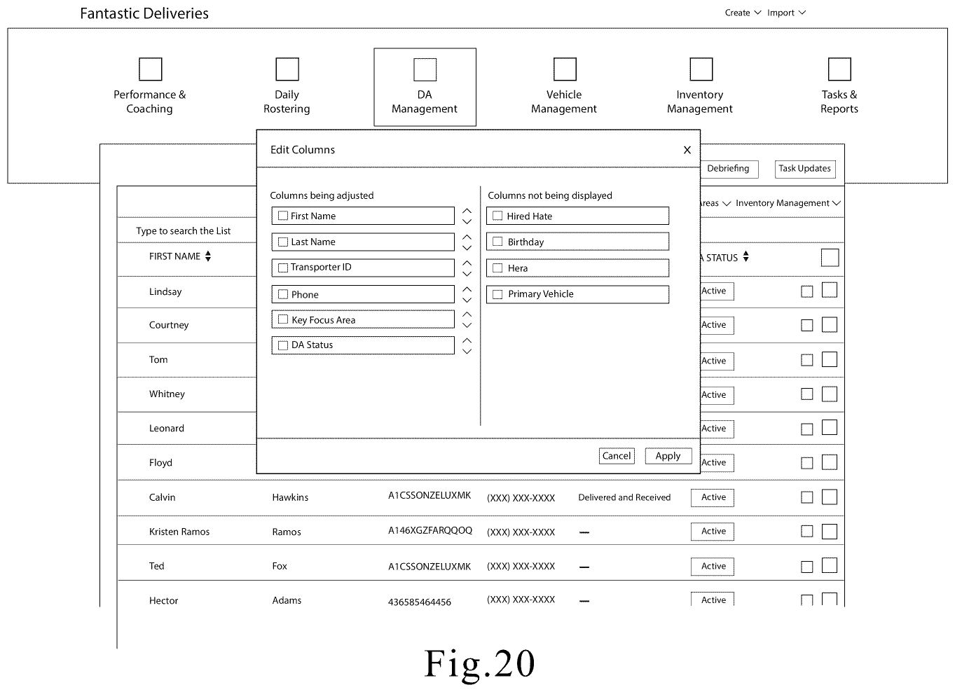

FIG. 20 is an illustration of one embodiment of a customization screen for the delivery association list of a system for delivery metric analysis and notification, consistent with some embodiments of the present disclosure.

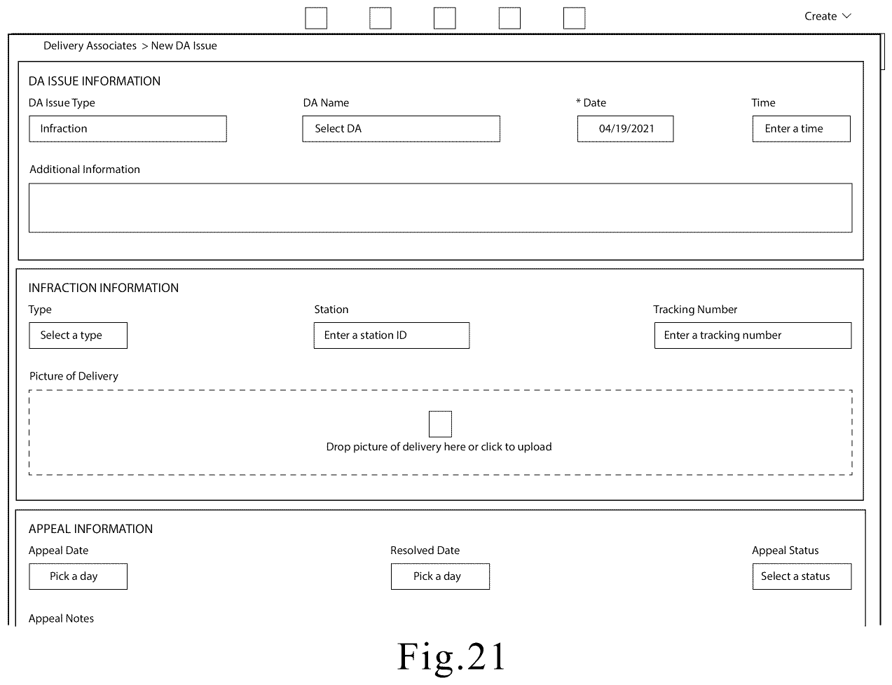

FIG. 21 is an illustration of one embodiment of a delivery associate issue input screen of a system for delivery metric analysis and notification.

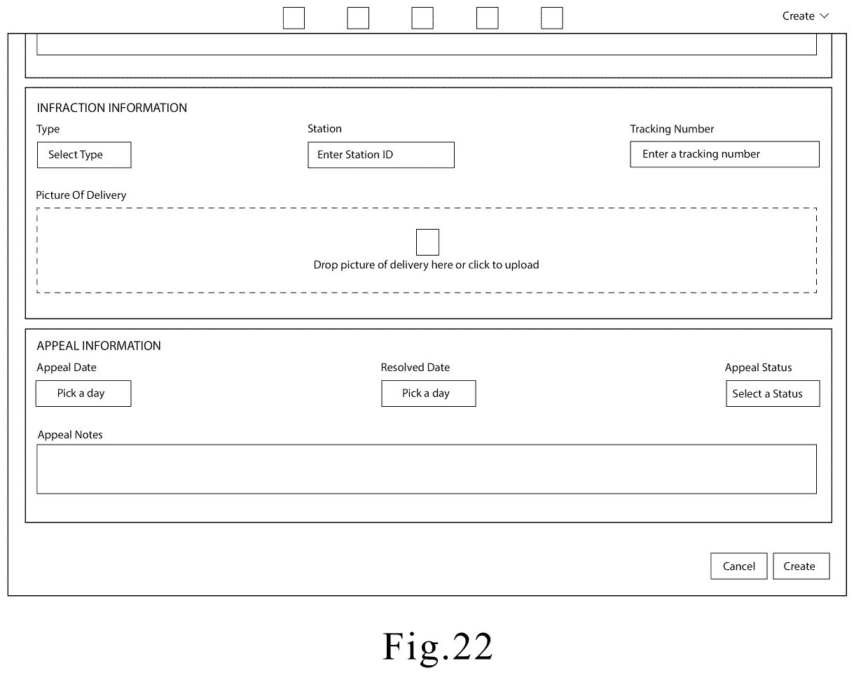

FIG. 22 is another illustration of one embodiment of a delivery associate issue input screen of a system for delivery metric analysis and notification.

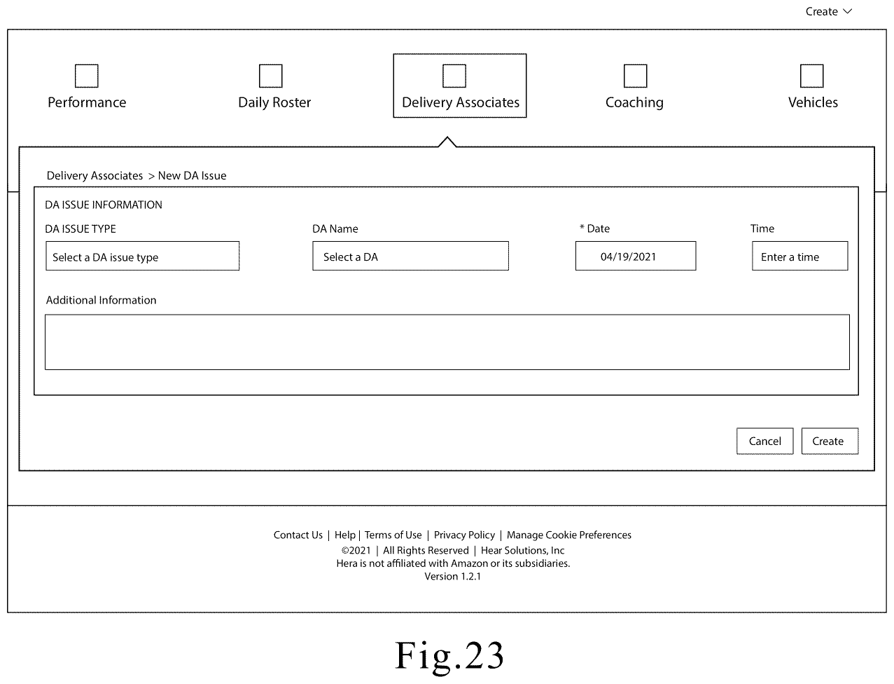

FIG. 23 is an illustration of one embodiment of a delivery associate issue input screen of a system for delivery metric analysis and notification.

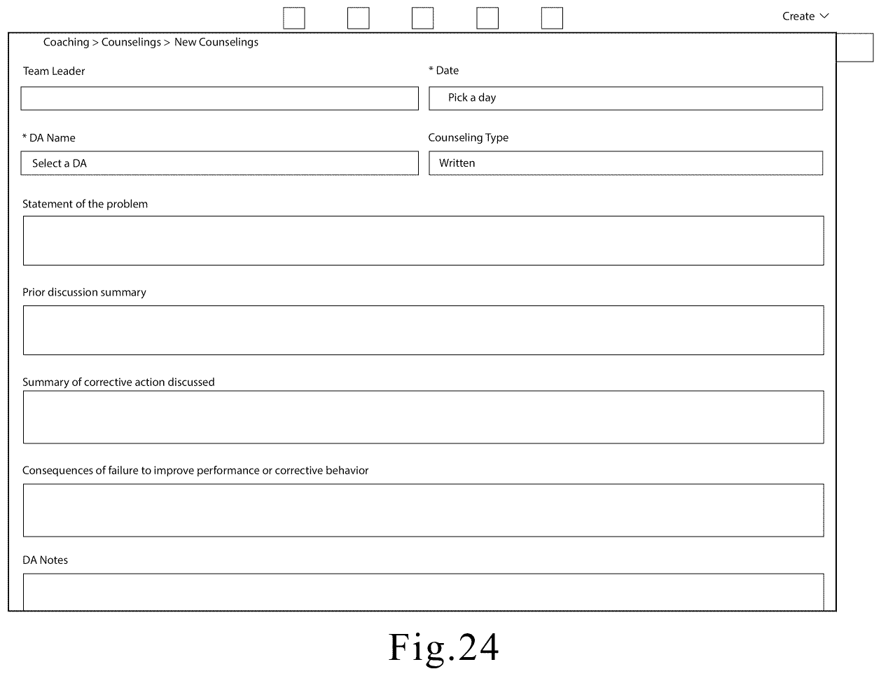

FIG. 24 is an illustration of one embodiment of a counseling input screen of a system for delivery metric analysis and notification.

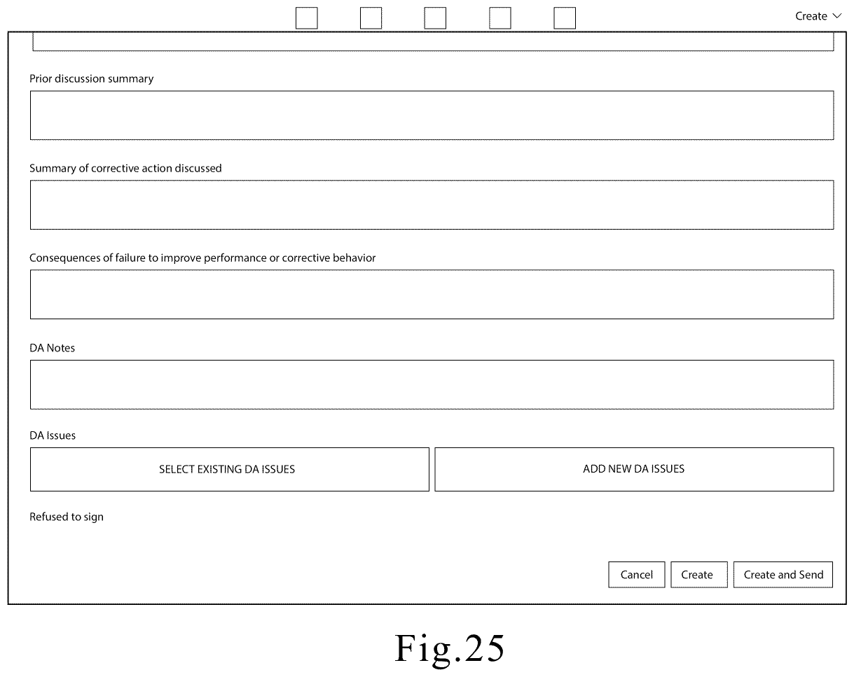

FIG. 25 is another illustration of one embodiment of a counseling input screen of a system for delivery metric analysis and notification.

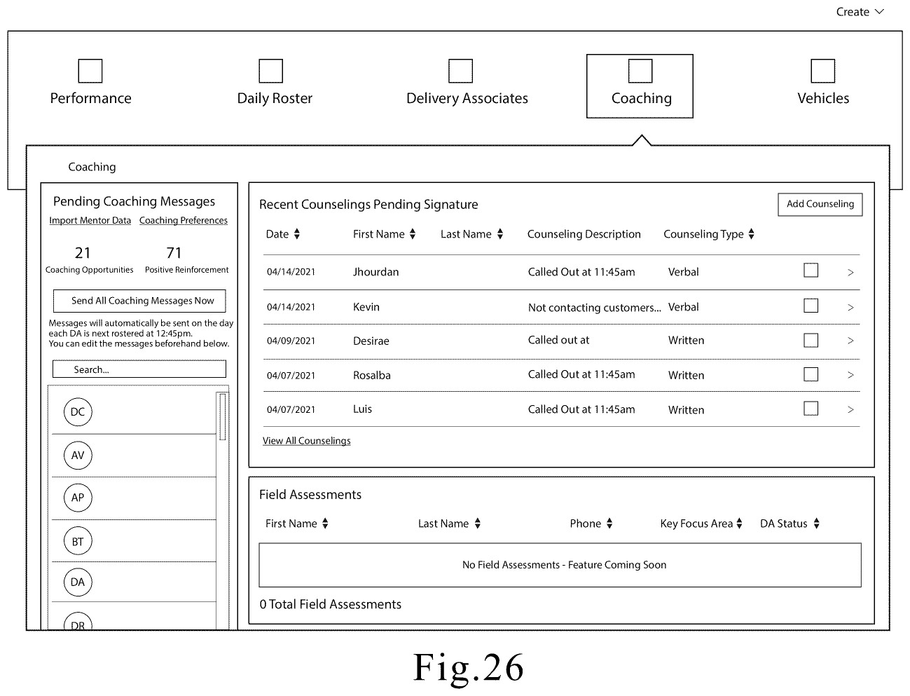

FIG. 26 is an illustration of one embodiment of a main coaching screen of a system for delivery metric analysis and notification. As shown in FIG. 26, the system may display pending coaching messages to be sent, recent counselings that need signature feedback, and field assessments conducted.

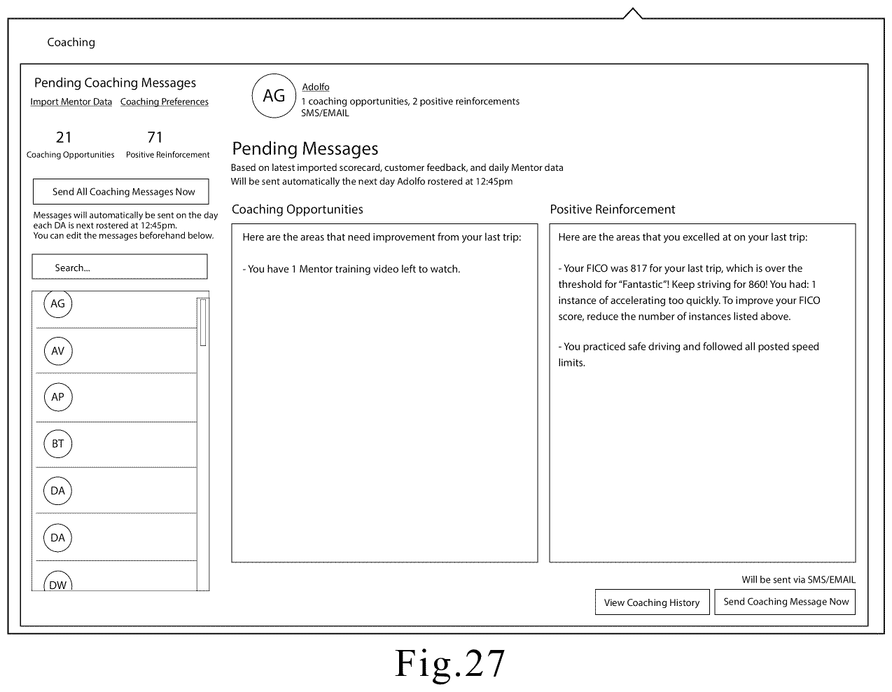

FIG. 27 is an illustration of one embodiment of a coaching messages screen of a system for delivery metric analysis and notification. When a pending message is selected from the list on the left, the specifics of the pending message are displayed, including what coaching opportunities and positive reinforcement may or will be provided to the delivery associate.

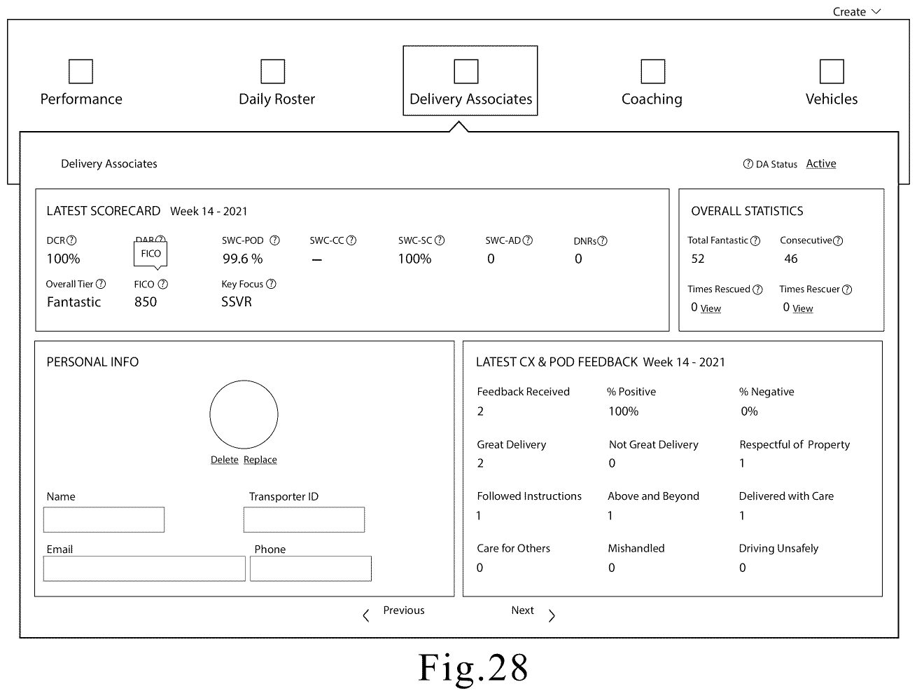

FIG. 28 is an illustration of one embodiment of a detailed delivery associate screen of a system for delivery metric analysis and notification. As shown, the delivery associate screen may provide a picture, personal information, past feedback, a summary of the overall statistics, and the latest scorecard.

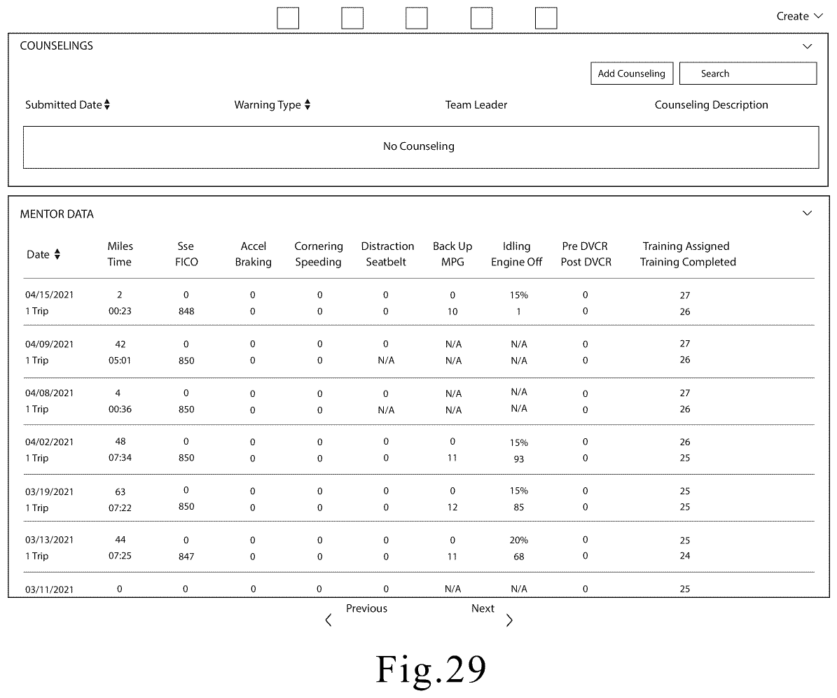

FIG. 29 is another illustration of one embodiment of a detailed delivery associate screen of a system for delivery metric analysis and notification. FIG. 29 provides the counselings and Mentor® data statistics for a particular delivery associate and allows additional counselings to be added.

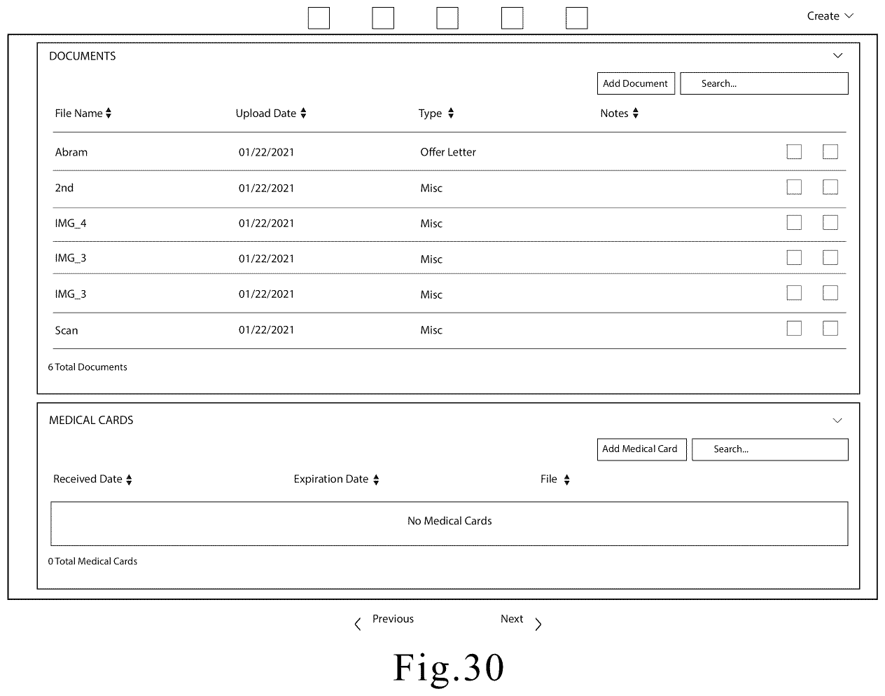

FIG. 30 is another illustration of one embodiment of a detailed delivery associate screen of a system for delivery metric analysis and notification. FIG. 30 shows that documents and medical cards may be added for specific delivery associates.

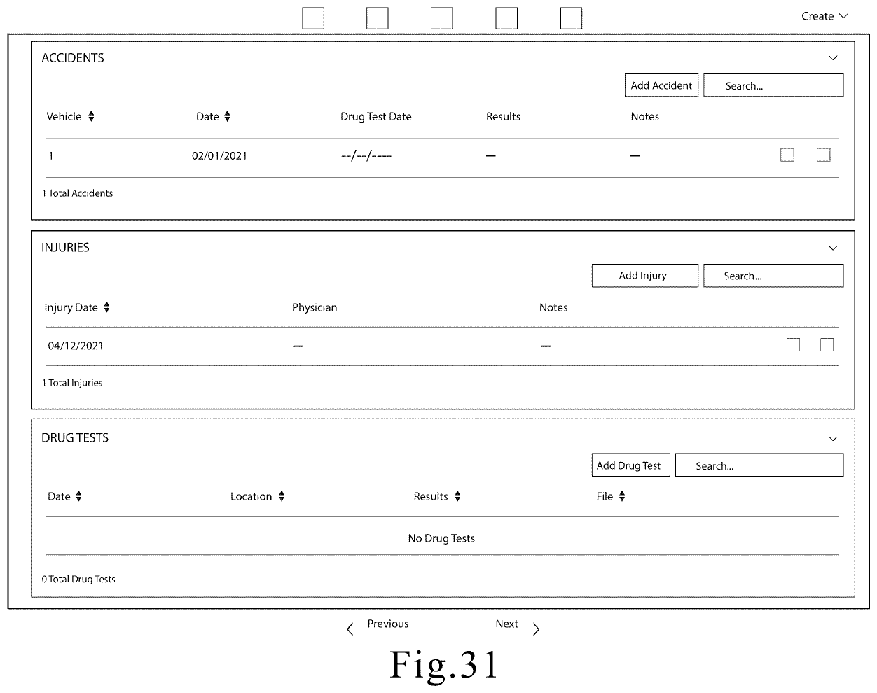

FIG. 31 is another illustration of one embodiment of a detailed delivery associate screen of a system for delivery metric analysis and notification. FIG. 31 shows that accidents, injuries, and drug tests may be added for specific delivery associates.

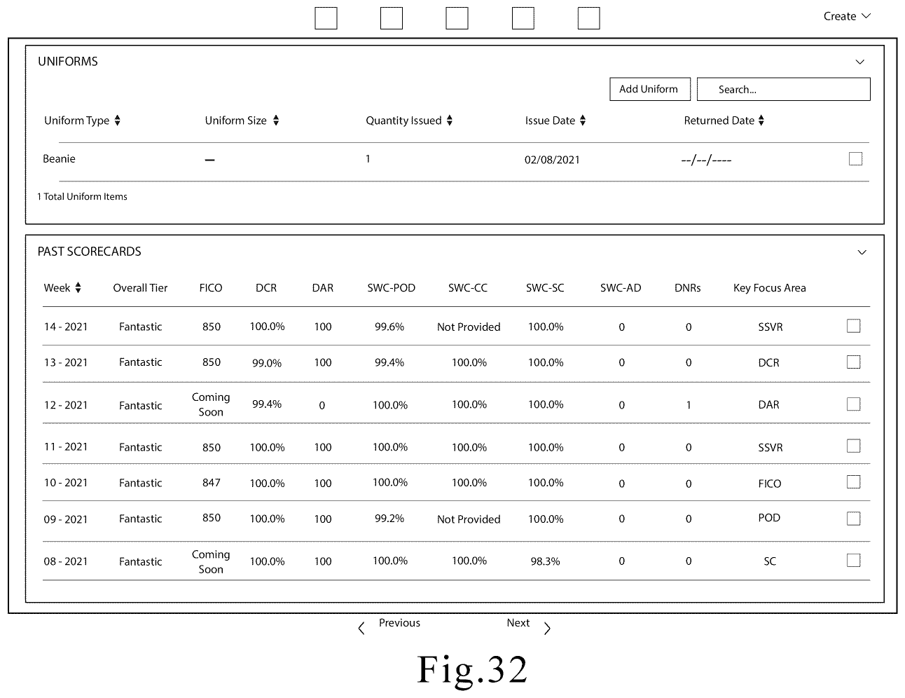

FIG. 32 is another illustration of one embodiment of a detailed delivery associate screen of a system for delivery metric analysis and notification. FIG. 32 shows that uniforms may be added and past scorecards may be listed and accessed.

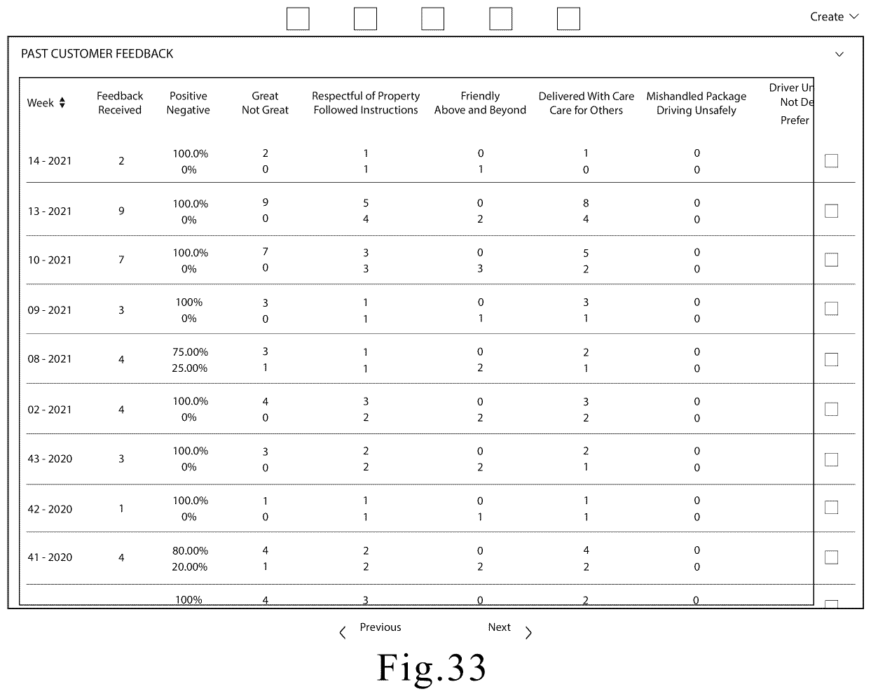

FIG. 33 is another illustration of one embodiment of a detailed delivery associate screen of a system for delivery metric analysis and notification. FIG. 33 shows that past customer feedback and details may be provided.

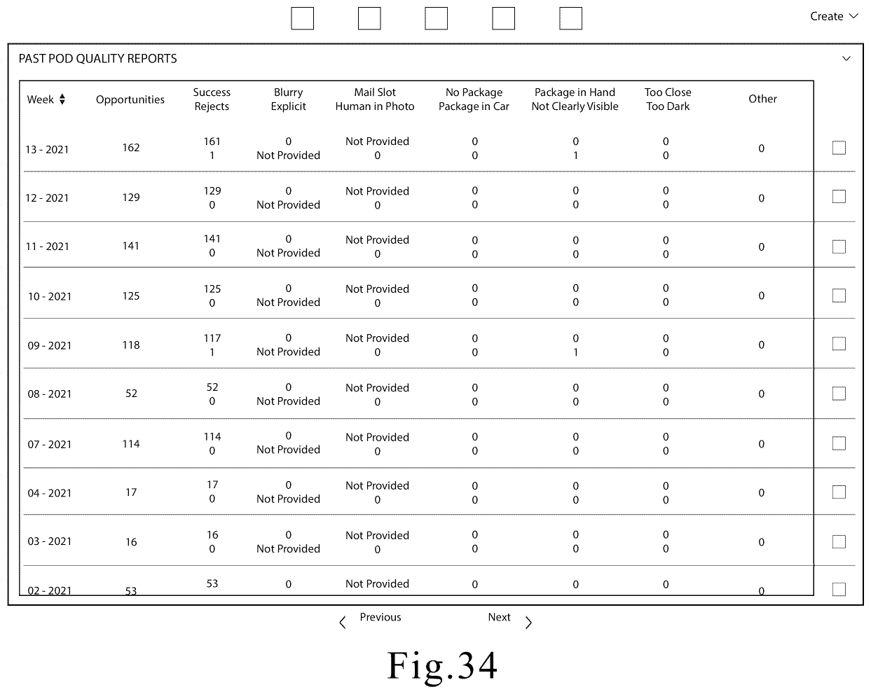

FIG. 34 is another illustration of one embodiment of a detailed delivery associate screen of a system for delivery metric analysis and notification. FIG. 34 shows that past Picture on Delivery (“POD”) Quality Reports may be provided.

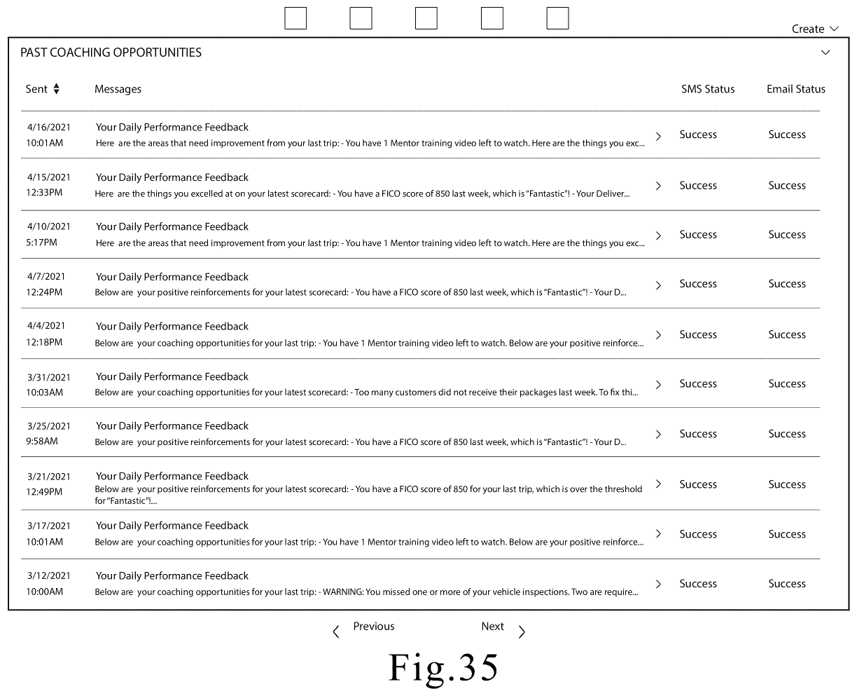

FIG. 35 is another illustration of one embodiment of a detailed delivery associate screen of a system for delivery metric analysis and notification. FIG. 35 shows that past coaching opportunities may be listed.

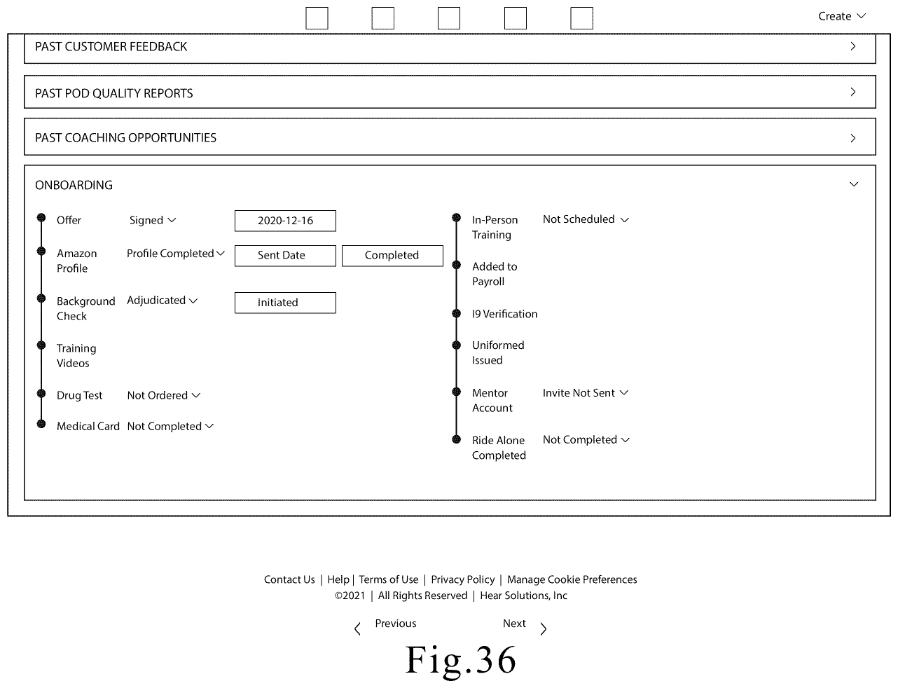

FIG. 36 is another illustration of one embodiment of a detailed delivery associate screen of a system for delivery metric analysis and notification. FIG. 36 shows that the details, such as customer feedback and POD Quality Reports may be collapsed and expanded, as desired. FIG. 36 shows that an onboarding timeline/summary may be provided.

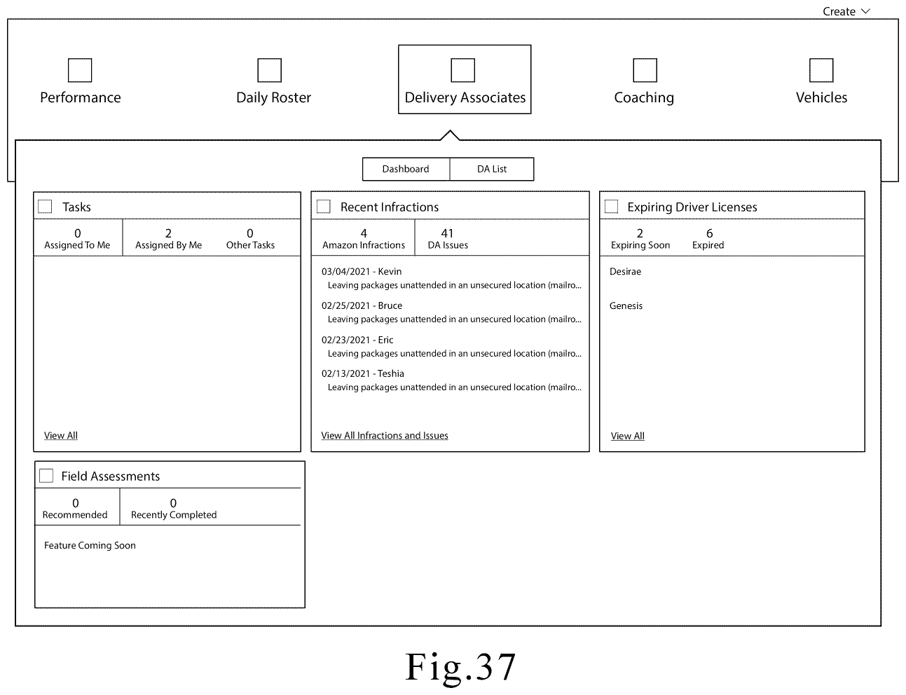

FIG. 37 is an illustration of one embodiment of a dashboard view of delivery associates screen of a system for delivery metric analysis and notification.

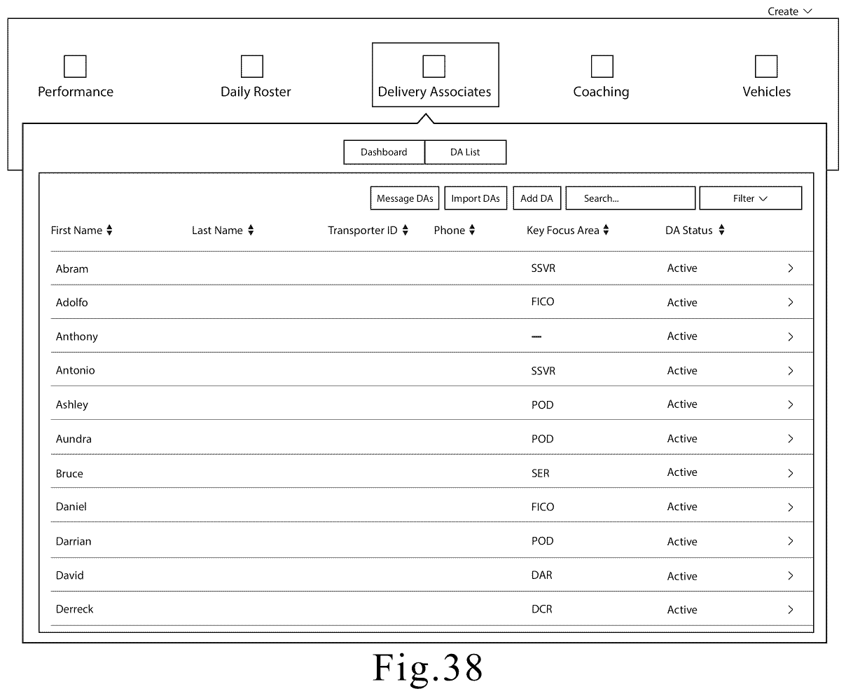

FIG. 38 is an illustration of one embodiment of a view of all delivery associates screen of a system for delivery metric analysis and notification. FIG. 38 shows a list of delivery associates and the ability to add associates, import associates, or message the associates.

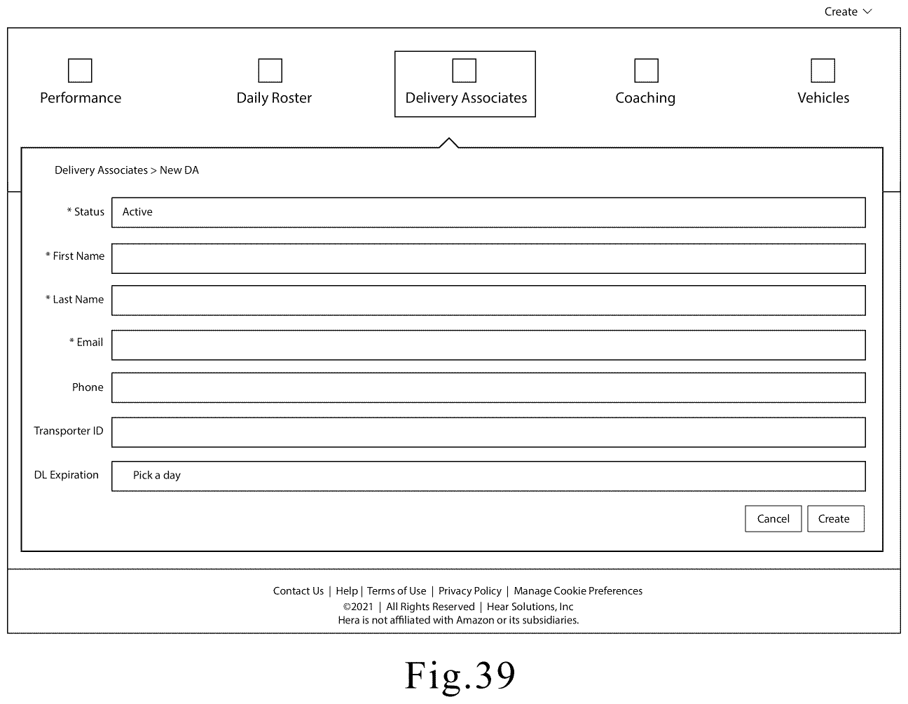

FIG. 39 is an illustration of one embodiment of a delivery associate addition screen of a system for delivery metric analysis and notification.

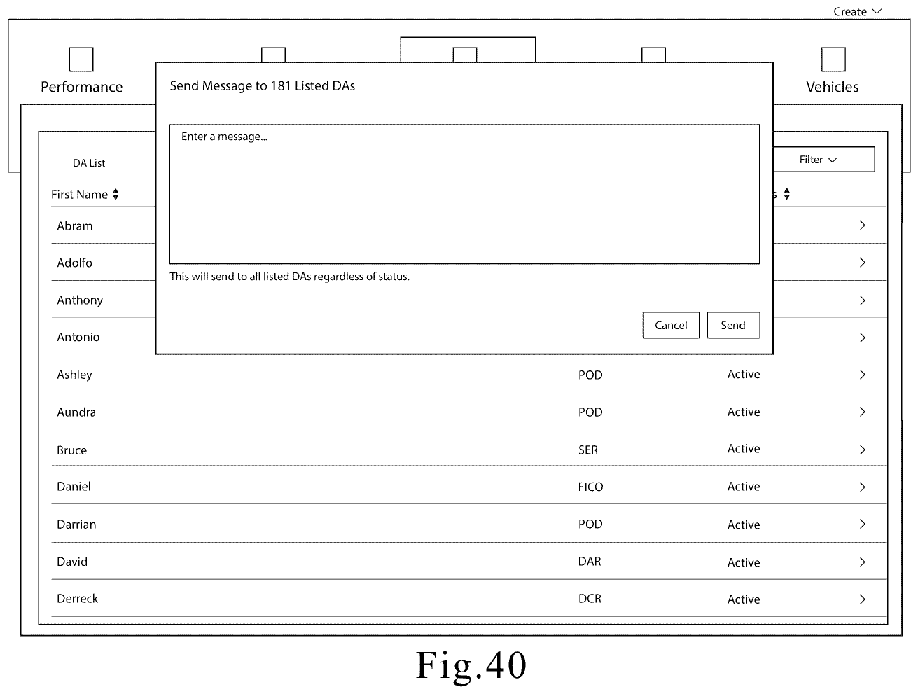

FIG. 40 is an illustration of one embodiment of a broadcast messaging screen of a system for delivery metric analysis and notification. FIG. 40 shows that a single message may be sent to all of the delivery associates.

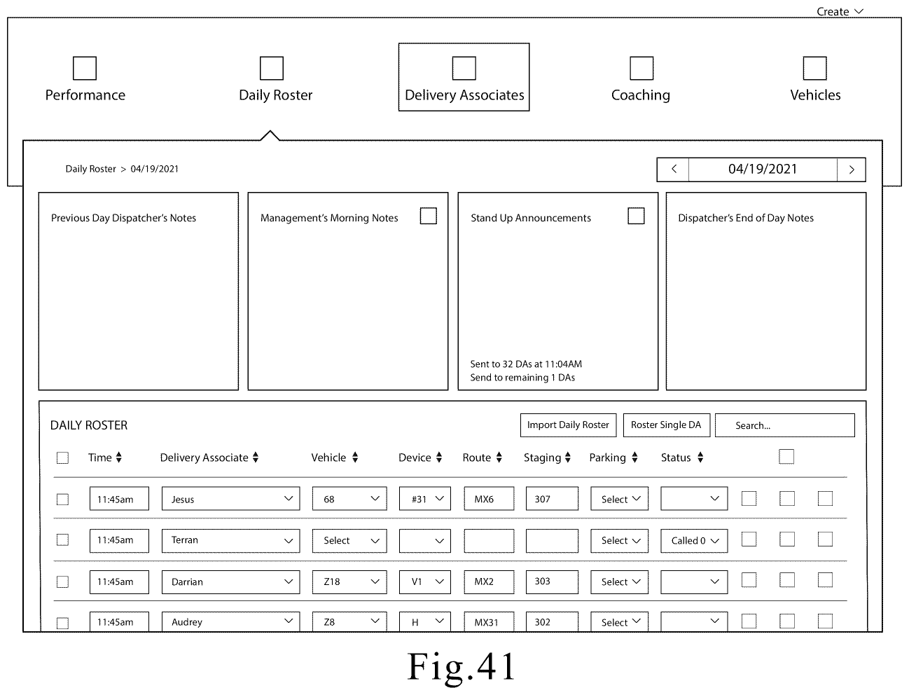

FIG. 41 is an illustration of one embodiment of a daily roster screen of a system for delivery metric analysis and notification.

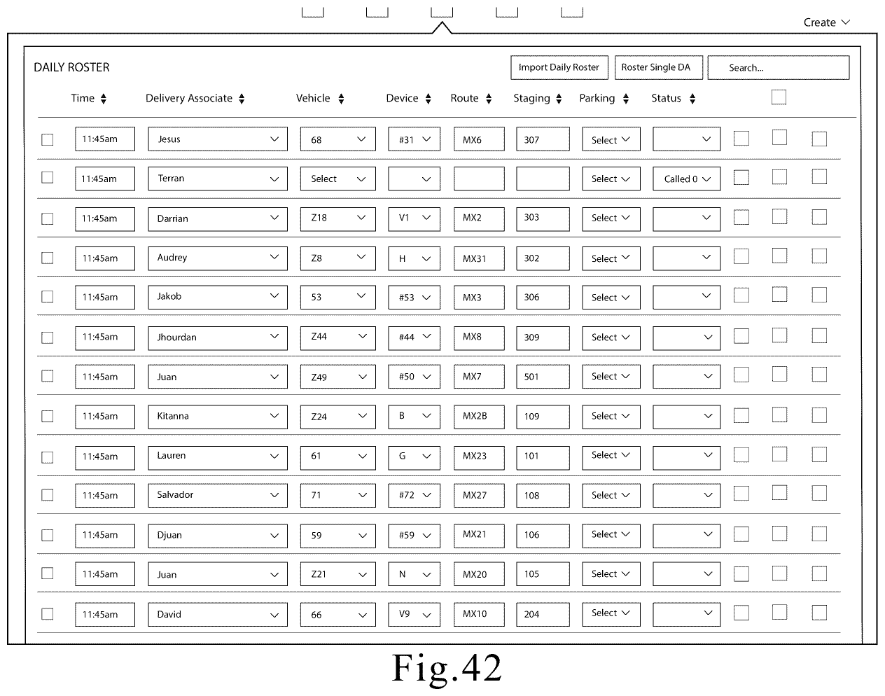

FIG. 42 is another illustration of one embodiment of a daily roster screen of a system for delivery metric analysis and notification.

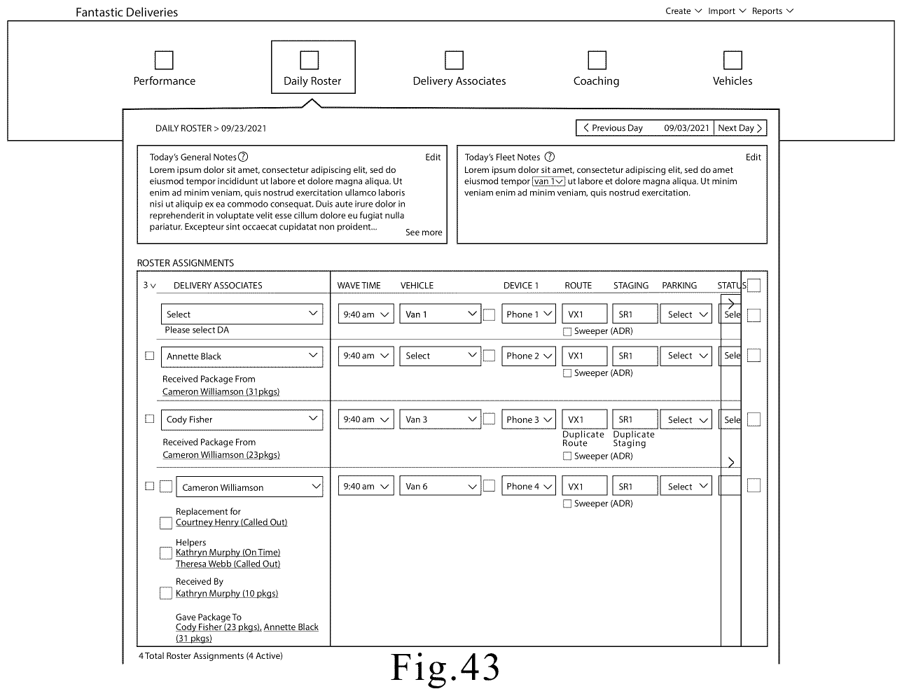

FIG. 43 is another illustration of one embodiment of a daily roster screen of a system for delivery metric analysis and notification.

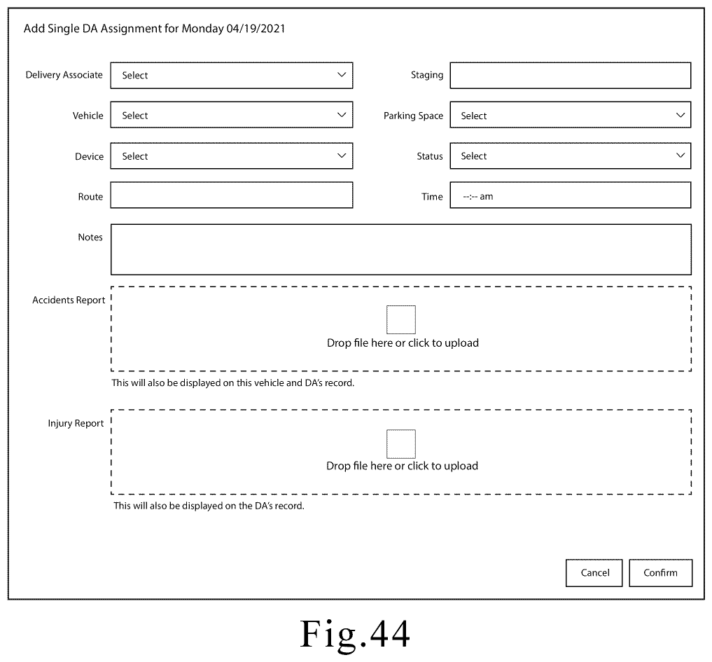

FIG. 44 is an illustration of one embodiment of a daily roster assignment addition screen of a system for delivery metric analysis and notification.

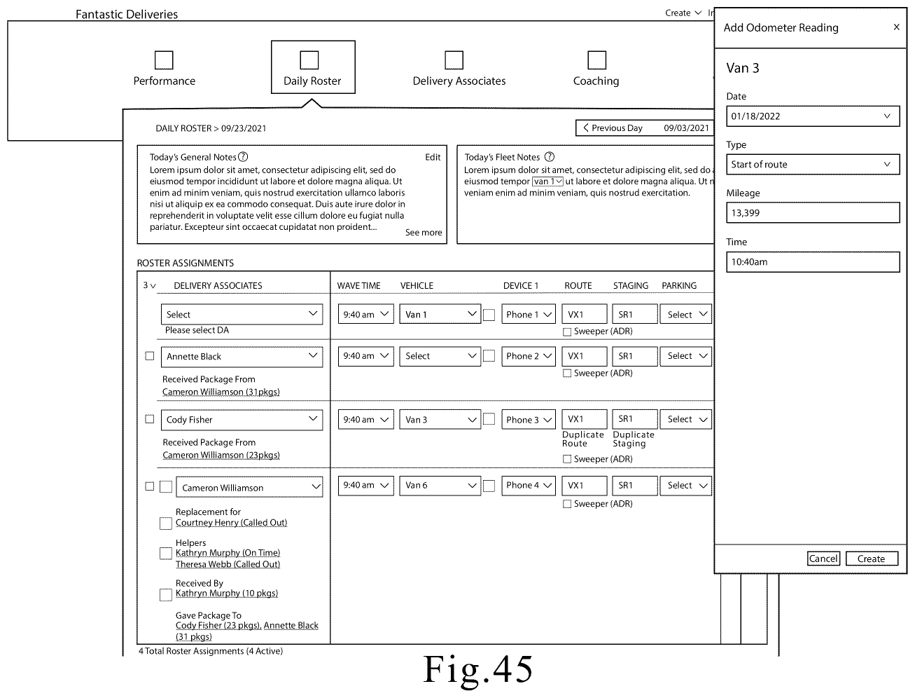

FIG. 45 is an illustration of one embodiment of a daily roster odometer reading input screen of a system for delivery metric analysis and notification.

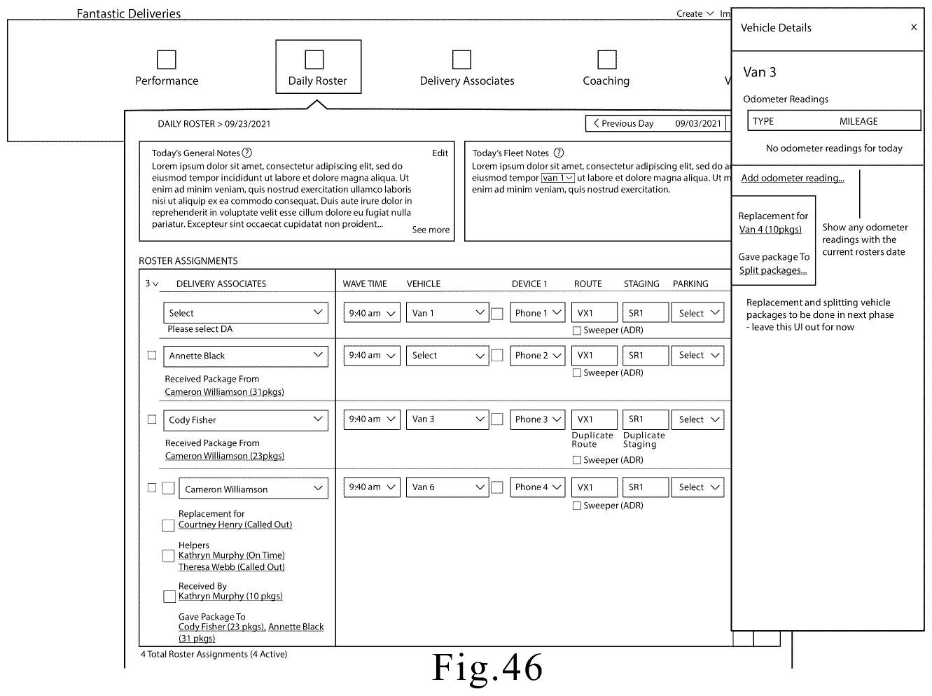

FIG. 46 is another illustration of one embodiment of a daily roster odometer reading input screen of a system for delivery metric analysis and notification.

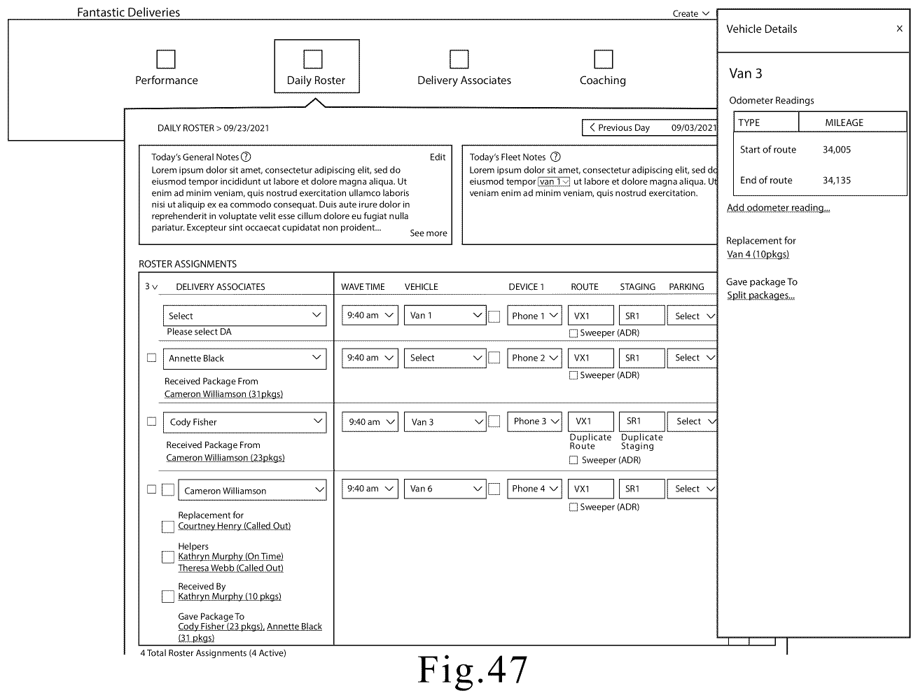

FIG. 47 is another illustration of one embodiment of a daily roster odometer reading input screen of a system for delivery metric analysis and notification.

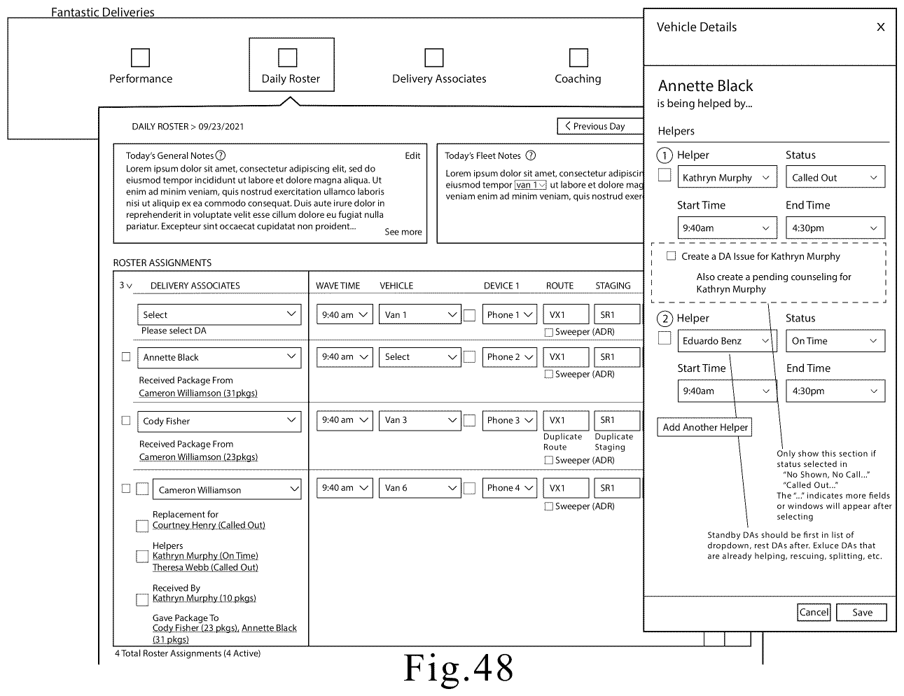

FIG. 48 is an illustration of one embodiment of a daily roster helper screen of a system for delivery metric analysis and notification.

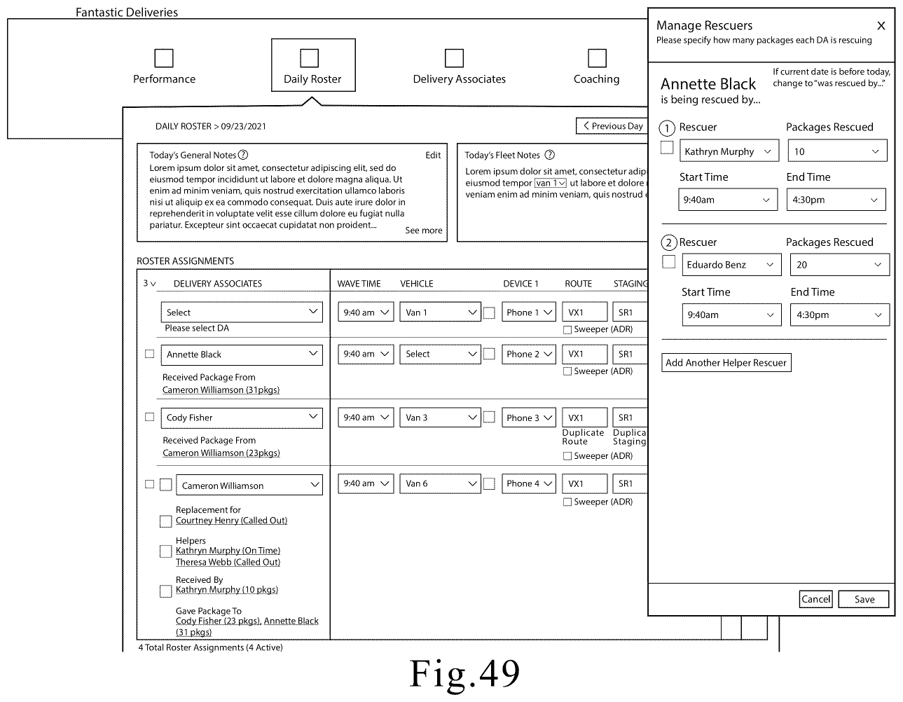

FIG. 49 is an illustration of one embodiment of a daily roster rescuer screen of a system for delivery metric analysis and notification.

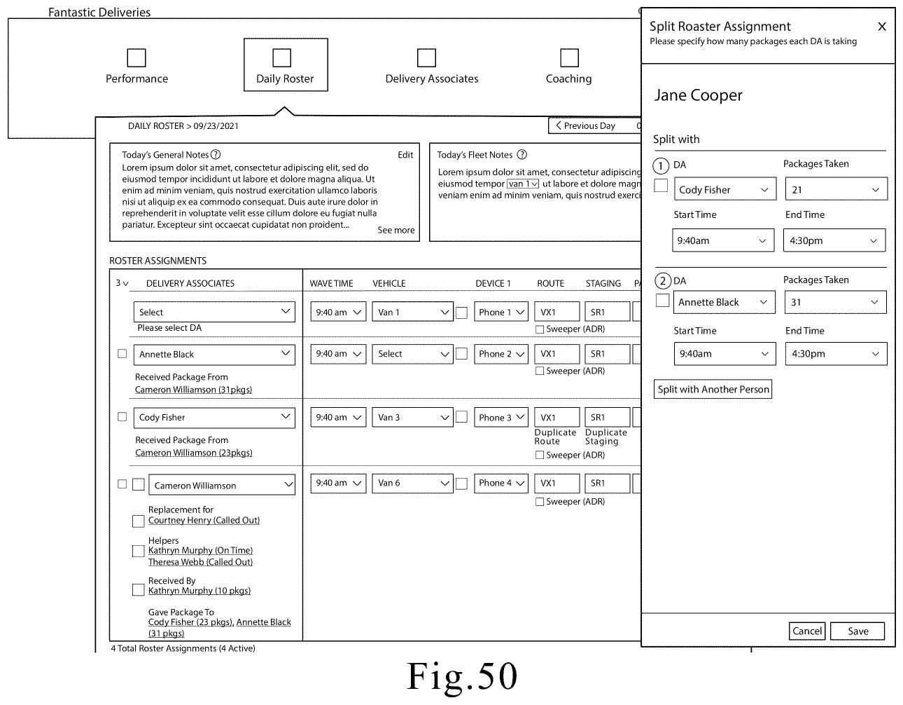

FIG. 50 is an illustration of one embodiment of a daily roster split-route screen of a system for delivery metric analysis and notification.

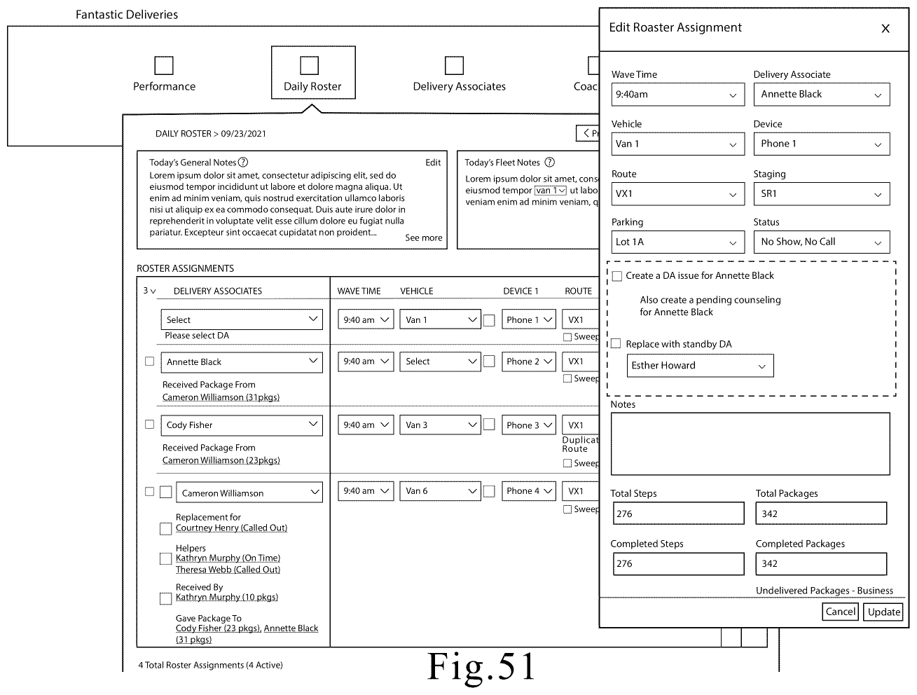

FIG. 51 is an illustration of one embodiment of a daily roster single delivery associate roster-assignment screen with the ability to add issues/counseling. This screen may also display the tracking of packages and undelivered packages for delivery metric analysis and notification.

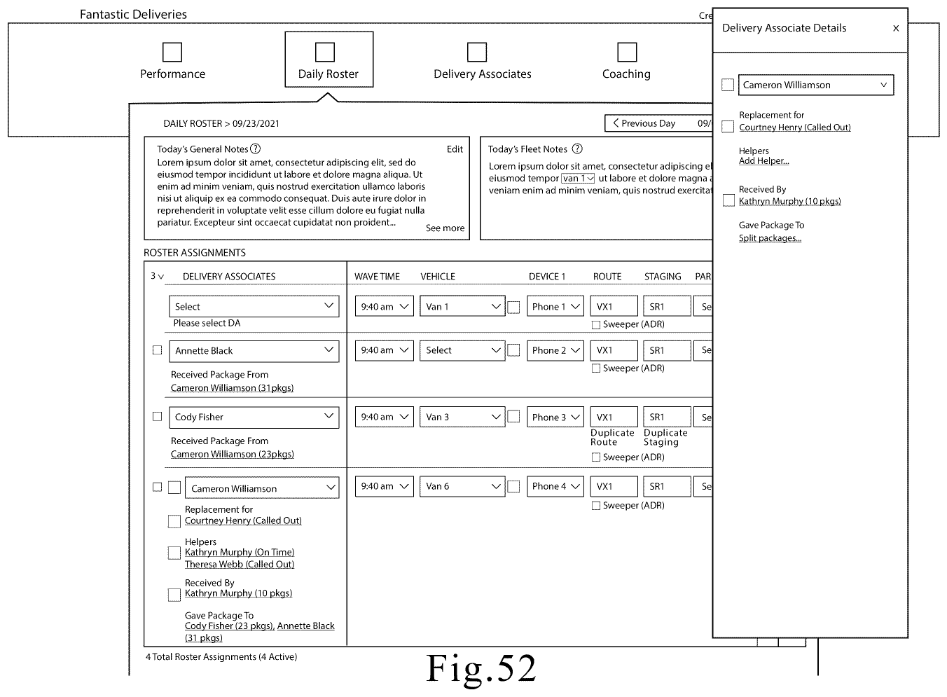

FIG. 52 is an illustration of one embodiment of a daily roster screen for delivery associates for delivery metric analysis and notification. In this embodiment, the delivery associates may have had helpers, rescuers, and/or took a split route or were replaced.

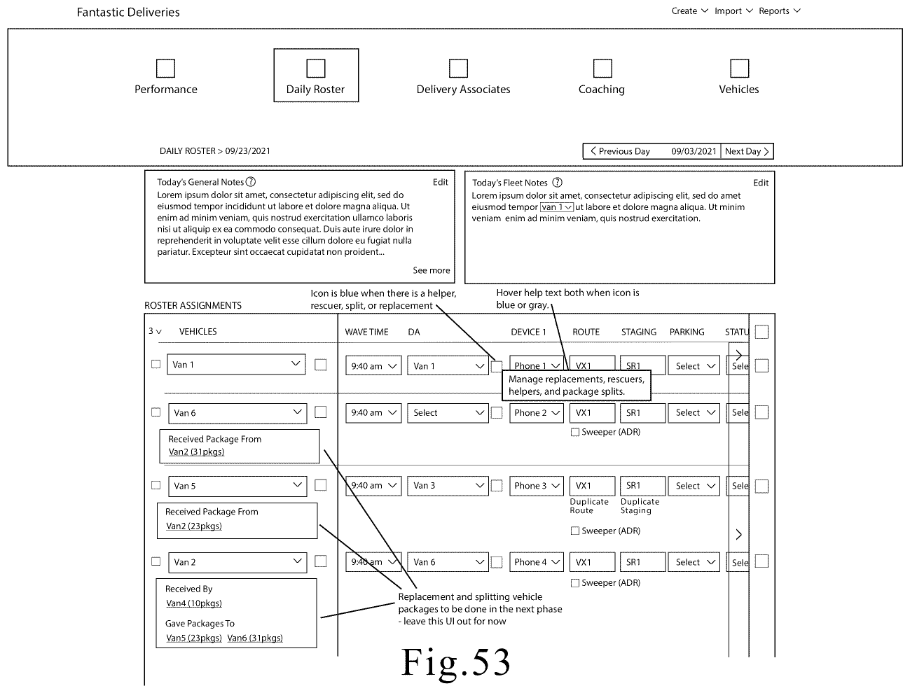

FIG. 53 is an illustration of one embodiment of a daily roster assignment status screen. The daily roster assignment screen may be used to track if a van is replaced and if the new van received packages from the previous vehicle.

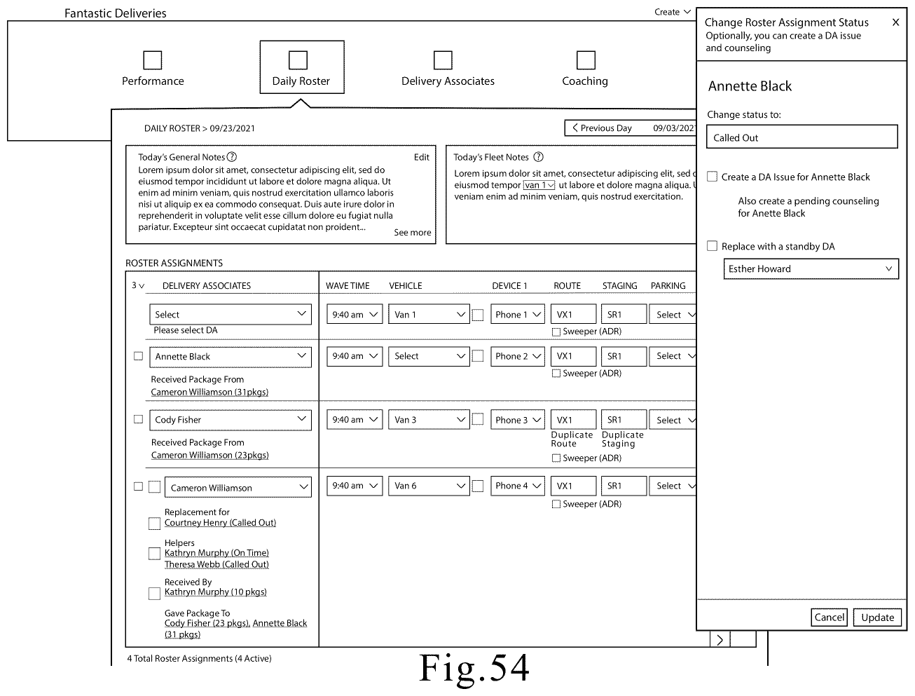

FIG. 54 is an illustration of one embodiment of a delivery associate screen for delivery metric analysis and notification. FIG. 54 shows a change in roster assignment status.

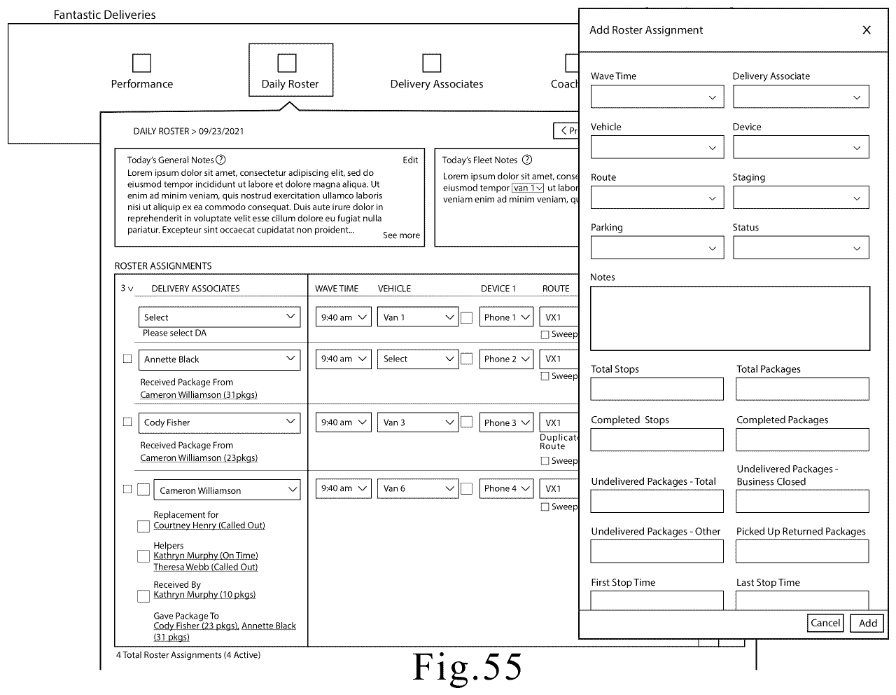

FIG. 55 is an illustration of one embodiment of a daily roster screen to add a single roster assignment.

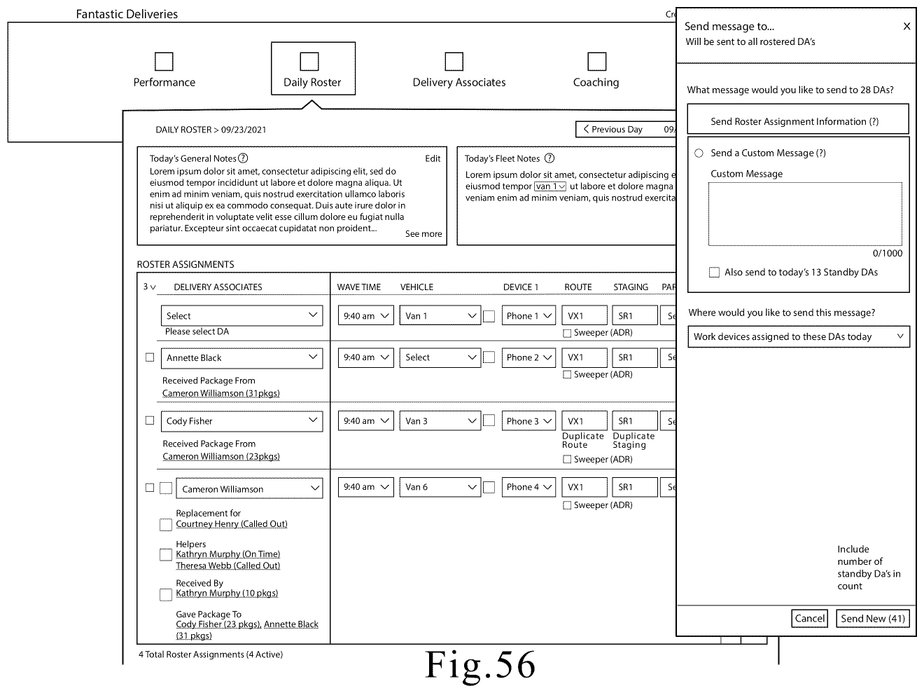

FIG. 56 is an illustration of one embodiment of a daily roster messenger screen which allows users to send a text message to a select group of employees. The daily roster messenger screen may allow users to send messages to employees working on a particular day, either on their personal or work phones.

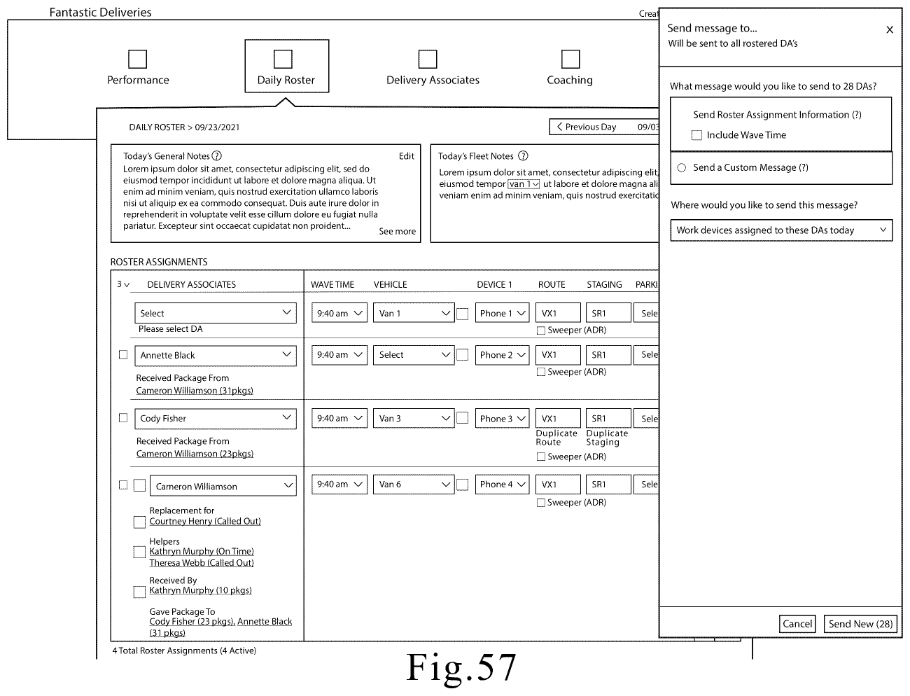

FIG. 57 is an illustration of one embodiment of a daily roster function which allows the user to send details of roster assignments to an employee's personal or work phones.

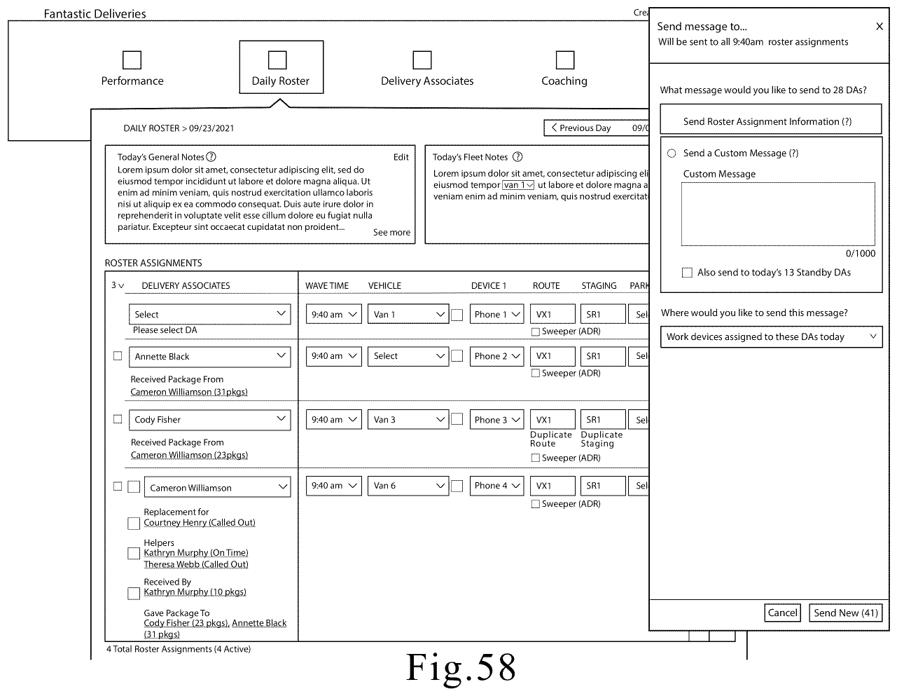

FIG. 58 is an illustration of one embodiment of a daily roster messenger screen which allows users to send a text message to all employees working on a particular day, either on their personal or work phones.

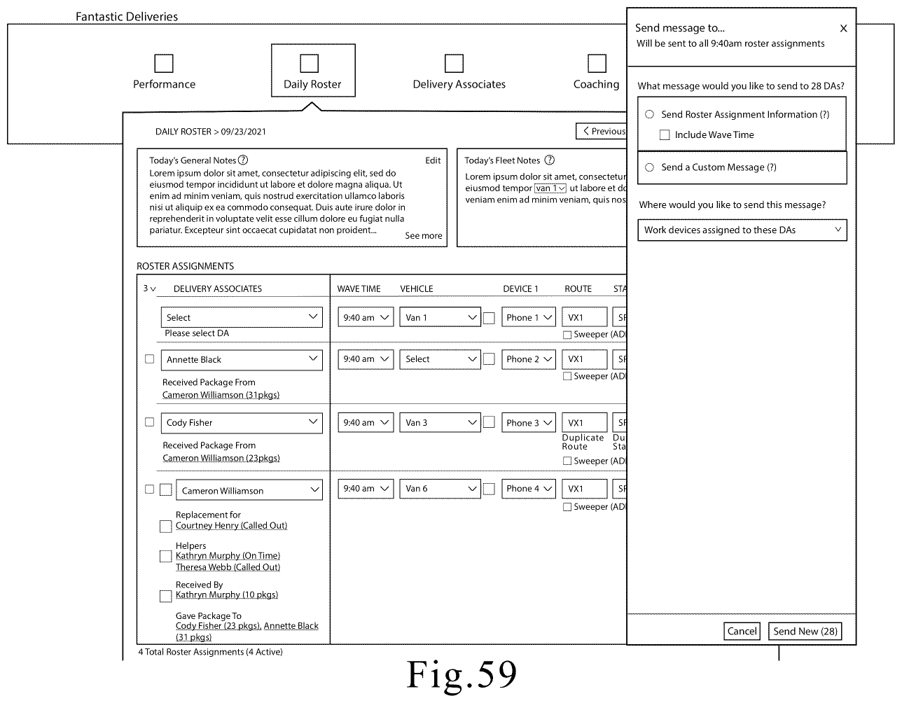

FIG. 59 is another illustration of one embodiment of a daily roster screen which allows users to send roster assignments to a select group of employees.

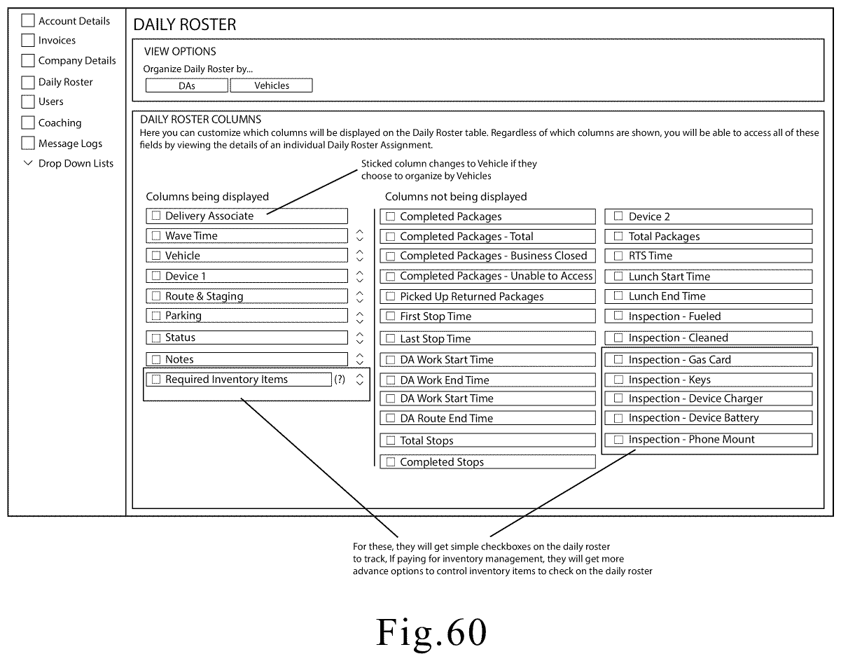

FIG. 60 is another illustration of one embodiment of a daily roster screen which allows users to customize which data may be displayed in the columns and in which order.

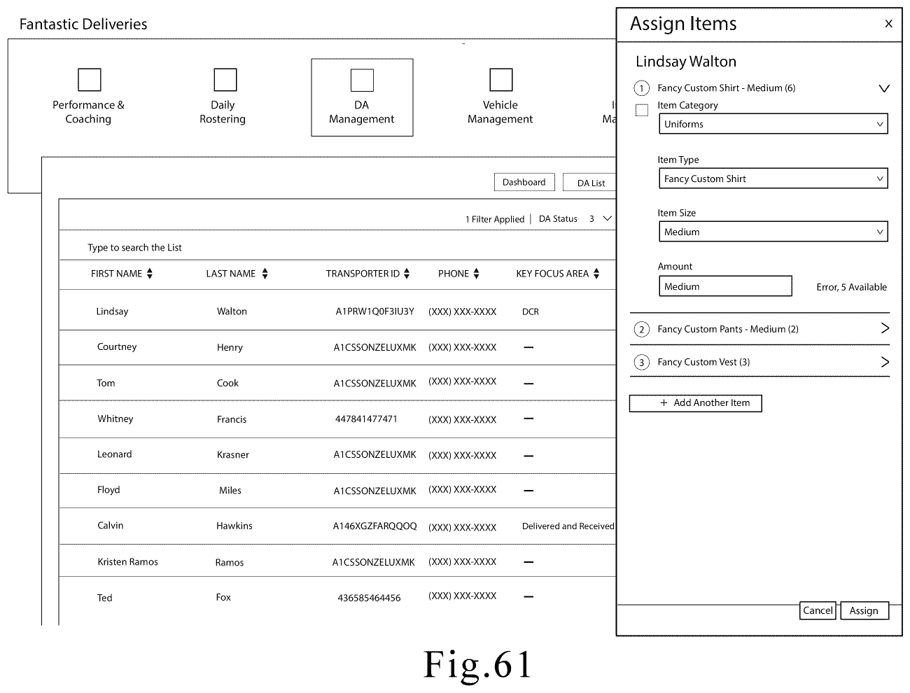

FIG. 61 is an illustration of one embodiment of the delivery associate screen with the ability to assign inventory.

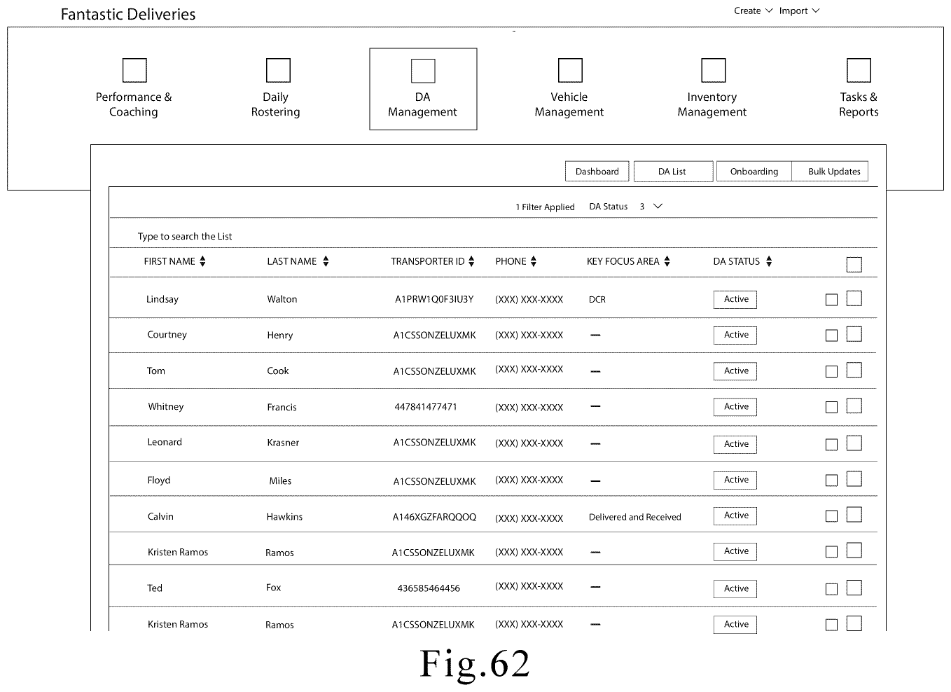

FIG. 62 is an illustration of one embodiment of the delivery associate screen with the ability to apply filters for data sorting. FIG. 62 shows the list of delivery associates as seen in a management screen.

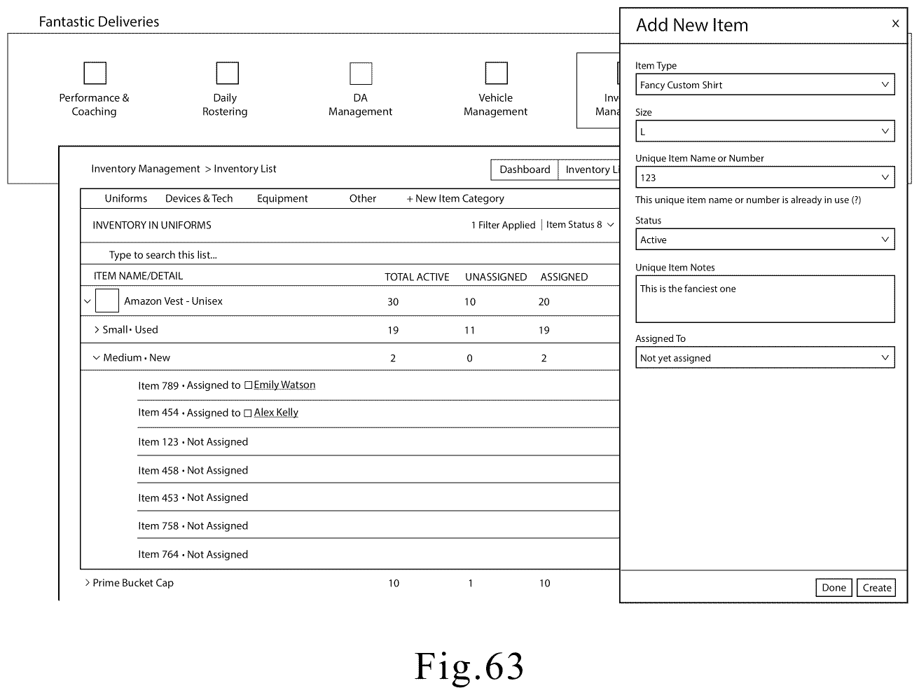

FIG. 63 is an illustration of one embodiment of the inventory management screen with the ability to add a new uniform item.

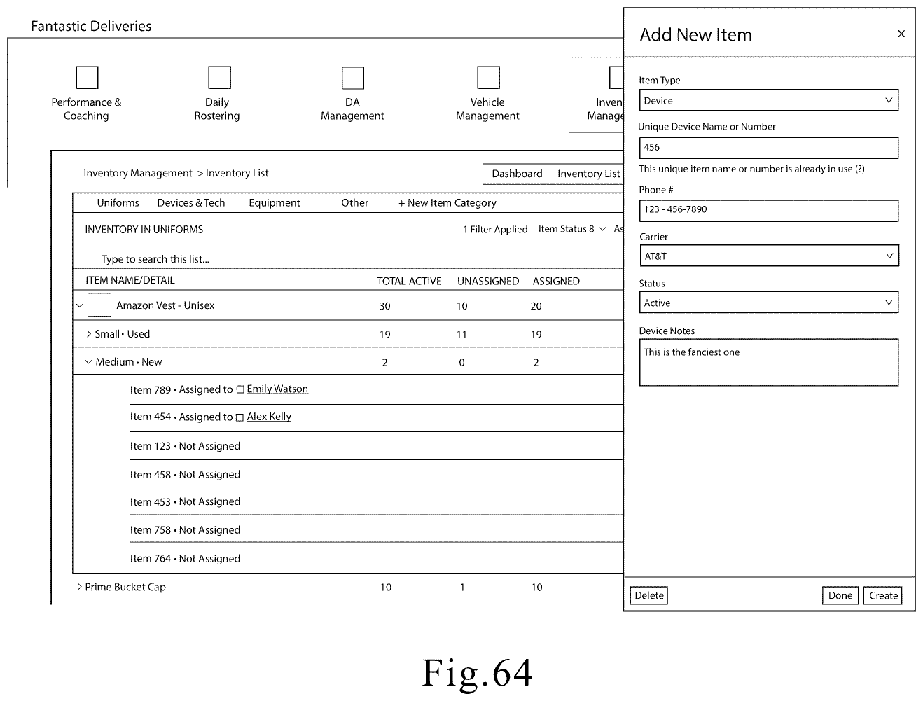

FIG. 64 is an illustration of one embodiment of the inventory management screen with the ability to add a new device. In this embodiment of the inventory management screen, the new device may be classified by number, cellular number, carrier status, and may include notes.

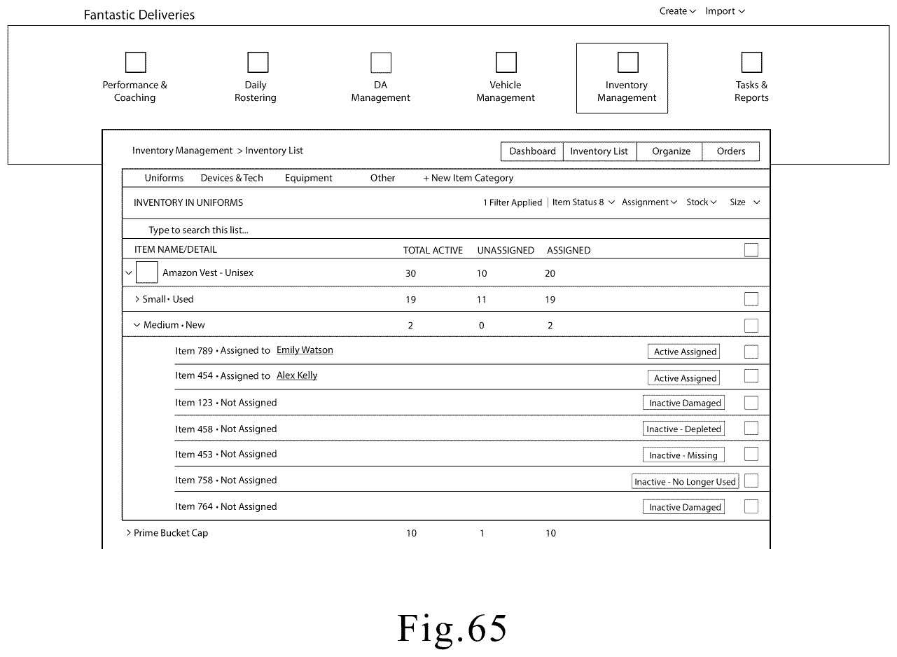

FIG. 65 is an illustration of one embodiment of the inventory management screen. As shown in FIG. 65, the use may be able to use the inventory management screen to view the inventory list showing details regarding type and to whom the device is assigned.

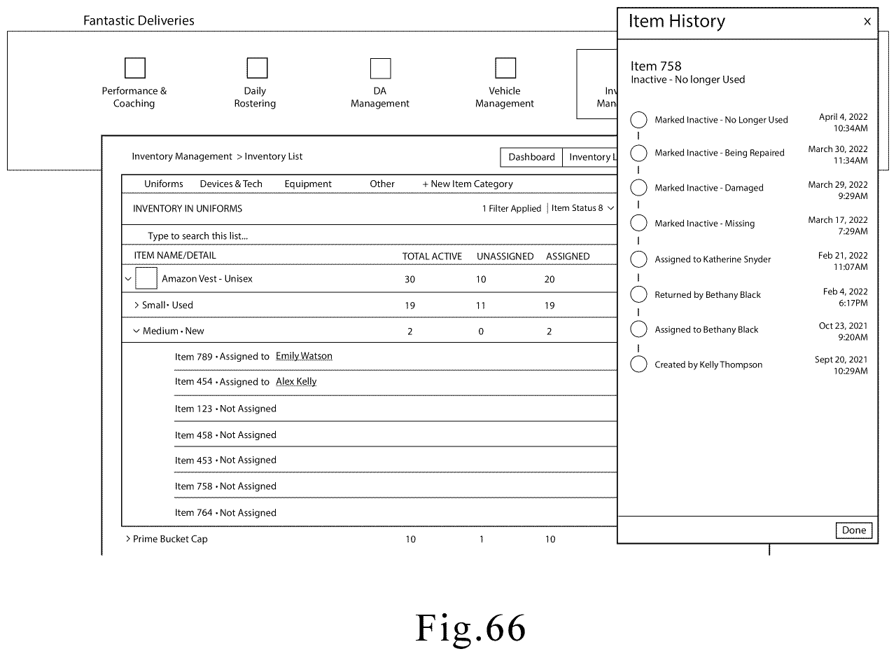

FIG. 66 is an illustration of one embodiment of the inventory management screen showing the history of an item. As shown in FIG. 66, the inventory management screen may comprise an item status that may be used to indicate which user borrowed the item and the condition of the item.

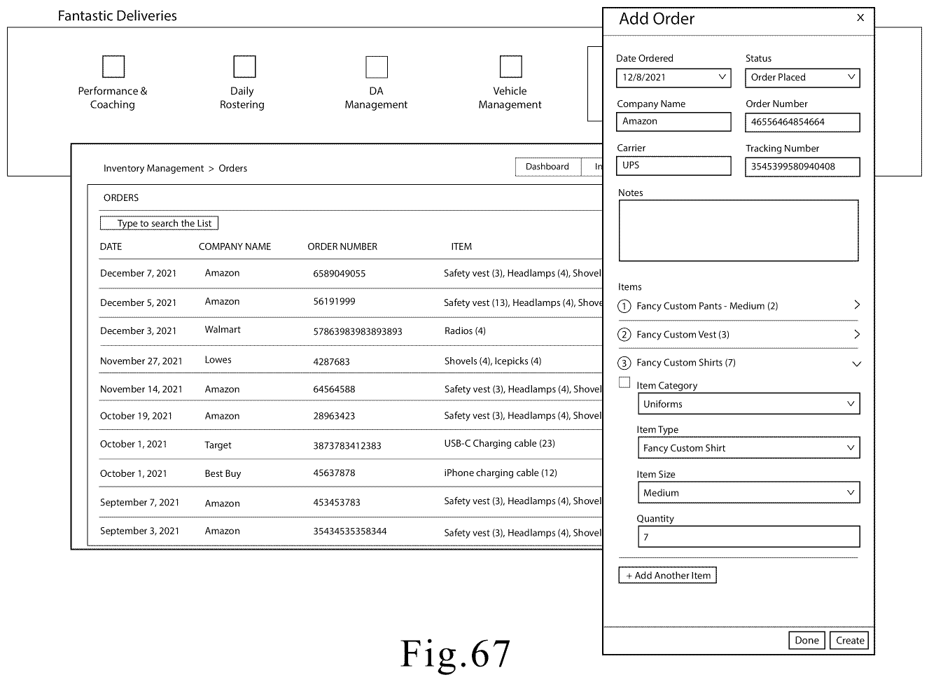

FIG. 67 is an illustration of one embodiment of the inventory management screen showing the ability to add an order. As shown in FIG. 67, the order added may be from an outside source and may simultaneously track order category, type, size, and quantity of the order.

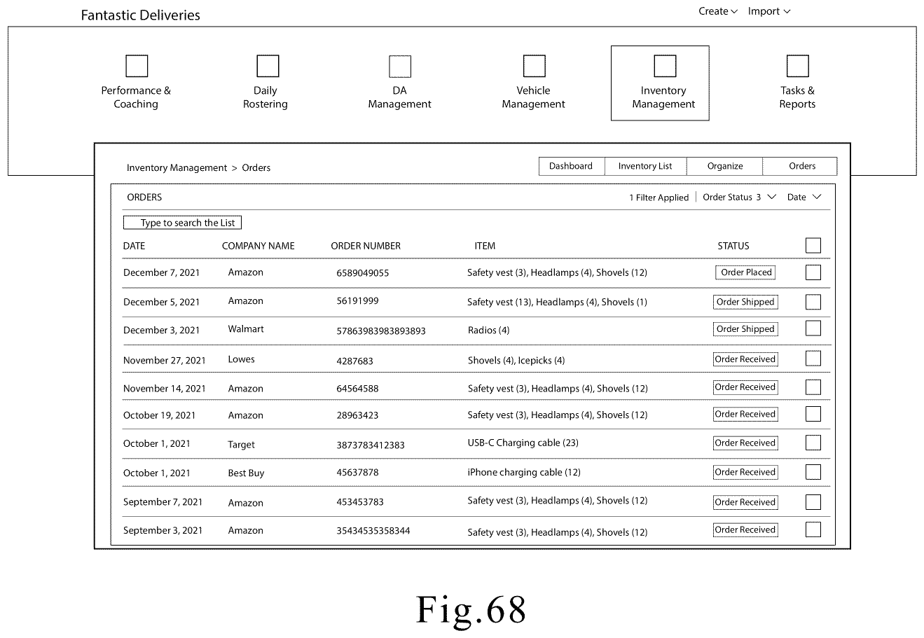

FIG. 68 is an illustration of one embodiment of the inventory management screen with replacement order status displayed. As shown in FIG. 68, orders may be tracked by date, company, order number, item, and status.

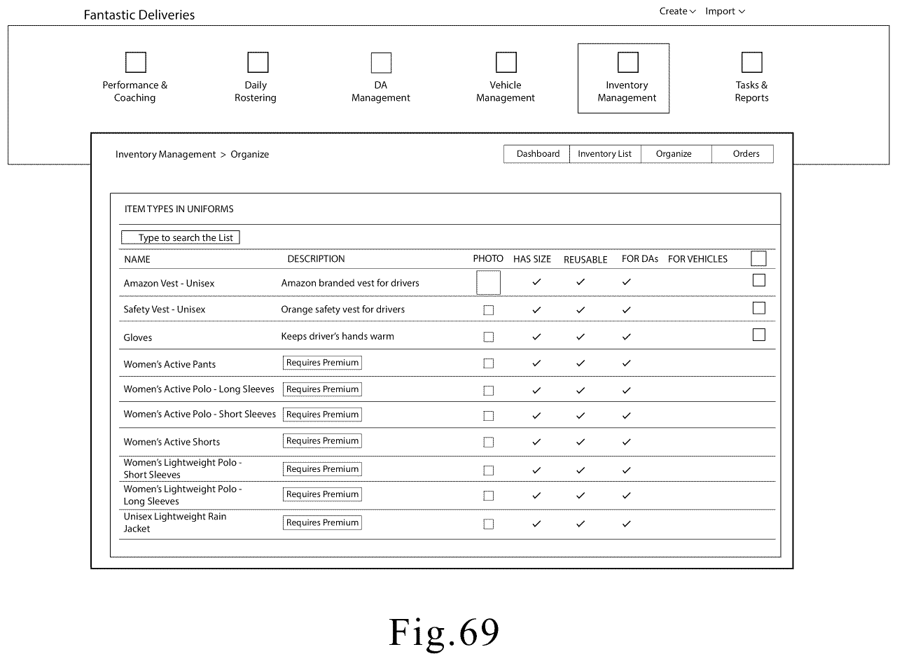

FIG. 69 is an illustration of one embodiment of the inventory management screen, showing the ability to change specific settings and types for inventory items. As shown in FIG. 69, the inventory management screen may be manually limited, such as for use by non-premium customers.

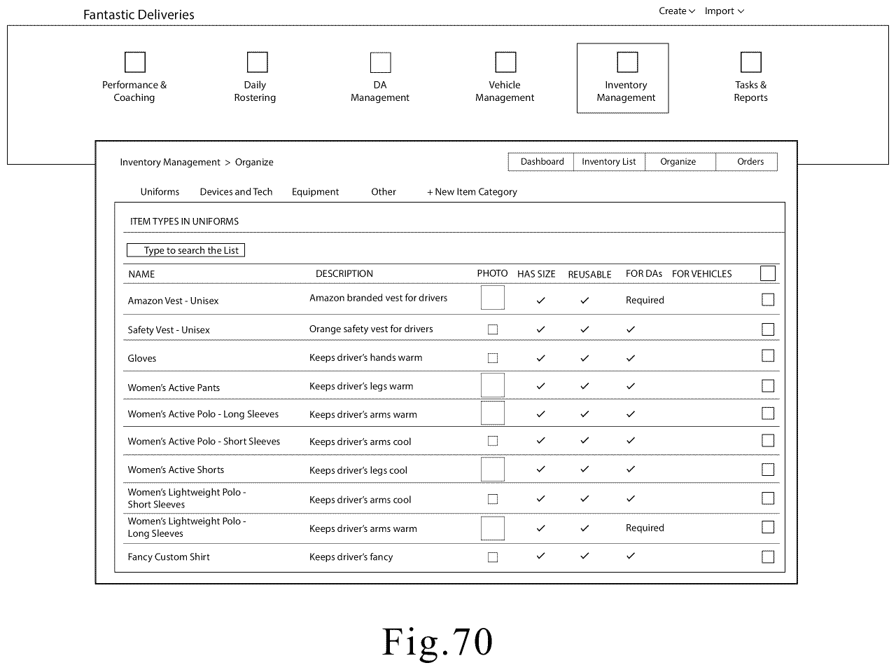

FIG. 70 is an illustration of one embodiment of the inventory management screen, showing the ability to change specific settings and types for inventory items. As shown in FIG. 70, the inventory management screen may be offered to for premium customers.

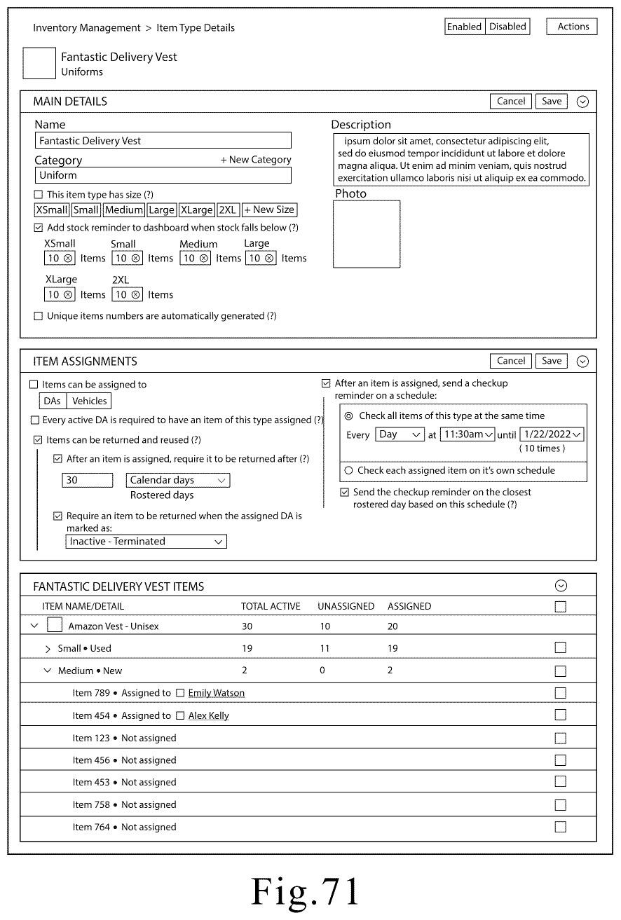

FIG. 71 is an illustration of one embodiment of the inventory management screen, item type details screen—shown in non-editable view for non-premium paying customers. As shown in FIG. 71, a user may preferably make changes to the details of an item, inventory counts, set automatic low inventory alerts, set a reminder to check-up on an item, set a remainder of when to return an item, and be able to mark whether an item is reusable or not. Users may also have the option to view details of the inventory, stock, and/or assignment of that inventory item.

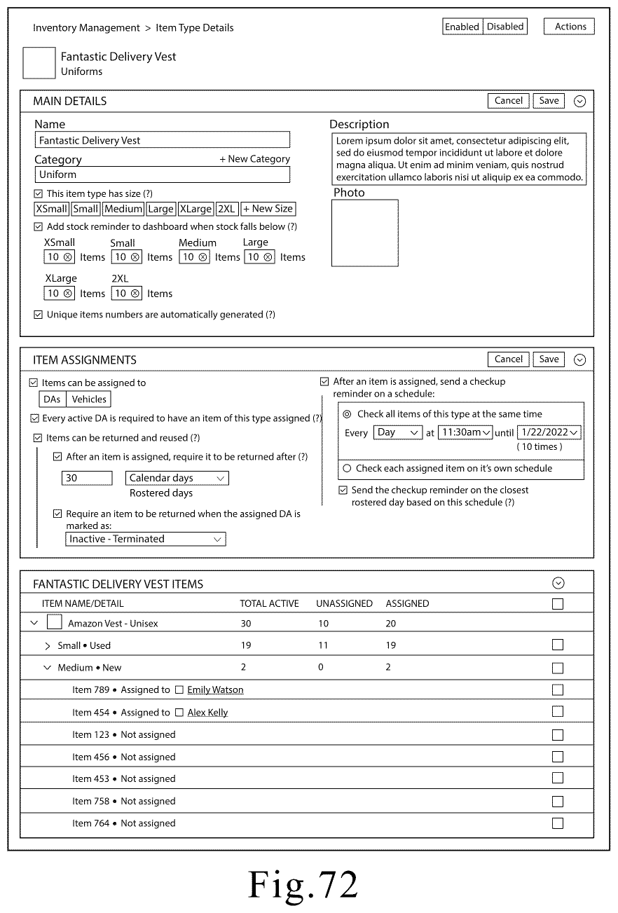

FIG. 72 is an illustration of one embodiment of the inventory management screen, item type details screen—shown in editable view for premium paying customers. As shown in FIG. 72, a user may preferably make changes to the details of an item, inventory counts, set automatic low inventory alerts, set a reminder to check-up on an item, set a remainder of when to return an item, and be able to mark whether an item is reusable or not. Users may also have the option to view details of the inventory, stock, and/or assignment of that inventory item.

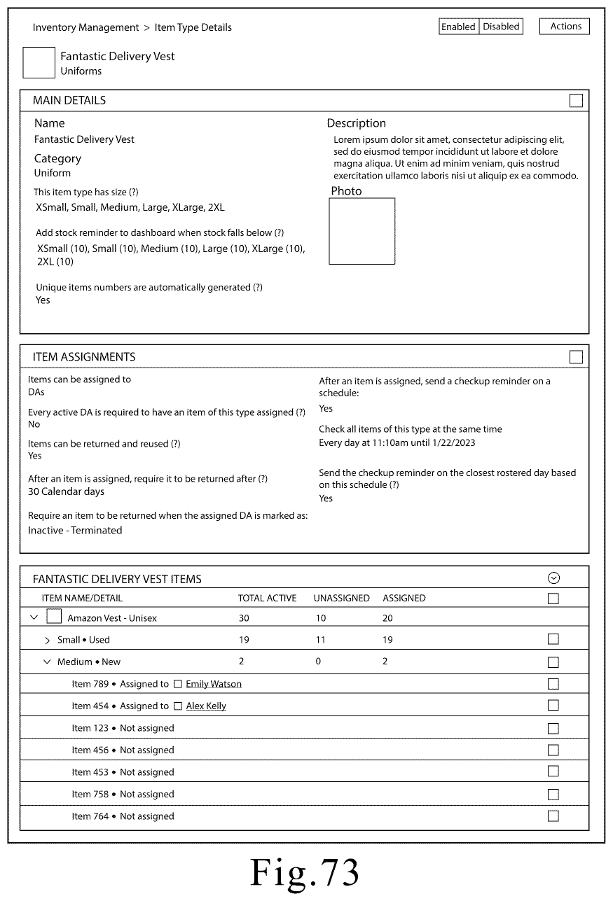

FIG. 73 is an illustration of one embodiment of the inventory management screen, item type details screen-shown in non-edit view. As shown in FIG. 73, a user may preferably make changes to the details of an item, inventory counts, set automatic low inventory alerts, set a reminder to check-up on an item, set a remainder of when to return an item, and be able to mark whether an item is reusable or not. Users may also have the option to view details of the inventory, stock, and/or assignment of that inventory item.

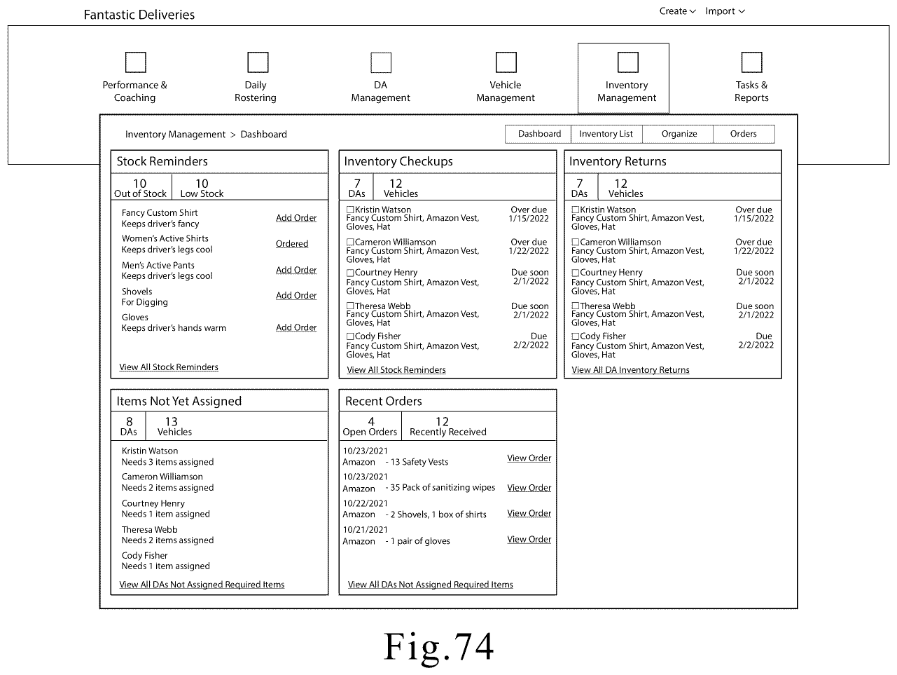

FIG. 74 is an illustration of one embodiment of the inventory management screen in dashboard view. As shown in FIG. 74, the dashboard view may display stock reminders, inventory check-ups, inventory returns, items not yet assigned, and recent orders.

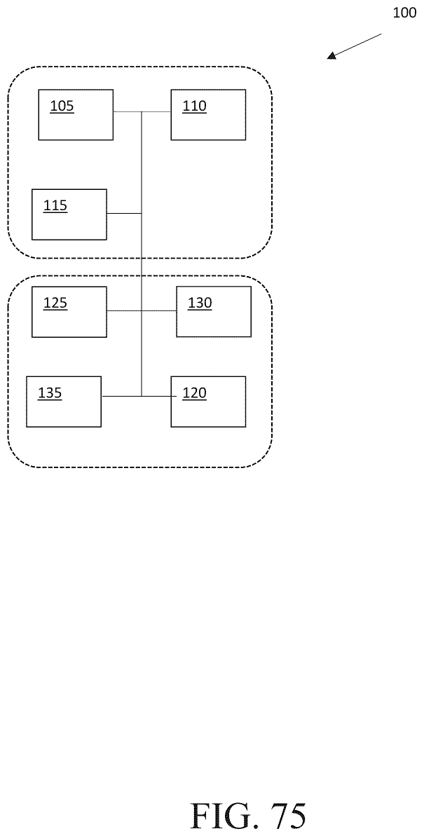

FIG. 75 is a block diagram of one embodiment of a system for delivery metric analysis and notification. As shown in FIG. 75, the system for delivery metric analysis and notification 100 may comprise a delivery metric receiving device 105, a delivery metric analysis device 110, a delivery coaching message transmission device 115, an injury information input device 120, a delivery associate input device 125, an inventory management input device 130, and a daily roster input device 135.

In some embodiments, the delivery metric receiving device 105, delivery metric analysis device 110, delivery coaching message transmission device 115, injury information input device 120, delivery associate input device 125, inventory management input device 130, and daily roster input device 135 may each be individual and separate devices. In other embodiments, two or more of the delivery metric receiving device 105, delivery metric analysis device 110, delivery coaching message transmission device 115, injury information input device 120, delivery associate input device 125, inventory management input device 130, and daily roster input device 135 may combined into as few as one device. In one embodiment, the delivery metric receiving device 105, delivery metric analysis device 110, delivery coaching message transmission device 115, injury information input device 120, delivery associate input device 125, inventory management input device 130, and daily roster input device 135 may be separate devices as indicated by the broken lines denoting combinations of the devices. For example, in one embodiment, the delivery metric receiving device 105, delivery metric analysis device 110, delivery coaching message transmission device 115 may be a first device, and the injury information input device 120, delivery associate input device 125, inventory management input device 130, and daily roster input device 135 may be a second device.

The delivery metric analysis device 110 may be configured to generate performance data based on delivery metrics. The delivery metrics may be based on what the driver is doing while driving and may comprise acceleration metrics, braking metrics, cornering metrics, speeding metrics, distraction metrics, seatbelt metrics, back up metrics, mile-per-gallon metrics, idling metrics, odometer reading metrics, engine off metrics, and any other metric that may be used to evaluate delivery performance. The delivery metric analysis device 110 may be configured to generate one or more coaching messages based on the performance data. In some embodiments, the coaching messages may provide the delivery driver with feedback that may help the delivery driver improve their performance. In some embodiments, the delivery metrics may be tracked with respect to the coaching messages over time to determine what coaching messages are having an impact on the delivery driver's performance. In one embodiment, the delivery metrics may be recorded automatically by monitoring user activity. In some embodiments, the delivery metrics may be used to generate a scorecard that may present the delivery metrics in an easy to understand format for the delivery driver.

The delivery coaching message transmission device 115 may be configured to send the generated coaching messages to one or more users. In a preferred embodiment, the generated coaching messages may be generated in response to a particular user's actions or delivery metrics. In a preferred embodiment, the users may be delivery drivers. In some embodiments, the delivery drivers may deliver packages, food, individuals, or anything else that may be transported from one location to another. In some embodiments, coaching messages may be broadcast to more than one user. In some embodiments, the coaching message may be broadcast via cellular networks or the internet. In some embodiments, the coaching message may be received by the user via an electronic device such as a cellular phone, tablet, computer, or other device with an electronic display.

The injury information input device 120 may be configured to receive an injury information associated with an injury and generate an injury form based on said injury information. In one embodiment, the one or more users may have the ability to input injury information into the injury information input device 120. In a preferred embodiment, the injury information may be related to injuries caused to the one or more user's while the one or more users are performing delivery related activities. In another embodiment, supervisors of the users may have the ability to input injury information into the injury information input device 120. In another embodiment, anyone with access to information relating to the injury may have the ability to input injury information into the injury information input device 120.

The delivery associate input device 125 may allow the user to input delivery associate data that is configured to be displayed in an associate dashboard view, daily roster view, and detailed associate summary view. In some embodiments, the associate dashboard view, daily roster view, and detailed associate summary view may be displayed to the user via an electronic device such as a cellular phone, tablet, computer, or other electronic device with a display.

The inventory management input device 130 may be configured to receive inventory data comprising information about product inventory. In some embodiments, the product inventory relates to the specific items present on the user's vehicle. In some embodiments, the inventory management input device 130 may be used to scan the specific items as the specific items are being loaded or unloaded from the user's vehicle.

The daily roster input device 135 may be configured to allow users to track, change, and update routes, or vehicle reassignments.

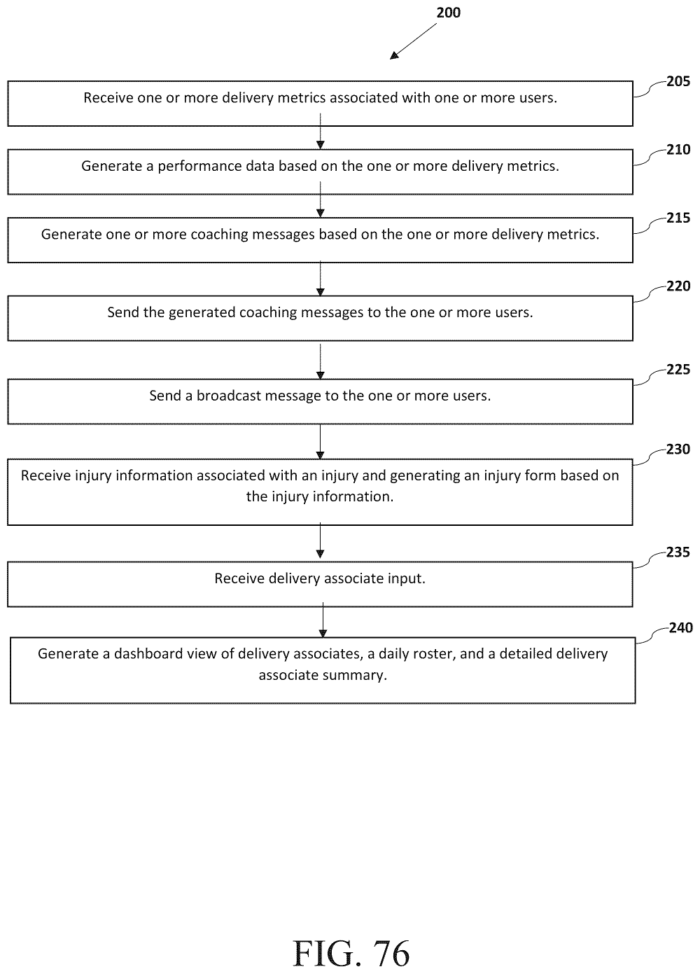

FIG. 76 is a flow diagram illustrating an embodiment of a method for delivery metric analysis and notification. As shown in FIG. 76, the method for delivery metric analysis and notification 200 may comprise the steps: receiving one or more delivery metrics associated with one or more users 205; generating a performance data based on said one or more delivery metrics 210; generating one or more coaching messages based on said one or more delivery metrics 215; and sending said generated coaching messages to said one or more users 220.

In one embodiment, the delivery metrics may be used to generate one or more scorecards. The scorecards and/or delivery metrics may be reflective of acceleration metrics, braking metrics, cornering metrics, speeding metrics, distraction metrics, seatbelt metrics, back up metrics, mile-per-gallon metrics, idling metrics, odometer reading metrics, engine off metrics, and any other metric that may be used to evaluate delivery performance.

The generated performance data comprises: a picture upon delivery report, a delivery service partner delivery excellence performance report, a customer feedback report, a driver performance report (which may be in whole or in part be provided by a third-party such as Amazon®, Netradyne®, and/or Mentor®), and any other report or feedback that reflects the user's/delivery associate's activities.

In some embodiments, the method for delivery metric analysis and notification 200 may further comprise the step of sending a broadcast message to the one or more users 225. The users are sometimes referred to as delivery associates.

In some embodiments, the method for delivery metric analysis and notification 200 may further comprise the step of receiving an injury information associated with an injury and generating an injury form based on said injury information 230.

In some embodiments, the method for delivery metric analysis and notification 200 may further comprise the step of receiving a delivery associate input 235. The delivery associate input 235 may be used to generate a dashboard view of delivery associates, a daily roster, a detailed delivery associate summary, and any other report relating to the delivery associates 240. In one embodiment, the delivery associates may be users or delivery drivers.

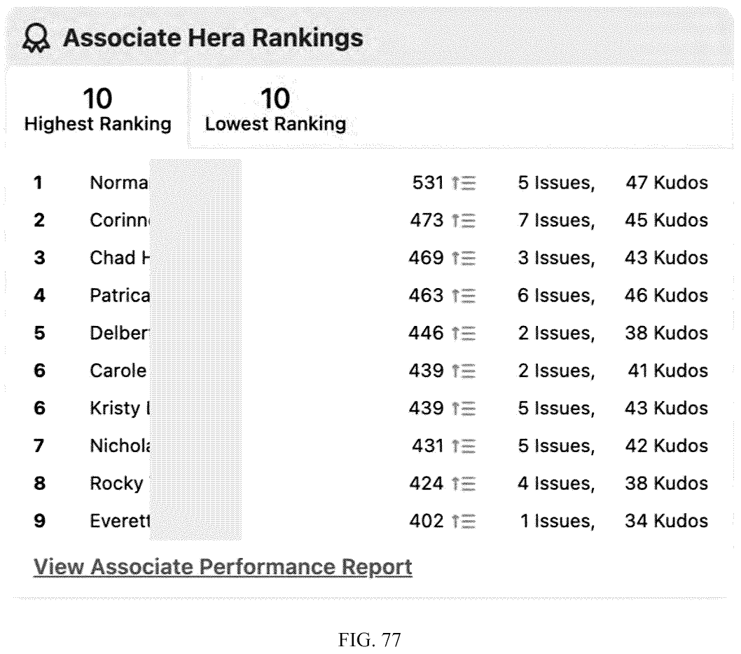

FIG. 77 is an illustration of one embodiment of a ranking of delivery associates for a particular user/company. FIG. 77 shows that the system is able to toggle back and forth between the 10 best performing and 10 worst performing deliver associates. The ranking also shows the number of “issues” or corrections or coachings that the associate received, along with the number of “kudos” or praises or positive reinforcements the associate received.

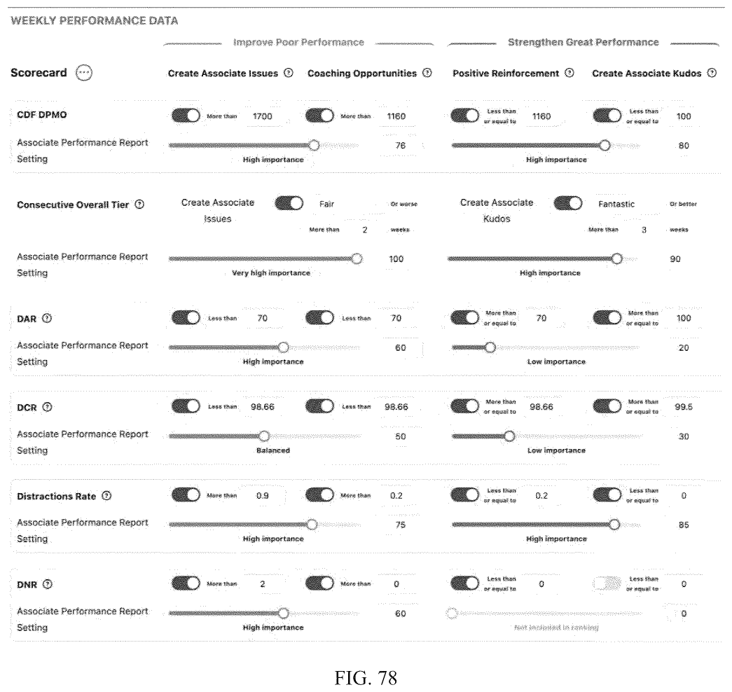

FIG. 78 is an illustration of one embodiment of a scorecard customization screen, previously referred to as the coaching preferences screen. FIG. 78 is similar to FIG. 7, but allows the user to slide the scale for each metric in order to give each metric more or less weight or importance. This allows the user to customize the scorecard, and thus the rankings of the associates, for that particular company. CDF is customer delivery feedback. POD picture on delivery. DSP is delivery service partner. PM is preventative maintenance. DVCR driver vehicle condition report. DVIC is daily vehicle inspection checklist. DPMO is defects per million opportunities. DNR is Delivery not received. CC is contact compliance. SSE is scorecard speeding event. High G is high gravity due to acceleration, turning, or deceleration.

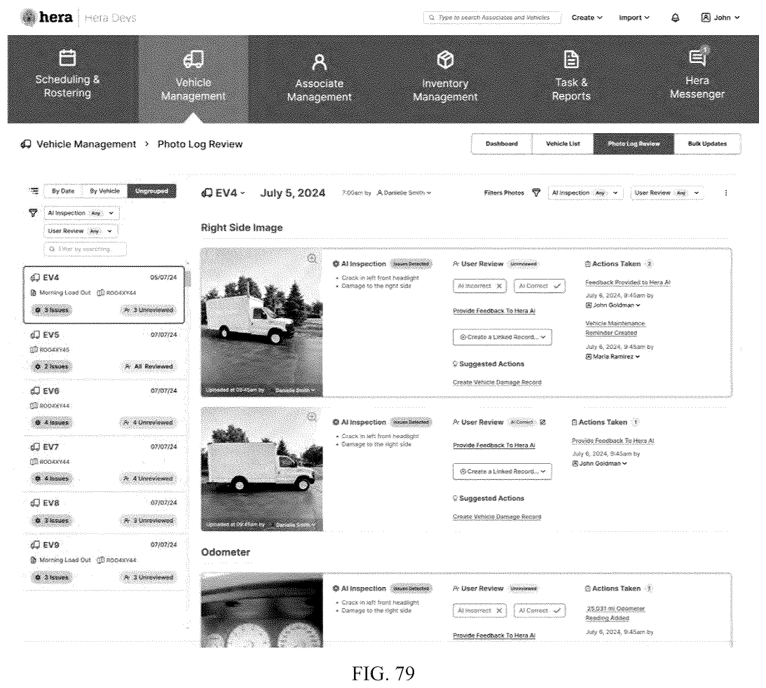

FIG. 79 is an illustration of one embodiment of a photo log review screen. This demonstrates the system's machine learning and/or artificial intelligence powered vehicle photo log system, which automatically detects and flags vehicle damage during inspections. The photo log review may allow users to review, provide feedback, and create linked records for vehicle maintenance based on machine/system identified issues.

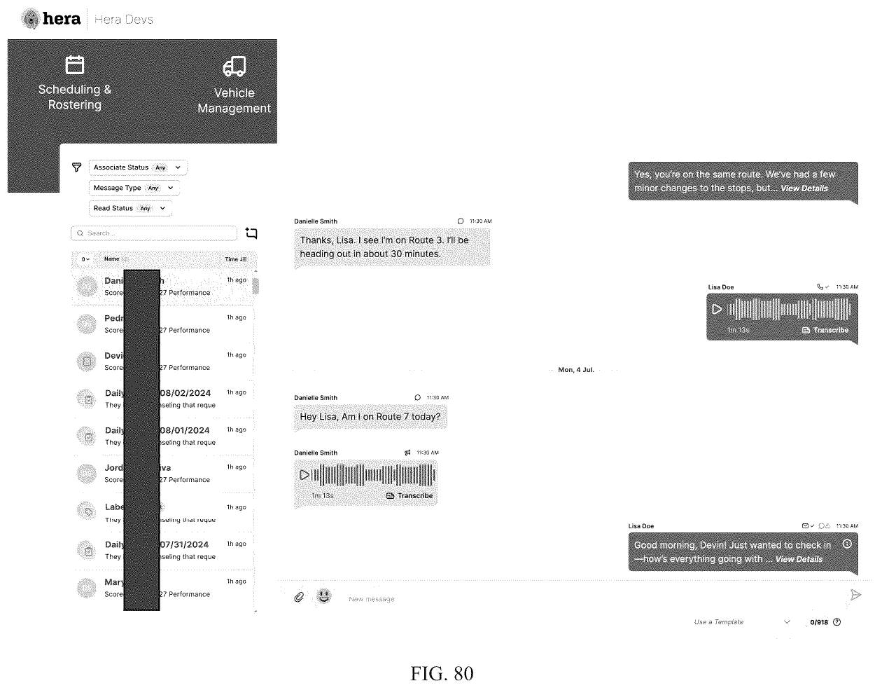

FIG. 80 is an illustration of one embodiment of a messenger interface showing a one-on-one conversation.

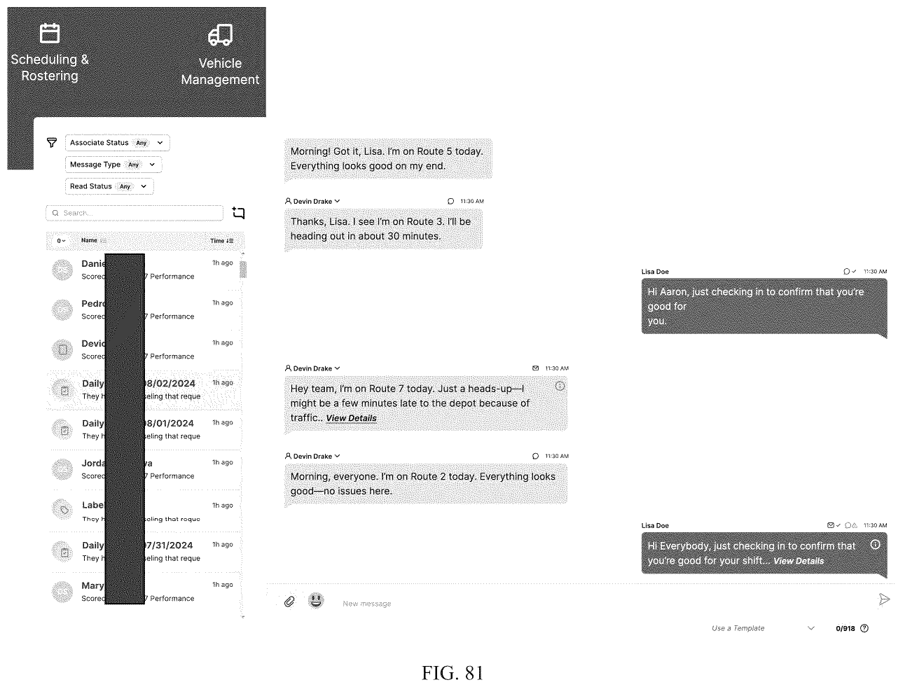

FIG. 81 is an illustration of one embodiment of a messenger interface showing a group conversation between two or more delivery associates working on a particular day.

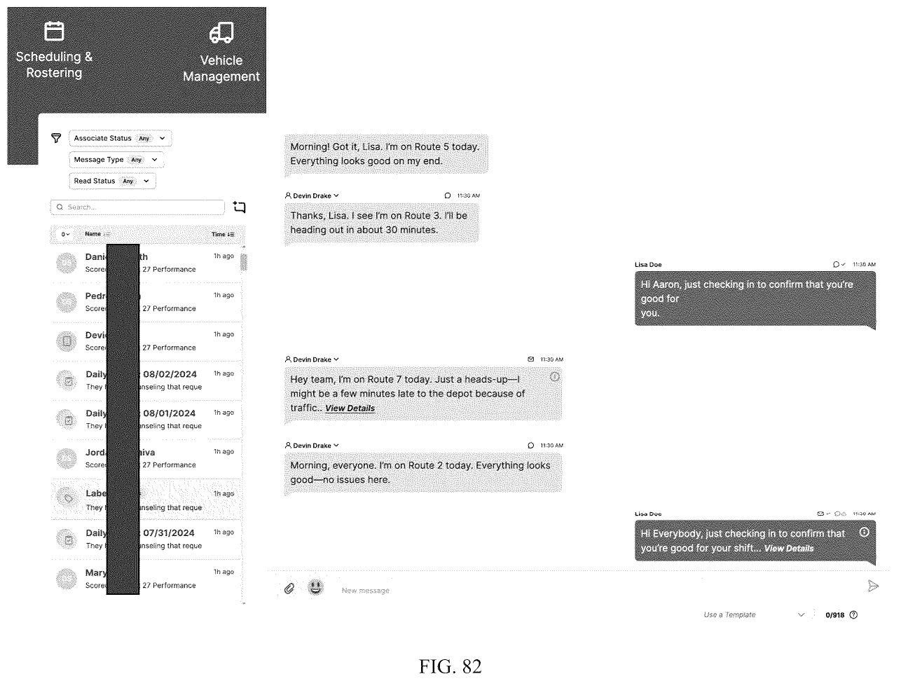

FIG. 82 is an illustration of one embodiment of a messenger interface showing a group conversation between one or more delivery associates that have been assigned a custom label. For example, a group chat could be started with all delivery associates that are given a custom label of “Step-Van Driver”.

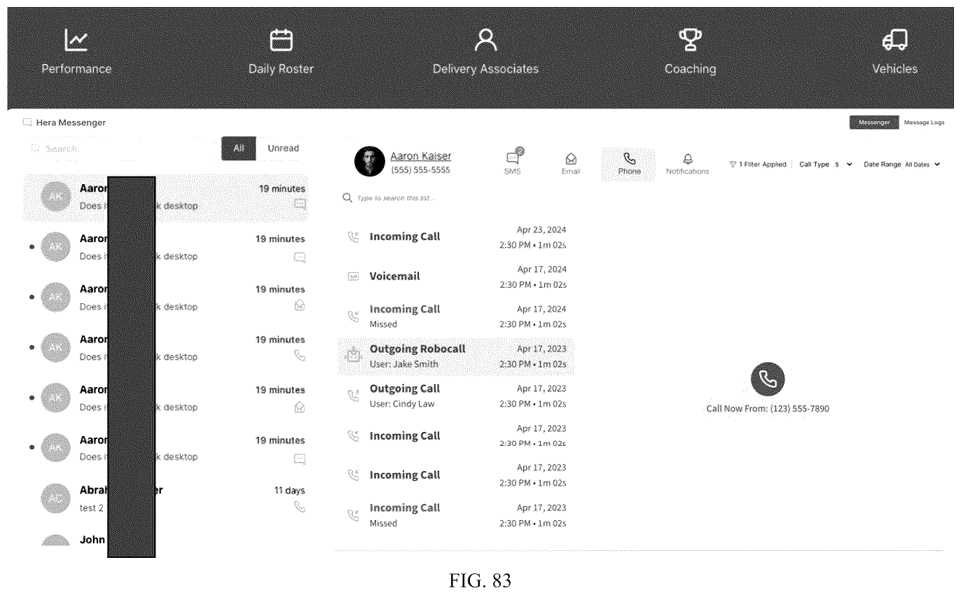

FIG. 83 is an illustration of one embodiment of a messenger interface showing the platform may include the ability to see all forms of communication (SMS/Email/Phone/Notifications) for one specific delivery associate on one screen.

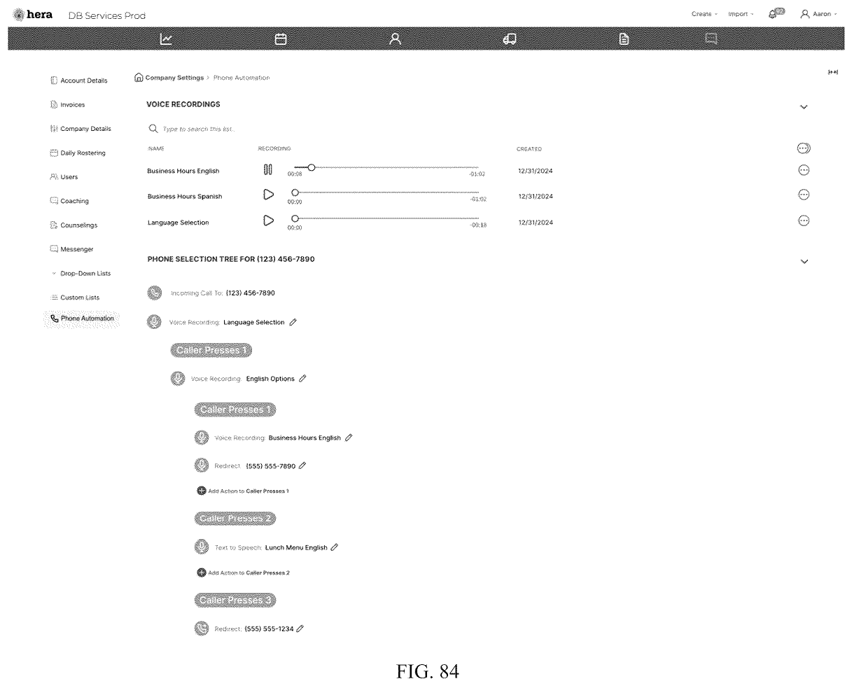

FIG. 84 is an illustration of one embodiment of a messenger interface showing the first part of company settings for managing voice recordings. This may allow users to adjust preferences related to voice recordings, including recording storage, access, and management settings. The header “Voice Recordings” indicates that this section may allow the user to configure how voice communications are handled within the system.

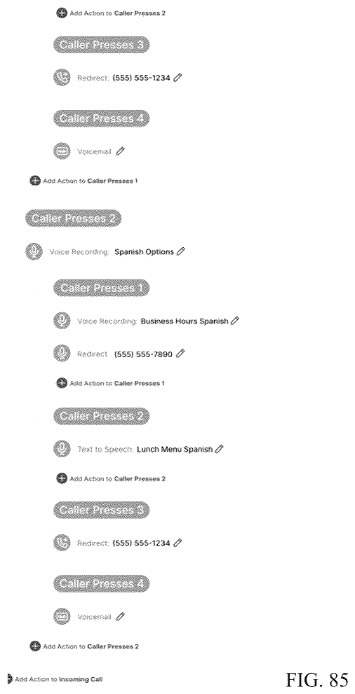

FIG. 85 is an illustration showing the second part of what is shown in FIG. 84.

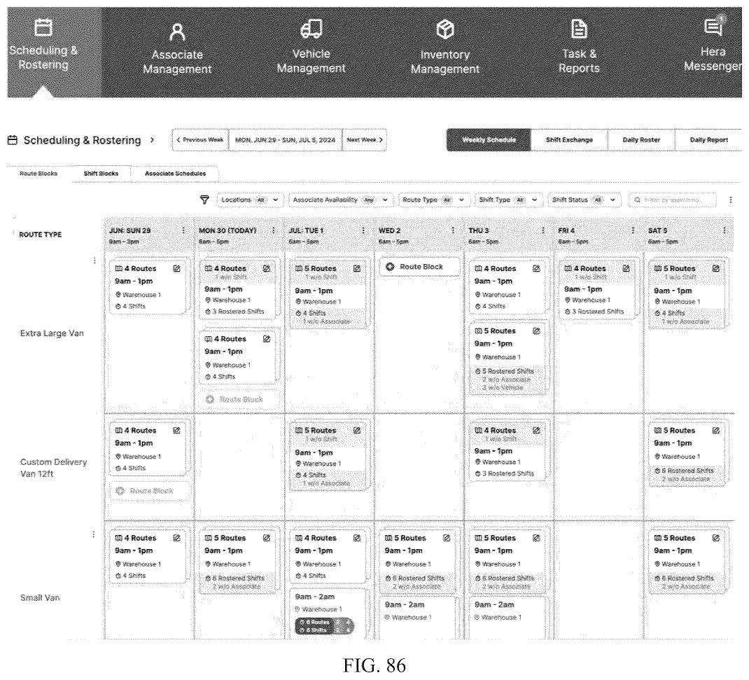

FIG. 86 is an illustration of one embodiment of a daily roster and scheduler showing an overview of the weekly schedule for associates, including showing shifts, routes, and rostered vehicles across different days. This may allow supervisors to manage shifts by displaying the number of routes without assigned associates and vehicles. It may be specifically dedicated to what type of vehicle a route requires. FIG. 86 is focused on the route.

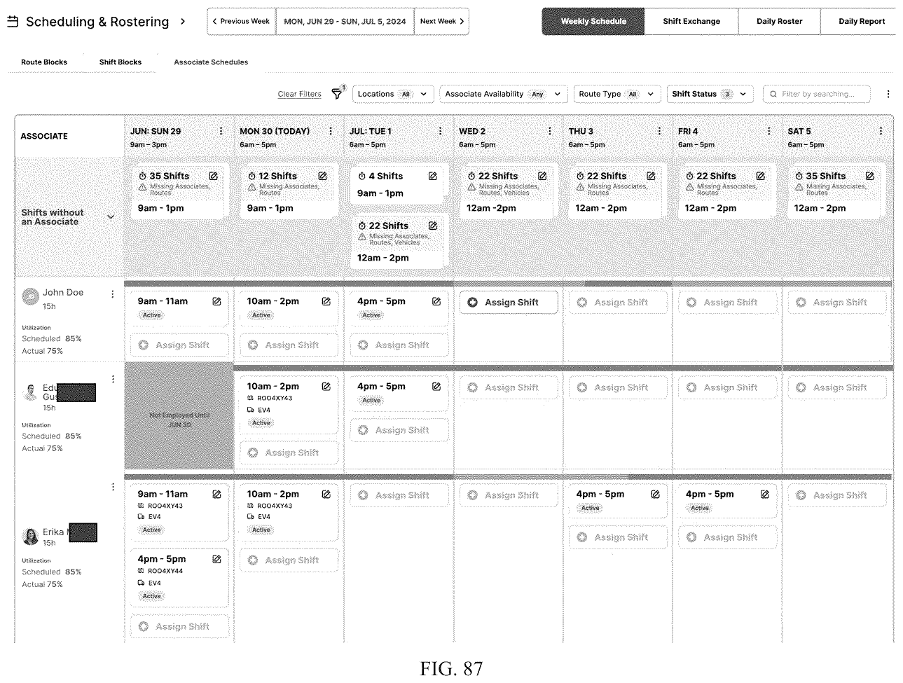

FIG. 87 is an illustration of one embodiment of a roster and scheduler showing shift utilization for individual associates, which includes showing their scheduled shifts and actual schedules. As shown, supervisors may assign shifts, review utilization percentages, and check up on missing associates or vehicles. FIG. 87 highlights shifts that have not been assigned and the supervisor can view each employee's schedule for the week and whether they have availability to take an unassigned shift.

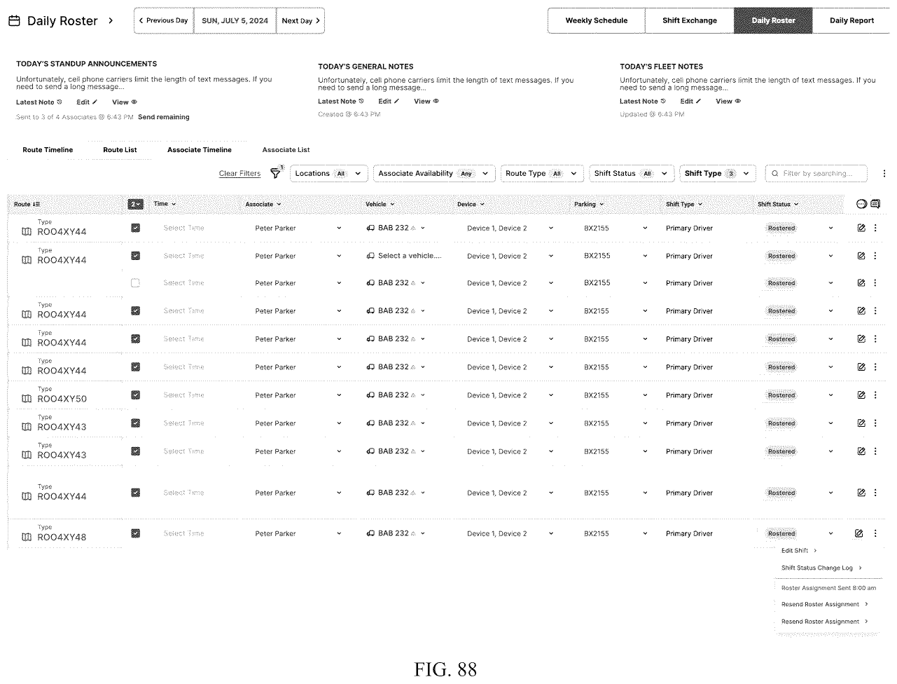

FIG. 88 is an illustration of one embodiment of a roster and scheduler showing the current day's standup announcements, general notes, and fleet notes, which allows supervisors to send critical messages to associates. FIG. 88 also shows details about routes and associates, allowing for updates on shift status and route assignments.

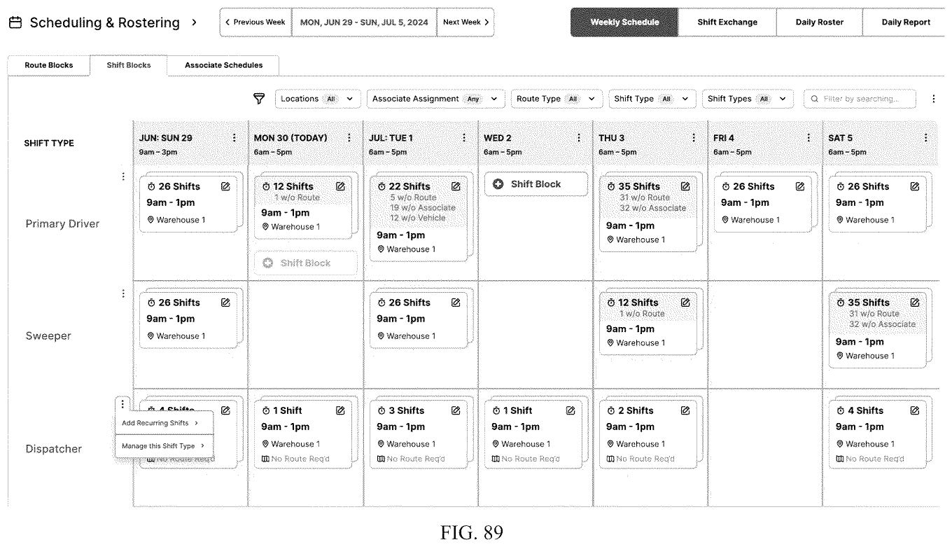

FIG. 89 is an illustration of one embodiment of a roster and scheduler showing associates' shift types, time blocks for each shift type, and shift duration. Supervisors may adjust schedules and monitor assigned/unassigned shifts in real-time.

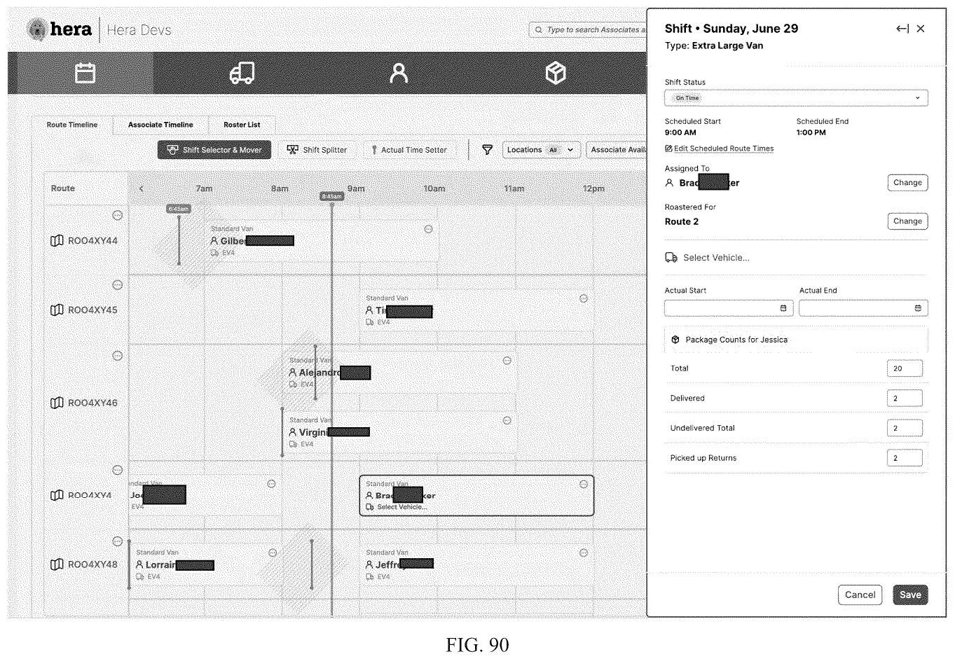

FIG. 90 is an illustration of one embodiment of a roster and scheduler showing detailed information about a specific shift, including the scheduled start and end times. The user may compare scheduled start/stop times to actual start/stop times. Further, users can also see assigned associates, vehicle, and package counts. Supervisors can edit route times and update the status of deliveries and pickups.

Unless otherwise stated, all measurements, values, ratings, positions, magnitudes, sizes, locations, and other specifications, which set forth in this specification, including in the claims that follow, are approximate, not exact. They are intended to have a reasonable range, which is consistent with the functions to which they relate and with what is customary in the art to which they pertain.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The foregoing description of the preferred embodiment has been presented for the purposes of illustration and description. While multiple embodiments are disclosed, still other embodiments will become apparent to those skilled in the art from the above detailed description, which shows and describes the illustrative embodiments. As will be realized, these embodiments are capable of modifications in various obvious aspects, all without departing from the spirit and scope of the present disclosure. Accordingly, the detailed description is to be regarded as illustrative in nature and not restrictive. Also, although not explicitly recited, one or more additional embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A system for data aggregation, data processing, and messaging comprising:
a delivery metric gathering device;
a delivery metric analysis device;
a message transmission device;
a driver device; and
a manager device;
wherein said delivery metric gathering device is configured to receive one or more delivery metrics associated with one or more drivers;
wherein said delivery metric gathering device is configured to send said one or more delivery metrics to said delivery metric analysis device;
wherein a driver is prompted to enter into said driver device one or more driver ranges of acceptable values of said one or more delivery metrics;
wherein a manager is prompted to enter into said manager device one or more manager ranges of acceptable values of said one or more delivery metrics;
wherein said delivery metric analysis device determines when said one or more delivery metrics is a value outside of said one or more driver ranges of acceptable values;
wherein when said one or more delivery metrics is a value outside of said one or more driver ranges of acceptable values, said message transmission device is configured to send a driver message to said driver device;
wherein said delivery metric analysis device determines when said one or more delivery metrics is a value outside of said one or more manager ranges of acceptable values; and
wherein when said one or more delivery metrics is a value outside of said one or more manager ranges of acceptable values, said message transmission device is configured to send a manager message to said manager device.

2. The system of claim 1, wherein said delivery metric analysis device is configured to generate performance data based on said one or more delivery metrics.

3. The system of claim 2, wherein said performance data comprises one or more of: a picture upon delivery report, a delivery service partner delivery excellence performance report, a customer feedback report, and a driver performance report.

4. The system of claim 1, wherein said one or more delivery metrics are used to generate one or more ranking scorecards.

5. The system of claim 4, wherein said delivery metrics comprise an injury information input.

6. The system of claim 5, wherein said injury information input relates to injuries caused to said one or more drivers while performing delivery related activities; and generating an injury form based on said injury information input.

7. The system of claim 4, wherein said one or more delivery metrics comprise one or more of: acceleration metrics, braking metrics, cornering metrics, speeding metrics, distraction metrics, seatbelt metrics, back up metrics, mile-per-gallon metrics, idling metrics, odometer reading metrics, and engine off metrics.

8. The system of claim 1, wherein said driver message and manager message are transmitted via wireless communications.

9. The system of claim 1, wherein said delivery metrics comprise inventory management data; and
wherein said inventory management data comprises information about product inventory.

10. The system of claim 1, wherein said delivery metric gathering device is operated by a first entity and said delivery metric analysis device is operated by a second entity.

11. The system of claim 10, wherein said driver device is operated by said driver and said manager device is operated by said manager.

12. The system of claim 3, wherein when said one or more delivery metrics is a value outside of said one or more manager ranges of acceptable values, said message transmission device is configured to automatically send a communication to said driver device;
wherein said communication comprises one or more of actionable coaching and positive reinforcement.

13. The system of claim 7, wherein said one or more delivery metrics further comprise one or more third party scorecards.

14. The system of claim 13, wherein said one or more delivery metrics further comprise attendance issues, van damage, rescues, and insubordination.

15. The system of claim 14, wherein each of said one or more drivers are ranked according to said one or more ranking scorecards.

16. The system of claim 15, wherein said one or more ranking scorecards are generated based on said delivery metrics collected over a specified period of time.

17. The system of claim 16, wherein said specified period of time is between 7 days and 180 days.

18. The system of claim 1, wherein said data metrics are imported by a data import algorithm from files provided by one or more third parties.

19. The system of claim 1, wherein each of said data metrics are assigned a weighted value, wherein that is adjustable by said first entity and said second entity.

20. A system for data aggregation, data processing, and messaging comprising:
a delivery metric gathering device;
a delivery metric analysis device;
a message transmission device;
a driver device; and
a manager device;
wherein said delivery metric gathering device is configured to receive one or more delivery metrics associated with one or more drivers;
wherein said delivery metric gathering device is configured to send said one or more delivery metrics to said delivery metric analysis device;
wherein a driver is prompted to enter into said driver device one or more driver ranges of acceptable values of said one or more delivery metrics;
wherein a manager is prompted to enter into said manager device one or more manager ranges of acceptable values of said one or more delivery metrics;
wherein said delivery metric analysis device determines when said one or more delivery metrics is a value outside of said one or more driver ranges of acceptable values;
wherein when said one or more delivery metrics is a value outside of said one or more driver ranges of acceptable values, said message transmission device is configured to send a driver message to said driver device;
wherein said delivery metric analysis device determines when said one or more delivery metrics is a value outside of said one or more manager ranges of acceptable values; and
wherein when said one or more delivery metrics is a value outside of said one or more manager ranges of acceptable values, said message transmission device is configured to send a manager message to said manager device;
wherein said delivery metric analysis device is configured to generate performance data based on said one or more delivery metrics;
wherein said performance data comprises one or more of: a picture upon delivery report, a delivery service partner delivery excellence performance report, a customer feedback report, and a driver performance report;
wherein said one or more delivery metrics are used to generate one or more ranking scorecards;
wherein said delivery metrics comprise an injury information input and inventory management data;
wherein said injury information input relates to injuries caused to said one or more drivers while performing delivery related activities; and generating an injury form based on said injury information input;
wherein said one or more delivery metrics comprise one or more of: acceleration metrics, braking metrics, cornering metrics, speeding metrics, distraction metrics, seatbelt metrics, back up metrics, mile-per-gallon metrics, idling metrics, odometer reading metrics, one or more third party scorecards; attendance issues; van damage; rescues; insubordination; and engine off metrics;
wherein said driver message and said manager message are transmitted via wireless communications;
wherein said inventory management data comprises information about product inventory;
wherein said delivery metric gathering device is operated by a first entity and said delivery metric analysis device is operated by a second entity;
wherein said driver device is operated by said driver and said manager device is operated by said manager;
wherein when said one or more delivery metrics is a value outside of said one or more manager ranges of acceptable values, said message transmission device is configured to automatically send a communication to said driver device;
wherein said communication comprises one or more of actionable coaching and positive reinforcement;
wherein each of said one or more drivers are ranked according to said one or more ranking scorecards;
wherein said one or more ranking scorecards are generated based on said delivery metrics collected over a specified period of time;
wherein said data metrics are imported by a data import algorithm from files provided by one or more third parties; and
wherein each of said data metrics are assigned a weighted value, wherein that is adjustable by said first entity and said second entity.
